(19) United States
(12) Patent Application Publication
(10) Pub. No.: US 2026/0276399 A1
(43) Pub. Date: Sep. 17, 2026

(54) SYSTEM AND METHOD FOR HAPTIC NAVIGATION

(71) Applicant: WearWorks, Inc., Brooklyn, NY (US)

(72) Inventor: Kevin Yoo, Brooklyn, NY (US)

(73) Assignee: WearWorks, Inc., Brooklyn, NY (US)

(21) Appl. No.: 19/667,675

(22) Filed: May 5, 2026

Related U.S. Application Data
(63) Continuation-in-part of application No. 18/884,123, filed on Sep. 13, 2024, now abandoned.
Application No. 18/884,123 is a continuation of application No. 18/674,965, filed on May 27, 2024, now Pat. No. 12,203,770.
Application No. 18/674,965 is a continuation of application No. 18/418,549, filed on Jan. 22, 2024, now abandoned.

(51) Int. Cl. G01C 21/36; G01B 7/30; G06F 3/01; G06F 3/0346; G08B 6/00

(52) U.S. Cl. CPC G01C 21/3652; G01B 7/30; G06F 3/014; G06F 3/016; G06F 3/0346; G08B 6/00

(57) ABSTRACT

A haptic navigation system delivers navigation guidance through vibrotactile feedback without requiring visual display or audio output. The system encodes heading deviation as a structured vibrotactile gradient: a null vibration state when the user's or device's orientation is within a configurable threshold of the target heading, with vibration intensity increasing proportionally as angular deviation increases toward 180 degrees. The system is implemented via one or more orientation sensors comprising at least one of a gyroscope, accelerometer, magnetometer, GPS/GNSS receiver, or camera-based orientation system. A vibration actuator delivers the encoded gradient through a wristband wearable, smartwatch, smartphone, augmented reality glasses frame via bone conduction transducers, or other haptic output device. A distributed architecture supports a first computing device executing the navigation engine wirelessly paired to a second haptic output device.

### CROSS-REFERENCE TO RELATED APPLICATIONS

The present application is a US Continuation-In-Part Utility Patent Application which claims priority to US Continuation Utility patent application Ser. No. 18/884,123, filed Sep. 13, 2024, claims priority under 35 USC 119 (e) from U.S. Non-Provisional application Ser. No. 18/674,965 filed on May 27, 2024 and issued as U.S. Pat. No. 12,203,770 on Jan. 21, 2025; which claimed priority from U.S. Non-Provisional application Ser. No. 18/418,549 filed on Jan. 22, 2024, the entire contents of which are incorporated by reference.

### FIELD OF THE INVENTION

This invention relates to systems and methods for creating a Haptic Line™. In particular, this invention relates to the drawing of the Haptic Line™ on a computing device, converting the Haptic Line™ into a haptic file format, playing back the Haptic Line™ over a user-specified duration in vibrations that the user can feel from the computing device, and transmitting the customized Haptic Line™ to a database, another computing device, or another user.

### BACKGROUND OF THE EMBODIMENTS

Haptic technology, also known as kinesthetic communication or 3D touch, refers to any technology that can create an experience of touch by applying forces, vibrations, or motions to the user. These technologies can be used to create virtual objects in a computer simulation, to control virtual objects, and to enhance remote control of machines and devices. Haptic devices may incorporate haptic sensors that measure forces exerted by the user on the interface.

However, creating haptics is a challenge. The process involves technical knowledge of hardware (vibrating motors and drivers), mathematics, software, and firmware. Further, haptics are often identical and fail to allow for user-customizability. The instant invention provides both systems and methods for creating user-specified Haptic Lines™

Previous approaches to haptic navigation systems have focused on utilizing various sensors and actuators to provide tactile feedback to users. These systems typically involve the use of accelerometers or gyroscopes to detect the orientation of a haptic navigation device and generate corresponding haptic patterns. However, these approaches often lack the ability to accurately interpret and map the angular data obtained from the sensors to generate dynamic haptic patterns.

Some existing haptic navigation systems employ vibration motors to generate haptic feedback based on predefined patterns. These patterns are typically static and do not adapt to the specific orientation of the haptic navigation device relative to the target. As a result, the haptic feedback provided by these systems may not effectively convey the desired information to the user.

Other approaches have attempted to address the limitations of static haptic patterns by incorporating more complex algorithms and mapping techniques. These systems aim to generate dynamic haptic patterns based on the orientation of the haptic navigation device. However, these approaches often require significant computational resources and may suffer from latency issues, resulting in a delay between the detection of the orientation and the generation of the corresponding haptic feedback. Previous approaches to haptic navigation systems have made use of sensors and actuators to provide tactile feedback to users. However, these approaches have not been able to accurately interpret and map angular data to generate dynamic haptic patterns that effectively convey information to the user. Additionally, existing systems may suffer from limitations such as static haptic patterns or latency issues. Therefore, there is a need for an improved haptic navigation system that overcomes these limitations and provides a more intuitive and responsive user experience.

### SUMMARY OF THE EMBODIMENTS

In some aspects, the techniques described herein relate to a haptic navigation device including: one or more orientation sensors configured to detect angular data representing an angular relationship between a current orientation of the haptic navigation device and a target heading, the one or more orientation sensors including at least one of: a gyroscope, an accelerometer, a magnetometer, a GPS/GNSS receiver, a camera-based visual-inertial odometry system, or combinations thereof; a vibration actuator configured to generate vibrotactile output; a non-transitory memory storing a planned navigation route; and a processor configured to: compute an angular deviation between a current heading of the haptic navigation device and the target heading derived from the planned navigation route; cause the vibration actuator to produce a null vibration state when the angular deviation is within a configurable threshold angular range of the target heading; and cause the vibration actuator to increase vibration intensity proportionally as the angular deviation increases beyond the configurable threshold angular range, reaching maximum intensity at approximately 180 degrees of deviation from the target heading.

In some aspects, the techniques described herein relate to a system for haptic navigation including: a processor configured to compute an angular deviation between a sensed orientation and a target heading derived from a navigation route stored in memory; a vibration actuator coupled to the processor; and wherein the processor maps the angular deviation to a vibrotactile gradient output in which: a vibration intensity is at a null state when the angular deviation is within a threshold of the target heading; the vibration intensity increases continuously from the null state as the angular deviation increases; and the vibration intensity reaches a maximum value at 180 degrees of the angular deviation from the target heading; wherein the null state and the vibrotactile gradient output are implemented without a graphical display output.

In some aspects, the techniques described herein relate to a distributed haptic navigation system including: a first computing device including a navigation engine configured to: receive route data; determine a current position and a current heading of a user; and compute an angular deviation between the current heading and a target heading; a second haptic output device communicatively coupled to the first computing device via a short-range wireless protocol including at least one of Bluetooth, Bluetooth Low Energy, or Ultra-Wideband; the second haptic output device including a vibration actuator; and wherein the first computing device transmits vibrotactile output parameters to the second haptic output device, and the second haptic output device generates vibrotactile output encoding the angular deviation as: a null vibration state when the angular deviation is within a configurable threshold; and increasing vibration intensity proportional to the angular deviation as the angular deviation increases beyond the configurable threshold.

In some aspects, the techniques described herein relate to a method for haptic navigation including: receiving orientation data from one or more orientation sensors including at least one of: a gyroscope, an accelerometer, a magnetometer, a GPS/GNSS receiver, a camera-based visual-inertial odometry system, or combinations thereof; computing an angular deviation between a current heading derived from the orientation data and a target heading derived from a planned navigation route stored in memory; encoding the angular deviation as a vibrotactile signal in which: a vibration intensity is at a null state when the angular deviation is within a configurable threshold; and the vibration intensity increases proportionally as the angular deviation increases beyond the configurable threshold; and delivering the vibrotactile signal through a vibration actuator of a haptic output device worn on or carried by a user.

In some aspects, the techniques described herein relate to a proximity-based vehicle identification system including: a positioning module configured to receive proximity signals from a target vehicle via at least one of: Bluetooth Low Energy (BLE) received signal strength indicator (RSSI), Ultra-Wideband (UWB) two-way ranging, Near Field Communication (NFC) field detection, computer vision vehicle recognition, or QR code scanning; a vibration actuator; a non-transitory memory storing a target vehicle identifier; and a processor configured to: compare a received vehicle identifier against the stored target vehicle identifier; and generate a vehicle identification heartbeat pattern including a rhythmic vibrotactile pulse whose repetition rate and intensity each increase as the measured proximity to the target vehicle decreases below a configurable proximity threshold; wherein the target vehicle identifier is broadcast by a rideshare application, autonomous vehicle platform, or fleet management system operating on a driver device, vehicle-embedded computer, or vehicle-mounted beacon. As used herein, ‘rhythmic’ and ‘periodic’ are used interchangeably to describe a repeating vibrotactile pulse pattern.

In some aspects, the techniques described herein relate to a haptic human-robot guidance system including: a robotic platform including a proximity radio module configured to broadcast a unique robot identifier via at least one of Bluetooth Low Energy (BLE), Ultra-Wideband (UWB), or Wi-Fi; a human-worn haptic output device including: a vibration actuator; one or more orientation sensors; and a processor; and wherein the processor of the human-worn haptic output device is configured to: receive the unique robot identifier broadcast and determine a heading toward the robotic platform; compute angular deviation between a current heading of a user and the heading toward the robotic platform; and encode the angular deviation as a null vibration state when the angular deviation is within a threshold and as increasing vibration intensity as the angular deviation increases beyond the threshold; wherein guidance is delivered without requiring visual display or audio output from either the robotic platform or the human-worn haptic output device.

In some aspects, the techniques described herein relate to a non-transitory computer-readable medium storing instructions that, when executed by a processor of a haptic output device including a vibration actuator and one or more orientation sensors, cause the processor to: receive orientation data from the one or more orientation sensors; compute an angular deviation between a current heading derived from the orientation data and a target heading derived from a planned navigation route stored in memory of the haptic output device; cause the vibration actuator to produce a null vibration state when the angular deviation is within a configurable threshold angular range of the target heading; and cause the vibration actuator to increase vibration intensity proportionally as the angular deviation increases beyond the configurable threshold angular range, reaching maximum intensity at 180 degrees of deviation from the target heading.

In some aspects, the techniques described herein relate to a haptic navigation device including: one or more orientation sensors configured to detect angular data representing an angular relationship between a current orientation of the haptic navigation device and a target heading, the one or more orientation sensors including at least one of: a gyroscope, an accelerometer, a magnetometer, a GPS/GNSS receiver, a camera-based orientation system, or combinations thereof; a vibration actuator configured to generate vibrotactile output; a non-transitory memory storing a planned navigation route; and a processor configured to: compute an angular deviation between a current heading of the haptic navigation device and the target heading derived from the planned navigation route; cause the vibration actuator to produce a null vibration state when the angular deviation is within a configurable threshold angular range of the target heading; and cause the vibration actuator to increase vibration intensity proportionally as the angular deviation increases beyond the configurable threshold angular range, reaching maximum intensity at a maximum angular deviation from the target heading.

In some aspects, the techniques described herein relate to a system for haptic navigation including: a processor configured to compute an angular deviation between a sensed orientation and a target heading derived from a navigation route stored in memory; a vibration actuator coupled to the processor; and wherein the processor maps the angular deviation to a vibrotactile gradient output in which: a vibration intensity is at a null state when the angular deviation is within a threshold of the target heading; the vibration intensity increases continuously from the null state as the angular deviation increases; and the vibration intensity reaches a maximum value at 180 degrees of the angular deviation from the target heading; wherein the null state and the vibrotactile gradient output are implemented without a graphical display output.

In some aspects, the techniques described herein relate to a distributed haptic navigation system including: a first computing device including a navigation engine configured to: receive route data; determine a current position and a current heading of a user; and compute an angular deviation between the current heading and a target heading; a second haptic output device communicatively coupled to the first computing device via a short-range wireless protocol including at least one of Bluetooth, Bluetooth Low Energy, or Ultra-Wideband; the second haptic output device including a vibration actuator; and wherein the first computing device transmits vibrotactile output parameters to the second haptic output device, and the second haptic output device generates vibrotactile output encoding the angular deviation as: a null vibration state when the angular deviation is within a configurable threshold; and vibration intensity increases proportionally to the angular deviation as the angular deviation increases beyond the configurable threshold.

In some aspects, the techniques described herein relate to a method for haptic navigation including: receiving orientation data from one or more orientation sensors including at least one of: a gyroscope, an accelerometer, a magnetometer, a GPS/GNSS receiver, a camera-based orientation system, or combinations thereof; computing an angular deviation between a current heading derived from the orientation data and a target heading derived from a planned navigation route stored in memory; encoding the angular deviation as a vibrotactile signal in which: a vibration intensity is at a null state when the angular deviation is within a configurable threshold; and the vibration intensity increases proportionally as the angular deviation increases beyond the configurable threshold; and delivering the vibrotactile signal through a vibration actuator of a haptic output device worn on or carried by a user.

In some aspects, the techniques described herein relate to a proximity-based vehicle identification system including: a positioning module configured to receive proximity signals from a target vehicle via at least one of: Bluetooth Low Energy (BLE) received signal strength indicator (RSSI), Ultra-Wideband (UWB) two-way ranging, Near Field Communication (NFC) field detection, computer vision vehicle recognition, or QR code scanning; a vibration actuator; a non-transitory memory storing a target vehicle identifier; and a processor configured to: compare a received vehicle identifier against a stored target vehicle identifier; and generate a vehicle identification heartbeat pattern including a rhythmic vibrotactile pulse whose repetition rate and intensity each increase as measured proximity to the target vehicle decreases below a configurable proximity threshold; wherein the target vehicle identifier is broadcast by a rideshare application, autonomous vehicle platform, or fleet management system operating on a driver device, vehicle-embedded computer, or vehicle-mounted beacon.

In some aspects, the techniques described herein relate to a haptic human-robot guidance system including: a robotic platform including a proximity radio module configured to broadcast a unique robot identifier via at least one of Bluetooth Low Energy (BLE), Ultra-Wideband (UWB), or Wi-Fi; a human-worn haptic output device including: a vibration actuator; one or more orientation sensors; and a processor; and wherein the processor of the human-worn haptic output device is configured to: receive the unique robot identifier broadcast and determine a heading toward the robotic platform; compute angular deviation between a current heading of a user and the heading toward the robotic platform; and encode the angular deviation as a null vibration state when the angular deviation is within a threshold and as increasing vibration intensity as the angular deviation increases beyond the threshold; wherein guidance is delivered without requiring visual display or audio output from either the robotic platform or the human-worn haptic output device.

In some aspects, the techniques described herein relate to a non-transitory computer-readable medium storing instructions that, when executed by a processor of a haptic output device including a vibration actuator and one or more orientation sensors, cause the processor to: receive orientation data from the one or more orientation sensors; compute an angular deviation between a current heading derived from the orientation data and a target heading derived from a planned navigation route stored in memory of the haptic output device; cause the vibration actuator to produce a null vibration state when the angular deviation is within a configurable threshold angular range of the target heading; and cause the vibration actuator to increase vibration intensity proportionally as the angular deviation increases beyond the configurable threshold angular range, reaching maximum intensity at a maximum angular deviation from the target heading.

### BRIEF DESCRIPTION OF THE DRAWINGS

FIG. 1 depicts a schematic diagram of a computer system, in accordance with embodiments of the present invention.

FIG. 2 depicts a schematic diagram of a login screen for a user to access a haptic creative studio, in accordance with embodiments of the present invention.

FIG. 3 depicts schematic diagrams of tutorial screens associated with a haptic creative studio, in accordance with embodiments of the present invention.

FIG. 4 depicts schematic diagrams of tutorial screens associated with a haptic creative studio, in accordance with embodiments of the present invention.

FIG. 5 depicts schematic diagrams of tutorial screens associated with a haptic creative studio, in accordance with embodiments of the present invention.

FIG. 6 depicts schematic diagrams of tutorial screens associated with a haptic creative studio, in accordance with embodiments of the present invention.

FIG. 7 depicts schematic diagrams of tutorial screens associated with a haptic creative studio, in accordance with embodiments of the present invention.

FIG. 8 depicts a schematic diagram of a home screen associated with a haptic creative studio, in accordance with embodiments of the present invention.

FIG. 9 depicts a schematic diagram of a screen associated with “favorite” Haptic Lines™ in a haptic creative studio, in accordance with embodiments of the present invention.

FIG. 10 depicts a schematic diagram of a search component that allows a user to search for Haptic Lines™ in a haptic creative studio, in accordance with embodiments of the present invention.

FIG. 11 depicts a schematic diagram of example search results from FIG. 10, in accordance with embodiments of the present invention.

FIG. 12 depicts a schematic diagram of a screen to share one or more Haptic Lines™, in accordance with embodiments of the present invention.

FIG. 13 depicts a schematic diagram of a screen displaying default Haptic Lines™ in a haptic creative studio, in accordance with embodiments of the present invention.

FIG. 14 depicts a schematic diagram of a screen showing a Haptic Line™ associated with alerts in a haptic creative studio, in accordance with embodiments of the present invention.

FIG. 15 depicts schematic diagrams of creating a Haptic Line™ in a haptic creative studio in portrait mode, in accordance with embodiments of the present invention.

FIG. 16 depicts schematic diagrams of creating a Haptic Line™ in a haptic creative studio in portrait mode, in accordance with embodiments of the present invention.

FIG. 17 depicts schematic diagrams of creating a Haptic Line™ in a haptic creative studio in portrait mode, in accordance with embodiments of the present invention.

FIG. 18 depicts a schematic diagram of a screen to save a created Haptic Line™ in a haptic creative studio, in accordance with embodiments of the present invention.

FIG. 19 depicts schematic diagrams of creating a Haptic Line™ in a haptic creative studio in landscape mode, in accordance with embodiments of the present invention.

FIG. 20 depicts schematic diagrams of creating a Haptic Line™ in a haptic creative studio in landscape mode, in accordance with embodiments of the present invention.

FIG. 21 depicts schematic diagrams of creating a Haptic Line™ in a haptic creative studio in landscape mode, in accordance with embodiments of the present invention.

FIG. 22 depicts a schematic diagram of a screen to save a Haptic Line™ in a haptic creative studio, in accordance with embodiments of the present invention.

FIG. 23 depicts a schematic diagram of a screen associated with Haptic Lines™ designated for an emergency scenario, in accordance with embodiments of the present invention.

FIG. 24 depicts schematic diagrams to add a Haptic Line™ to an alarm in a haptic creative studio, in accordance with embodiments of the present invention.

FIG. 25 depicts schematic diagrams to add a Haptic Line™ to an alarm in a haptic creative studio, in accordance with embodiments of the present invention.

FIG. 26 depicts schematic diagrams to add a Haptic Line™ to an alarm in a haptic creative studio, in accordance with embodiments of the present invention.

FIG. 27 depicts schematic diagrams describing a custom haptics tutorial associated with a haptic creative studio, in accordance with embodiments of the present invention.

FIG. 28 depicts schematic diagrams describing a custom haptics tutorial associated with a haptic creative studio, in accordance with embodiments of the present invention.

FIG. 29 depicts schematic diagrams of creating a Haptic Line™ in a haptic creative studio, in accordance with embodiments of the present invention.

FIG. 30 depicts schematic diagrams of creating a Haptic Line™ in a haptic creative studio, in accordance with embodiments of the present invention.

FIG. 31 depicts schematic diagrams of creating a Haptic Line™ in a haptic creative studio, in accordance with embodiments of the present invention.

FIG. 32 depicts a schematic diagram of a MyHaptics screen containing Haptic Lines™ of a user, in accordance with embodiments of the present invention.

FIG. 33 depicts a schematic diagram associated with creating a haptics collection containing Haptic Lines™ in a haptic creative studio, in accordance with embodiments of the present invention.

FIG. 34 depicts a schematic diagram depicting sharing of a haptics collection from a haptic creative studio, in accordance with embodiments of the present invention.

FIG. 35 depicts a block diagram of a computing device used within the system of FIG. 1, in accordance with embodiments of the present invention.

FIG. 36 depicts a schematic diagram depicting a user interface of a control mechanism that uses a haptic wheel to map a user's orientation from a target angle to specific haptic patterns, in accordance with embodiments of the present invention.

FIG. 37 is a block diagram illustrating a haptic navigation system, according to some embodiments of the present disclosure.

FIG. 38 is a flowchart illustrating a method of implementing a haptic navigation system, according to some embodiments of the present disclosure.

FIG. 39 is an illustration of a Project Guideline simulator implementing sound and haptic feedback in the haptic navigation system, according to some embodiments of the present disclosure.

FIG. 40 is a block diagram illustrating a haptic navigation device, according to some embodiments of the present disclosure.

FIG. 41 is a block diagram further illustrating the haptic navigation device from FIG. 40, according to some embodiments of the present disclosure.

FIG. 42 is a block diagram illustrating a distributed haptic navigation system, according to some embodiments of the present disclosure.

FIG. 43 is a flowchart illustrating a method, according to some embodiments of the present disclosure.

FIG. 44 is a block diagram illustrating a proximity-based vehicle identification system, according to some embodiments of the present disclosure.

FIG. 45 is a block diagram illustrating a haptic human-robot guidance system, according to some embodiments of the present disclosure.

FIG. 46 is a block diagram illustrating a non-transitory computer-readable medium storing instructions, according to some embodiments of the present disclosure.

FIG. 47 is a block diagram illustrating a bone conduction vibrotactile navigation system for augmented reality glasses, according to some embodiments of the present disclosure.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate, upon reading the present specification and viewing the present drawings, that various modifications and variations can be made thereto.

As used herein, the term “haptics” refers to the perception of objects by touch, like the vibrations in a mobile device.

As used herein, the term “computer” refers to a machine, apparatus, or device that is capable of accepting and performing logic operations from software code. The term “application”, “software”, “software code”, or “computer software” refers to any set of instructions operable to cause a computer to perform an operation. Software code may be operated on by an “engine” or processor. Thus, the methods and systems of the present invention may be performed by a computer or computing device having a processor based on instructions received from computer applications and software.

The term “haptic navigation device,” “electronic device,” “mobile device,” or “client device,” as used herein, is a type of computer comprising circuitry and configured to generally perform functions such as recording audio, photos, videos, and handwritten notes; displaying or reproducing audio, photos, videos, and handwritten notes; storing, retrieving, or manipulating electronic data; providing electrical communications and network connectivity; or any other similar function. Non-limiting examples of electronic devices include: personal computers (PCs), workstations, laptops, tablet PCs, cell phones, digital music players, digital notepads, digital pens, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, wearable computers such as smartwatches, fitness rings, fitness trackers, etc.

The term “computer readable medium” as used herein refers to any medium that participates in providing instructions to the processor for execution. A computer readable medium may take many forms, including but not limited to, non-volatile media, volatile media, and transmission media. Non-volatile media includes, for example, optical, magnetic disks, and magneto-optical disks, such as the hard disk or the removable media drive. Volatile media includes dynamic memory, such as the main memory. Transmission media includes coaxial cables, copper wire, and fiber optics, including the wires that make up the bus. Transmission media may also take the form of acoustic or light waves, such as those generated during radio wave and infrared data communications.

As used herein, the term “data network” or “network” shall mean an infrastructure capable of connecting two or more computers, such as client devices, either using wires or wirelessly, allowing them to transmit and receive data. Non-limiting examples of data networks may include the internet or wireless networks (e.g., a “wireless network”) which may include Wi-Fi and cellular networks. For example, a network may include a local area network (LAN), a wide area network (WAN) (e.g., the Internet), a mobile relay network, a metropolitan area network (MAN), an ad hoc network, a telephone network (e.g., a Public Switched Telephone Network (PSTN)), a cellular network, a Zigbee network, or a voice-over-IP (VOIP) network.

As used herein, the term “database” or “DB” shall generally mean a digital collection of data or information. A database may be stored on a remote server and accessed by a client device through the Internet (e.g., the database is in the cloud) or, alternatively, in some embodiments, the database may be stored on the client device or remote computer itself (e.g., local storage). A “data store” as used herein may contain or comprise a database (e.g., information and data from a database may be recorded into a medium on a data store).

“As used herein, the term ‘vibration actuator’ includes but is not limited to vibration motors, linear resonant actuators, eccentric rotating mass motors, and piezoelectric actuators.”

“As used herein, the terms ‘rhythmic’ and ‘periodic’ are used interchangeably to describe a repeating vibrotactile pulse pattern.”

“As used herein, the term ‘vehicle identification heartbeat’ refers to a rhythmic vibrotactile pulse pattern generated in response to proximity detection of a target vehicle.”

The present invention and its embodiments relate to systems and methods for creating a Haptic Line™. In particular, this invention relates to the drawing of the Haptic

Line™ on a computing device, converting the Haptic Line™ into a haptic file format, playing back the Haptic Line™ over a user-specified duration in vibrations that the user can feel from the computing device, and transmitting the customized Haptic Line™ to a database, another computing device, or a user.

The system provides a computing device that includes, at least, a graphical user interface (GUI) and a Haptic Line™ engine. The GUI is configured to receive a login input (e.g., an email address and a password or a biometric login input) from a user to access a haptic creative studio. The Haptic Line™ engine includes at least one algorithm. The Haptic Line™ engine is configured to verify the identity of the user from the login input and provide the user access to the haptic creative studio, such that the user is permitted to create, save, and share a Haptic Line™.

In some examples, the Haptic Line™ engine is further configured to share the Haptic Line™ with at least one of another computing device and another user. Such sharing may occur via a messaging method (such as SMS messaging and/or email messaging). In other examples, the Haptic Line™ engine is further configured to, in response to a prompt from the user, assign the Haptic Line™ to a contact or a notification on the computing device. For example, the notification may be an alarm, a calendar event, and/or a reminder.

In additional examples, the haptic creative studio comprises at least a grouping of default haptics, a grouping of user-created haptics, an option to search for new haptics, and an option to create and sort through haptic pattern collections. The Haptic Line™ engine is further configured to display information associated with the Haptic Line™ via the GUI. The information may include: a name of the user who created the Haptic Line™, a title of the Haptic Line™, an image associated with the Haptic Line™, a color associated with the Haptic Line™, and/or a quantity of likes of the Haptic Line™ from other users.

In some examples, to create the Haptic Line™, the Haptic Line™ engine is further configured to allow the user to drag a finger on the GUI to increase or decrease the intensity of the Haptic Line™ and/or increase or decrease the length of the Haptic Line™ when the computing device is in a portrait mode or in a landscape mode. In other examples, to create the Haptic Line™, the Haptic Line™ engine is further configured to allow the user to customize a sharpness or softness ratio applied over the Haptic Line™ when the computing device is in a portrait mode or in a landscape mode.

In additional examples, the Haptic Line™ engine is further configured to, in response to a prompt from the user, save the haptic line™ to an external database or server. The Haptic Line™ engine is further configured to, in response to a prompt from the user, provide one or more other users public access to the Haptic Line™.

Further, in some examples, the Haptic Line™ engine is further configured to, in response to a prompt from the user, group multiple Haptic Lines™ together to create a

Compound Haptic Line™. Further, the Haptic Line™ engine is configured to convert the Haptic Line™ into a haptic file format and play back the Haptic Line™ over a user-specified duration in vibrations that the user can feel from the computing device.

A wearable haptic navigation system serves as a fully functional and cost-efficient prototype of a wearable device designed for touch-based navigation. It operates without a visual display, relying solely on touch for information transmission. Functioning as both a compass directing users to the North and a GPS navigator guiding towards specific landmarks like home, the device allows users to perceive the distance from their designated locations. Its Bluetooth interface facilitates network connectivity, enabling the download of map landmarks from a cell phone. Moreover, the bidirectional networking feature enables the device to collect various sensor data, deliver haptic messages, and offer touch telepresence capabilities.

A haptic navigation system and method for delivering haptic spatial information is based on exploiting the human haptic perception system's ability to interpret sensations, providing comprehensive detail. A GPS, 3-axis compass, inertial sensor, power management, battery, and embedded processor are incorporated within a compact and cost-effective package. In an embodiment, the haptic navigation system is comprised of various components, including a digital compass, accelerometer, GPS positioning unit, Bluetooth communications module, memory card, integrated rechargeable battery system, USB connectivity for firmware and user data updates, and an optional character display. The accelerometer serves to offer tilt compensation to the compass and may recognize environmental attributes by detecting specific signals in the data that indicate the necessary movement to navigate around obstacles. Furthermore, there is an option to incorporate a camera system as an additional feature.

Initially developed as a navigation aid for the visually impaired, our system targets multiple markets, including assistive technologies for individuals with severe or partial visual impairments, dementia (with an estimated global market of 18 million), and applications in the military, tourism, hiking, and search and rescue.

The system's physical components include four vibro-haptic motors for directional guidance, one distal motor for distance indication, and a controller comprising a power management system, battery, GPS receiver, 3-axis accelerometer, digital compass (magnetometer), Bluetooth transmitter/receiver, and potentially a vision system in the future. To ensure optimal performance, a wearable medium like neoprene facilitates vertical conduction of motor vibrations to the skin, minimizing lateral energy transfer.

Using the Bluetooth wireless interface, the system processes single or multiple landmarks received in a sequential order, removing processed landmark information once the user reaches the designated vicinity and labeling the subsequent one as the current landmark.

Beyond the specifics outlined, the system's versatility allows for alternative forms beyond a belt, offering a continuum of orientations around various body parts. The device's size is primarily constrained by its electronic components, while communication methods can include RF, Bluetooth, or infrared. Storing maps and databases on separate devices like cell phones or iPods is recommended.

In summary, while our description provides specific details, they are illustrative rather than restrictive. The invention's scope should be determined by the appended claims and their legal equivalents, without being confined by the embodiments described.

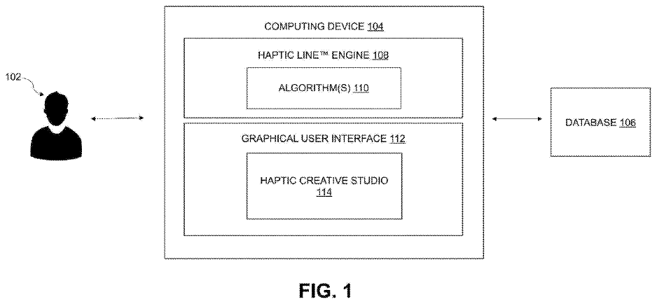

A computer system configured to implement a method for providing a Haptic Line™ is depicted in FIG. 1. Specifically, the instant system allows users to create and customize haptic vibrational patterns or select from a default library, as well as share the customized haptic vibrational patterns with friends and family. The computer system of FIG. 1 includes a computing device 104 associated with a user 102. The computer system of FIG. 1 may also include a database 106 that houses data and information described herein. The computing device 104 may access the database 106 via a network.

The computing device 104 of FIG. 1 may comprise a Haptic Line™ engine 108 that may execute the method described herein. In other examples, the Haptic Line™ engine 108 of FIG. 1 may be an application, a software program, a service, or a software platform configured to be executable on the computing device 104. Furthermore, the Haptic Line™ engine 108 may comprise one or more algorithms 110 that assist in the process steps executed by the Haptic Line™ engine 108.

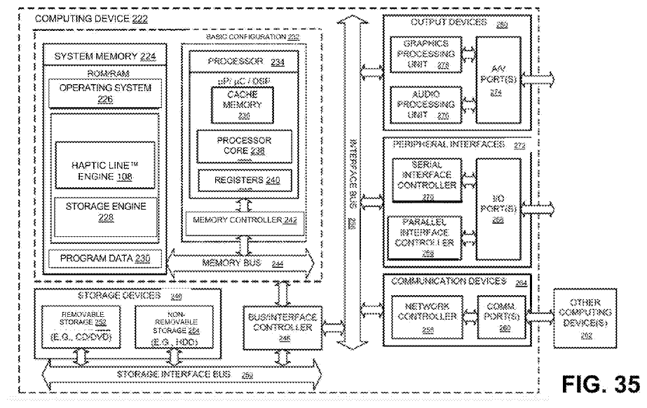

The computing device 104 may also comprise one or more processors, one or more memories, and one or more computer-readable hardware storage devices, which will be described further herein with regard to FIG. 35. The one or more computer-readable hardware storage devices contain program code executable by the one or more processors via the one or more memories to implement the method process steps described herein. Further, the computing device 104 may comprise a graphical user interface (GUI) 112. The user 102 may interact with a haptic creative studio 114 via the GUI 112.

For example, the user 102 may interact with the haptic creative studio 114 to create, save, and share haptics (e.g., Haptic Lines™) or Haptic Line™ collections with others. Specifically, the user 102 may interact with the haptic creative studio 114 to easily draw, save, and edit the Haptic Lines™. The user 102 may then engage the haptic creative studio 114 to assign the Haptic Lines™ created to notifications (e.g., calendar alerts, reminders, etc.) on the computing device 104.

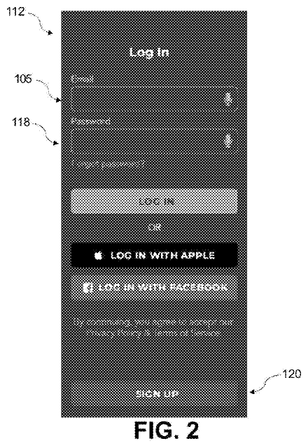

When the user 102 engages the haptic creative studio 114, the user 102 may be prompted to log in using an email address 105 and a password 118 or may be prompted to sign up 120 to utilize the service, as shown in FIG. 2. In some examples, other means to verify an identity of the user 102 may be used, such as biometric identification methods (e.g., fingerprint identification, face recognition identification, palm print identification, iris recognition, retina recognition, etc.).

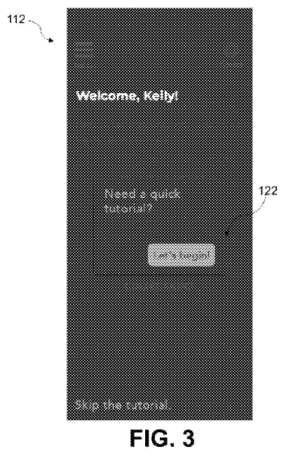

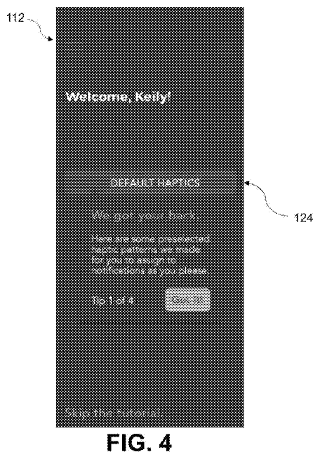

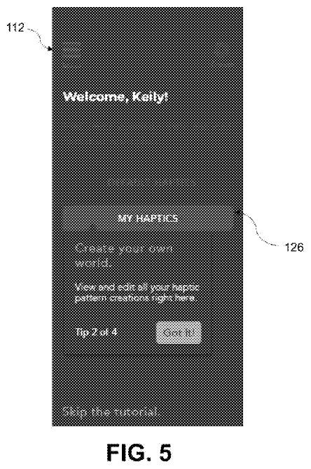

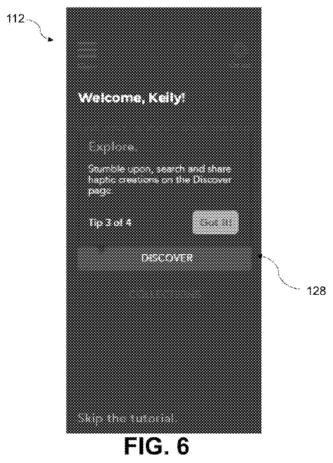

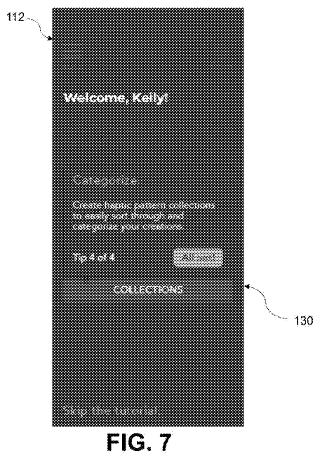

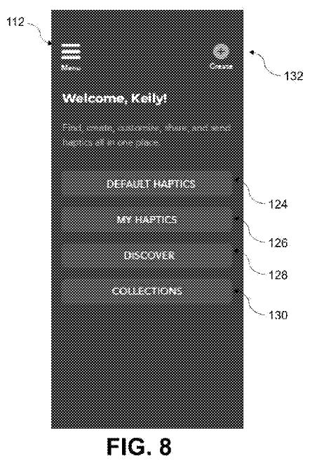

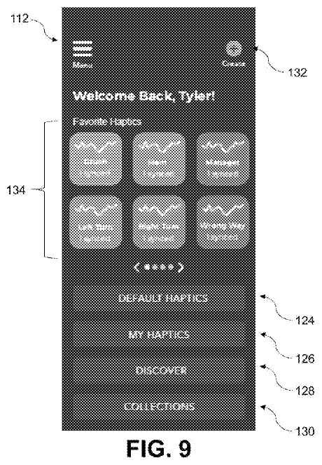

Once the Haptic Line™ engine 108 verifies the identity of the user 102, the user 102 may be directed to a welcome or home screen, as shown in FIG. 3. The welcome or home screen of FIG. 3 may provide the user 102 with a tutorial 122 for the haptic creative studio 114. The user 102 has the option to view or to skip the tutorial 122. The tutorial 122 for the haptic creative studio 114 may include: a grouping of default or preselected haptics 124 (of FIG. 4), a grouping of user-created haptics (e.g., “My Haptics”) 126 (of FIG. 5), an option to search for new haptics 128 (of FIG. 6), and an option to create and sort through haptic pattern collections 130 (of FIG. 7). FIG. 8 and FIG. 9 depict the options discussed in FIG. 4, FIG. 5, FIG. 6, and FIG. 7, as well as a creation action button 132 for the user 102 to create a new Haptic Line™ in the haptic creative studio 114. Moreover, FIG. 9 depicts a grouping of “Favorite Haptics” 134 of a given user 102.

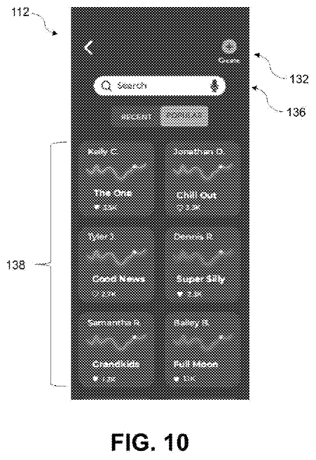

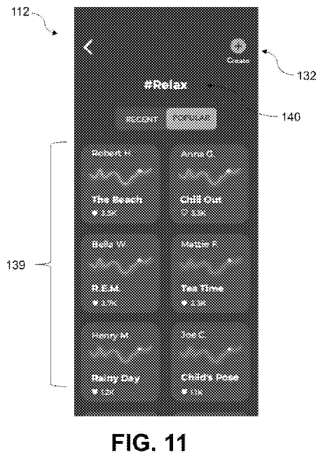

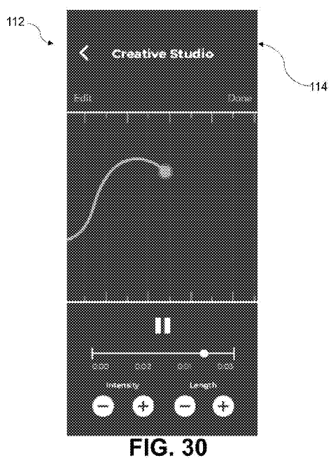

FIG. 10 depicts a search feature 136 of the haptic creative studio 114, whereby the user 102 may search 136 for recent haptics or popular haptics. Examples of “popular” haptics 138 are depicted in FIG. 10. Examples of popular haptics 138 associated with the search term “relax” are depicted in FIG. 10 as popular haptics 139. The depiction of the popular haptics 139 (FIG. 11) for the haptic creative studio 114 (FIG. 30) may include the name of the user 102, a title of the haptic, an image or graphic of the haptic, and/or a quantity of “likes” of the given haptic, among other components not explicitly listed herein, such as color, additional text, and/or additional graphics or images. FIG. 11 illustrates the #Relax interface 140.

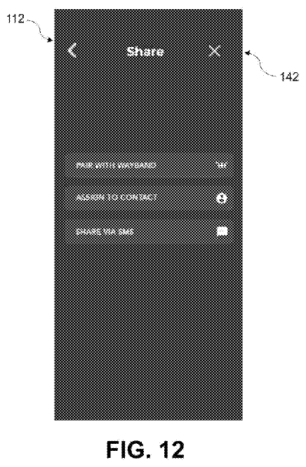

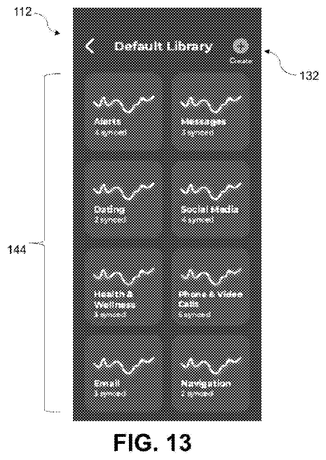

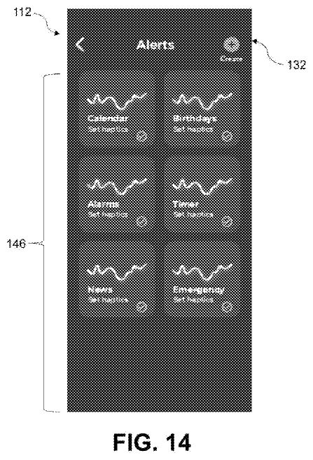

FIG. 12 depicts an option in the haptic creative studio 114 for the user 102 to: (1) share a given haptic via the GUI 112 with a WAYBAND™, (2) assign the haptic to a contact, and/or (3) share the haptic via SMS messaging. As described herein, “WAYBAND™” is a wristband that navigates you to a destination using only vibration. In other examples, the haptic may be shared to another smart device, such as a smart wearable ring or watch, or shared via another form of messaging, such as email messaging. FIG. 13 depicts a group of haptics 144 of a default library, viewable via the GUI 112 to the user 102. FIG. 14 depicts a group of haptics 146 associated with alerts.

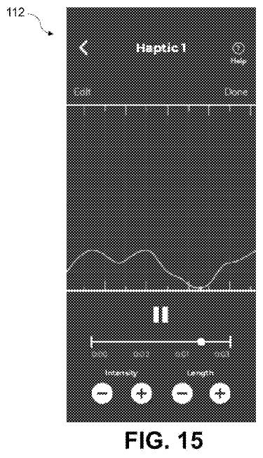

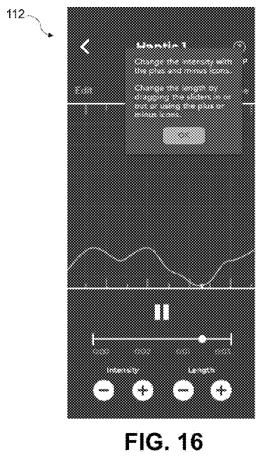

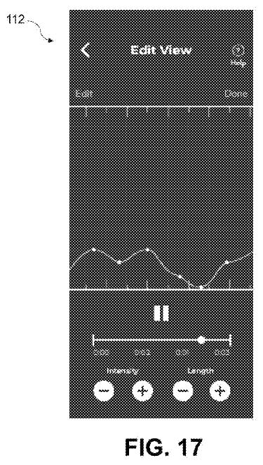

FIG. 15 and FIG. 16 depict a visual display of “Haptic 1”, where the user 102 can increase or decrease the intensity and/or length of the Haptic Line™ in a standard portrait mode. In the portrait mode, the upper and lower intensities are defined by the edge of the drawing area. FIG. 17 depicts a result of the modification of the intensity and/or the length of the Haptic Line™ from FIG. 15 and FIG. 16.

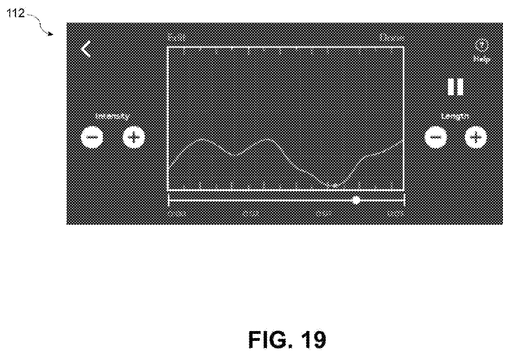

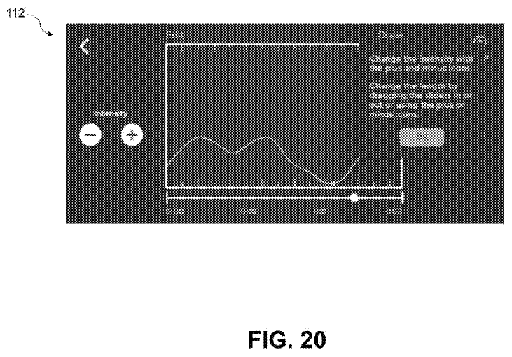

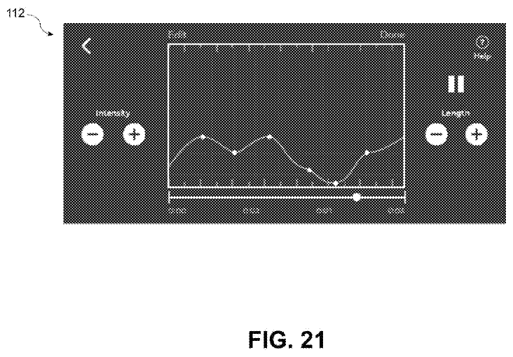

FIG. 19 and FIG. 20 depict a visual display of “Haptic 1”, where the user 102 can increase or decrease the intensity and/or length of the Haptic Line™ in a landscape mode. In the landscape mode, the top and bottom of the computing device 104 screen edge defines the upper and lower intensities (bottom=0%, top=100%). FIG. 21 depicts a result of the modification of the intensity and/or the length of the Haptic Line™ from FIG. 19 and FIG. 20. In some examples, the user 102 may further customize the total haptic sharpness/softness ratio applied over the entire Haptic Line™.

Further, in some examples, a scrubber line may be displayed via the GUI 112 to show visually what portion of the Haptic Line™ is playing. It should be appreciated that the scrubber line movement will be dictated by the duration and that the user 102 may drag his or her fingers to move the scrubber line manually. The Haptic Line™ will output in correspondence to the scrubber line location.

As such, once the Haptic Line™ is drawn in portrait or landscape mode, the Haptic Line™ is converted into a haptic file format for the computing device 104, the WAYBAND™, or another smart device that allows for playback of the Haptic Line™ over the user-customized duration in vibrations that the user 102 can feel from the computing device 104 or directly from the WAYBAND™.

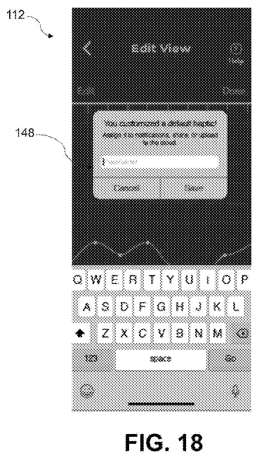

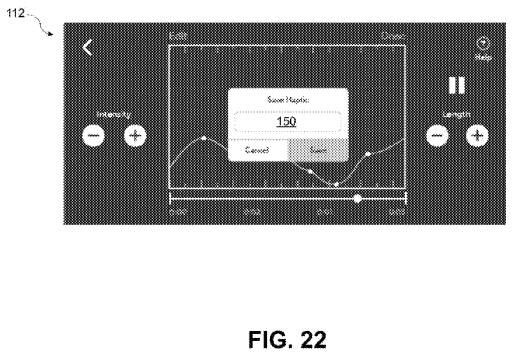

Further, once customized, the Haptic Line™ may be saved to the computing device 104 or the database 106 (e.g., via a save haptic box 148 of FIG. 18 or a save haptic box 150 of FIG. 22), shared, or assigned to a notification on the computing device 104. When saved to the database 106, other users may be given “public” access to the Haptic Line™ in the database 106 to try and download. To encourage sharing of these Haptic Lines™, the GUI 112 may display notifications of the number of “plays” their Haptic Line™ has received.

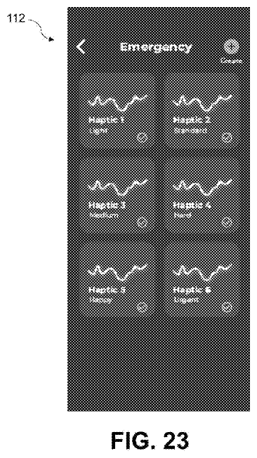

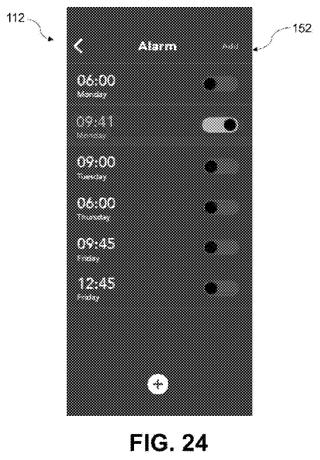

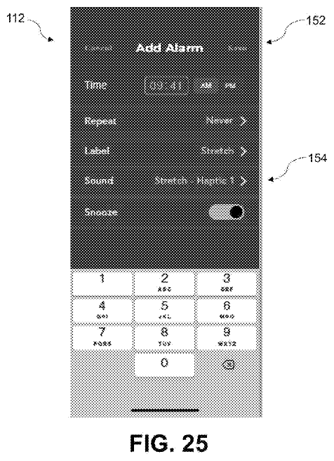

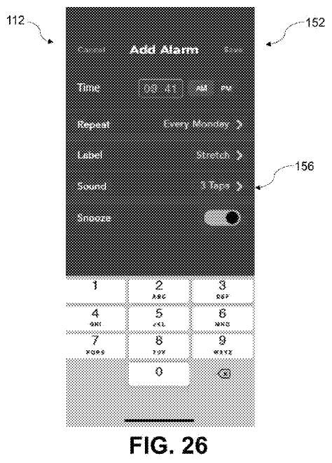

FIG. 23 depicts a grouping of haptics designated by the user 102 as “emergency notifications”. FIG. 24, FIG. 25, and FIG. 26 depict images of the Haptic Lines™ being assigned to a given alarm. An alarm may be created or added via an “add button” 152 (of FIG. 24). FIG. 25 depicts the user 102 assigning “Haptic 1” 154 as the sound for the added alarm and FIG. 26 depicts the user 102 adding a sound of “3 taps” 156 as the sound for the added alarm. It should be appreciated that the haptics may be assigned to other notifications, such as reminders, calendar appointments, etc. Further, in some examples, the user 102 can group multiple Haptic Lines™ together to create a Compound Haptic Line™.

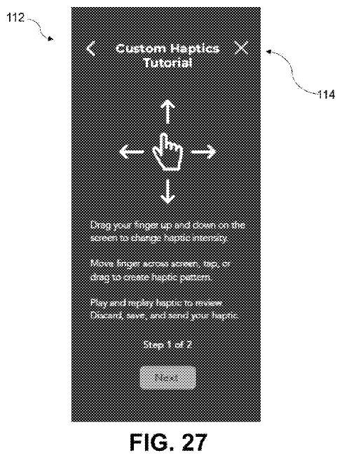

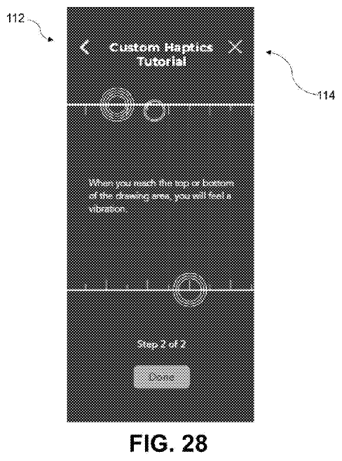

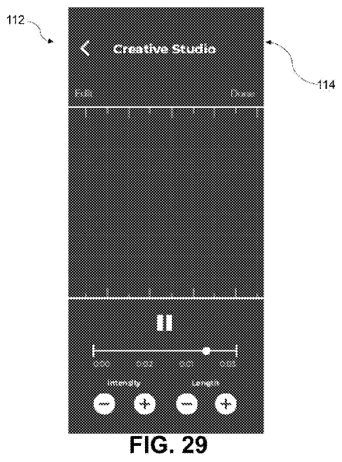

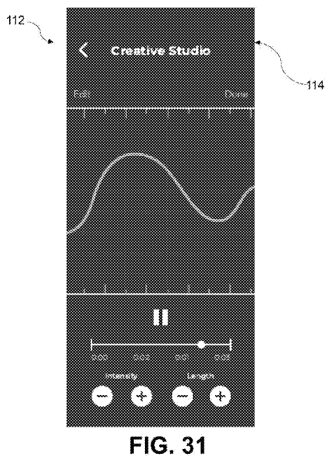

FIG. 27 and FIG. 28 depict images of a tutorial for the haptic creative studio 114, where the user 102 is directed to: (1) drag his or her fingers up and down on the screen to modify the intensity of the Haptic Line™, (2) move his or her fingers across the screen, tap, or drag to create the Haptic Line™, (3) play and replay the Haptic Line™ to review the customized Haptic Line™, and (4) discard, save, and send the customized Haptic Line™ to another party. FIG. 29-FIG. 31 depict creation of the customized Haptic Line™ based on the tutorial described in FIG. 27-FIG. 28.

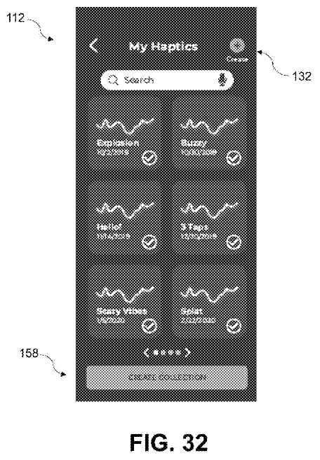

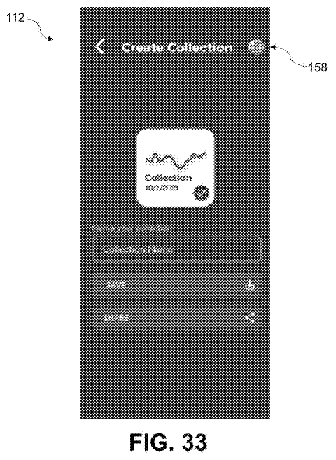

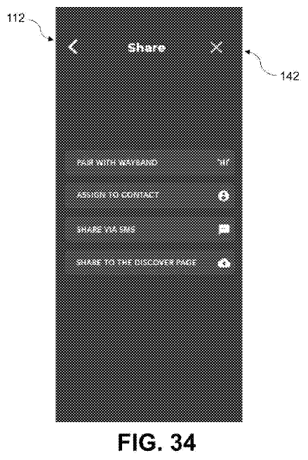

FIG. 32 depicts the grouping of user-created haptics (e.g., “My Haptics”), with an option for the user 102 to create a haptic collection 158. During the creation of the haptic collection 158, the user 102 may assign a color 158 to the given collection, assign a name to the collection, save the collection, and/or share the collection, as shown in FIG. 33. The user 102 may: (1) share 142 a given haptic collection 158, as shown in FIG. 34, to the WAYBAND™ or another smart device paired with the computing device 104, (2) assign the haptic collection 158 to a contact of the computing device 104, (3) share the haptic collection 158 via SMS or email messaging, and/or (4) share the haptic collection 158 to a discovery page, among others.

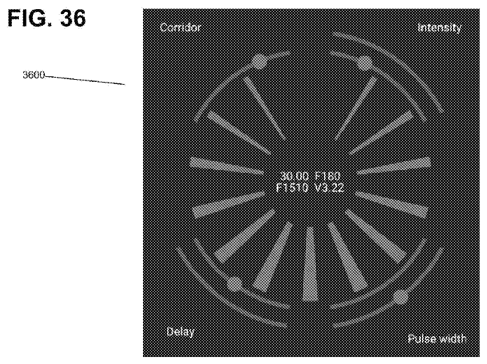

FIG. 36 depicts a schematic diagram depicting a user interface of a control mechanism that uses a haptic wheel system 3600 to map a user's orientation from a target angle to specific haptic patterns. FIG. 36 further delineates the functionality of a haptic wheel system 3600 that enables personalized mapping of angular differences, measured in degrees, between a user's orientation and a target to specific haptic patterns. Adjustment of sliders within this system correlates with visual representations as radial lines, symbolizing parameters such as intensity (color), delay (spacing), and pulse width (width). The numerical values displayed within the interface represent selectable parameter ranges for input into the SDK. Corridor slider, defining the ranges for input into the SDK. Corridor slider, defining the width in degrees around the target orientation where the user feels no haptic sensation, ranging from approximately 0 degrees to approximately 360 degrees. In the upper-right section, the intensity sliders control the strength of each haptic pulse. The system provides options for a fixed value (inner slider) that remains constant regardless of the user's orientation, ranging from approximately 0 to approximately 300, and a variable value (outer slider) that intensifies as the user deviates further from the target angle, ranging from about 0.1 to about 100.0. Moving to the lower-left section, the delay sliders regulate the time interval between haptic pulses. Similar to intensity, there are fixed and variable options, with the fixed value (inner slider) ranging from 30 to 3000 milliseconds and the variable value (outer slider) shortening as the user moves away from the target angle, ranging from about 0.1 to about 100.0. Finally, in the lower-right section, the Pulse Width sliders control the duration of each haptic pulse. Similar to the previous sections, there are fixed and variable options, with the fixed value (inner slider) ranging from about 0.3 milliseconds to about 2000 milliseconds and the variable value (outer slider) increasing as the user turns further from the target angle, ranging from about 0.1 to about 100.00. This intricate system allows users precise control over haptic feedback customization based on their orientation relative to the target angle.

### Configurable Threshold Angular Range

In some embodiments, the haptic navigation device includes a threshold angular range that defines a range of angular deviation within which no vibrotactile output is produced, thereby establishing a null vibration state. The threshold angular range corresponds to a tolerance band around a target heading such that when a current heading of the haptic navigation device falls within the threshold angular range, the processor causes the vibration actuator to produce no vibration. This null vibration state provides a clear indication to the user that the device is aligned with the target heading. The threshold angular range may be expressed in degrees and may extend symmetrically or asymmetrically about the target heading. In certain implementations, the threshold angular range may be defined within a range of approximately 0 degrees to approximately 360 degrees, depending on application requirements. The processor may store the threshold angular range in memory and reference the threshold angular range during operation when computing whether vibrotactile output should be generated.

In some embodiments, the threshold angular range may be configurable by a user or by the system through a graphical user interface. For example, a user may interact with a control element, such as a slider, dial, or input field, to adjust the width of the threshold angular range. In one implementation, a user interface component may define a corridor around the target heading in which no haptic sensation is generated, where the corridor width corresponds to the threshold angular range. The corridor may be adjusted within a range of approximately 0 degrees, corresponding to no tolerance, to approximately 360 degrees, corresponding to complete suppression of vibrotactile output regardless of orientation. In some embodiments, the configurable threshold angular range may be adjusted dynamically based on contextual factors, including user motion, environmental conditions, or application mode. For example, a larger threshold angular range may be used during high-speed movement to reduce sensitivity, while a smaller threshold angular range may be used for precision alignment tasks.

In other embodiments, the threshold angular range may be predetermined and stored in the non-transitory memory without user configurability. In such implementations, the threshold angular range may be selected based on device characteristics, intended use cases, or design considerations. For example, a threshold angular range of approximately 5 degrees to approximately 15 degrees may be selected to balance responsiveness and usability in pedestrian navigation scenarios. The processor may apply the threshold angular range when comparing the computed angular deviation to determine whether to maintain the null vibration state or to generate vibrotactile output. In some embodiments, the threshold angular range may be updated through firmware updates or configuration profiles without requiring direct user interaction.

In certain embodiments, the threshold angular range may correspond to or be implemented using a parameter associated with a haptic control system, such as a corridor parameter that defines a region of no feedback. For example, a haptic wheel system may include a corridor parameter defining the angular width around the target heading where no haptic sensation is produced. The corridor parameter may be represented as an angular value in degrees and may be adjustable through a user interface. The processor may interpret the corridor parameter as the threshold angular range and apply the parameter during mapping of angular deviation to vibrotactile output. The use of such a parameter provides a flexible mechanism for controlling sensitivity of the haptic navigation system.

In operation, the processor continuously computes the angular deviation between the current heading and the target heading and compares the angular deviation to the threshold angular range. When the angular deviation is less than or equal to the threshold angular range, the processor maintains the null vibration state. When the angular deviation exceeds the threshold angular range, the processor causes the vibration actuator to generate vibrotactile output in accordance with a mapping function. The threshold angular range thus functions as a boundary condition separating alignment from misalignment. The presence of the threshold angular range improves usability by preventing unnecessary vibration when the user is sufficiently aligned with the target heading. The described embodiments provide flexibility in defining and applying the threshold angular range while maintaining compatibility with various haptic navigation implementations.

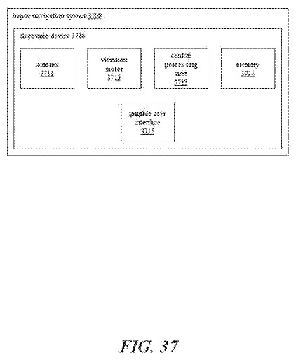

FIG. 37 is a block diagram that describes a haptic navigation system 3700, according to some embodiments of the present disclosure. In some embodiments, the haptic navigation system 3700 may include an electronic device 3710, such as a haptic navigation device. The electronic device 3710 may include one or more sensors 3711, a central processing unit 3713 (CPU), and a graphical user interface 3715 (GUI) configured to interact with the haptic feedback. The electronic device 3710 may also include a vibration motor 3712. The vibration motor 3712 is configured to generate haptic feedback based on mapped patterns based on the orientation of the electronic device 3710 relative to the target. The electronic device 3710 may also include a memory 3714. The memory 3714 is configured to store the mapping of the dynamic haptic patterns.

In some embodiments, at least one angular sensor is provided. The angular sensor is configured to detect angular data of an angle between an orientation of the electronic device 3710 and a target. The CPU is configured to execute instructions to implement the haptic navigation system 3700 to interpret the angular data that may be output from the angular sensor. The translation of the angular data is configured to form a mapping of dynamic haptic patterns. Control of the vibration motor 3712 of the electronic device 3710 may be implemented to correspond to the mapping of the dynamic haptic patterns.

In some embodiments, the memory 3714 may be configured to store predetermined haptic parameter values. In some embodiments, the angular data may be mapped using one or more mapping algorithms. In some embodiments, the haptic feedback may be a vibration output. In some embodiments, the vibration output may be a frequency change. In some embodiments, the vibration output may be an amplitude change.

In some embodiments, the vibration output may be intermittent. In some embodiments, the vibration output may be continuous. In some embodiments, the vibration output may include a range of about 0 Hz to about 1000 Hz. In some embodiments, the vibration output may include a gradient transition from a substantially low intensity to a substantially high intensity according to the orientation determined by the angular data. In some embodiments, the haptic navigation system 3700 may include an adaptive control algorithm to dynamically adjust parameters in real-time. In some embodiments, at least one of geolocation, a gyroscope, and an accelerometer is used.

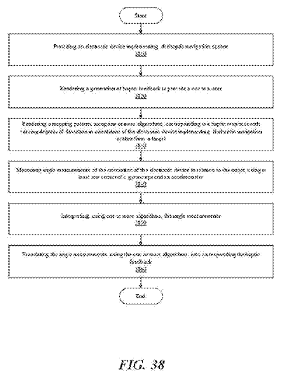

FIG. 38 is a flowchart that describes a method of implementing a haptic navigation system, according to some embodiments of the present disclosure. In some embodiments, at 3810, the method may include providing an electronic device, such as a haptic navigation device, implementing the haptic navigation system. At 3820, the method may include rendering a generation of haptic feedback to provide a cue to a user. At 3830, the method may include rendering a mapping pattern, using one or more algorithms, corresponding to a haptic response with varying degrees of deviation in orientation of the electronic device implementing the haptic navigation system from a target.

In some embodiments, at 3840, the rendering may include measuring angle measurements of the orientation of the haptic navigation device in relation to the target, using at least one sensor of a gyroscope and an accelerometer. At 3850, the rendering may include interpreting, using one or more algorithms, the angle measurements. At 3860, the rendering may include translating the angle measurements, using the one or more algorithms, into corresponding haptic feedback.

In some embodiments, the haptic feedback may be a vibration output. In some embodiments, the vibration output may be a frequency change. In some embodiments, the vibration output may be an amplitude change. In some embodiments, the vibration output may be intermittent. In some embodiments, the vibration output may be continuous. In some embodiments, the vibration output may have a range of about 0 Hz to about 1000 Hz. In some embodiments, the method may include dynamically adjusting parameters in real-time using an adaptive control algorithm.

The Haptic Navigation system may include vibration output, either through alterations in frequency or amplitude, presenting either rhythmic beats or a seamless, continuous haptic sensation. In an embodiment, the haptic output ranges broadly from 0 to 1000 Hz and works in conjunction with a suite of sensors tied to orientation, including geolocation, gyroscope, accelerometer, and similar sensors commonly present in smartphones (typically operating within a general range of 150 to 180 Hz). Further, the strength modulation of the haptic feedback correlates with the movement of the haptic navigation device, including, but not limited to, a smartphone and/or a wearable device. In a first case, no vibration occurs when the haptic navigation device is facing the “correct direction,” and the vibration is gradually intensifying to the highest vibration when facing the wrong direction. In a second case, the highest vibration may be felt when the haptic navigation device is oriented correctly, at which the target object and/or location is substantially coplanar with the haptic navigation device. Thus, reducing to no vibration when facing the wrong direction. The transition between these states forms a smooth gradient based on sensor-derived orientation data.

Moreover, when the haptic navigation device is aligned in the correct direction, a distinctive “heartbeat pulse” haptic feedback is generated to signify the correct orientation. This pulsation may be adjusted within a frequency range of 0 to 5 seconds, functioning as a tempo indicator.

In an embodiment, the Android version incorporates a specific haptic customization interface known as the “Haptic Wheel.” This interface offers similar functionalities to the Haptic Line but is designed differently, providing users with practical functions to tailor their haptic navigation experience according to their preferences and orientation needs.

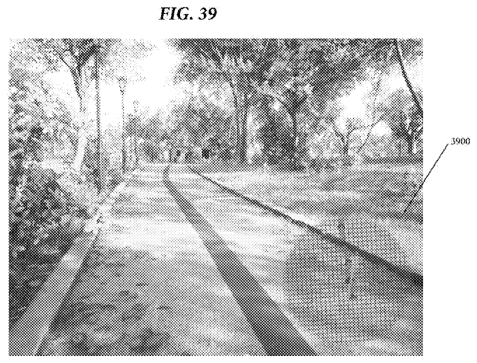

FIG. 39 is an illustration of a Project Guideline simulator 3900 implementing sound and haptic feedback in the haptic navigation system to guide runners, such as a blind marathon runner or any individual. Implementing sound and haptic feedback in the haptic navigation system for guiding runners may include integrating sensor data with an algorithmic framework to create a comprehensive feedback system. The process may begin with the collection of real-time environmental data using sensors such as GPS, accelerometers, gyroscopes, and proximity sensors. These sensors capture the runner's position, movement, orientation, and environmental conditions. The gathered data may then be processed and interpreted through one or more algorithms that compute the optimal route and generate navigation instructions. This algorithm may consider various factors such as the runner's speed, upcoming obstacles, terrain changes, and the desired destination. For haptic feedback, actuators or vibrational motors integrated into wearable devices, such as a mobile device, a ring, a wristband, and/or a belt may be employed to convey directional cues and alerts to the runner. These haptic cues are carefully designed to provide subtle yet distinct vibrations that guide the runner along the designated path. For instance, a series of vibrations on the left side might indicate a left turn, while a continuous vibration might signal an obstacle ahead.

Concurrently, sound feedback is employed to offer supplementary guidance. Audio cues, delivered through headphones or bone conduction devices, complement the haptic feedback. These auditory signals could include spoken instructions or tones representing various directions and alerts, synchronized with the haptic cues. For example, a voice prompt might say, “Turn left in 50 meters,” while a distinct sound could indicate the presence of a critical obstacle. The synchronization of haptic and sound feedback may provide a seamless and intuitive navigation experience. The system may dynamically adjust the frequency, intensity, and combination of haptic vibrations and audio signals based on real-time changes in the running environment, ensuring the runner receives timely and relevant guidance. Moreover, the system may offer options for users to personalize feedback preferences based on their comfort, sensitivity, and individual needs. Accessibility features, such as compatibility with screen readers or support for multiple languages, contribute to making the navigation system inclusive for individuals with varying abilities.

In an embodiment of the haptic wheel navigation system, the process of mapping patterns involves correlating distinct haptic responses with varying degrees of deviation in orientation from a specified target. This mapping procedure is commonly established through a predefined set of rules or algorithms. This mapping may occur when the system first measures the angle or deviation of the user's orientation concerning the target, using sensors such as gyroscopes, accelerometers, and/or similar orientation sensors. Subsequently, a mapping algorithm interprets these angular measurements and translates them into corresponding haptic patterns. This algorithm defines the relationship between the measured angle and the parameters governing haptic feedback, including intensity, duration, and delay. Based on the mapped angular measurements, the system dynamically adjusts various parameters of the haptic feedback. These parameters encompass intensity, determining the strength of the haptic feedback based on the degree of deviation, duration specifying the time for each haptic pulse or vibration, delay indicating the interval between successive haptic pulses, and pulse width defining the shape or duration of each haptic pulse.

Users may customize these parameters through sliders or controls, enabling them to fine-tune intensity, delay, and pulse width in alignment with their preferences or specific requirements. Furthermore, the system continually generates real-time haptic feedback as the user's orientation changes concerning the target. This immediate feedback provides tactile cues, guiding the user toward the desired orientation or target. The mapping process involves interpreting angular measurements via algorithms to ascertain haptic feedback parameters. This enables the system to generate suitable tactile sensations corresponding to the user's orientation concerning the specified target.

Various algorithms can be employed within a haptic navigation system to enhance user interaction and aid navigation. These algorithms encompass Angular Mapping, which interprets orientation sensor data to create corresponding haptic patterns based on the user's orientation in relation to a target. Obstacle Detection algorithms identify obstacles, offering haptic guidance for circumnavigation. Pathfinding algorithms calculate optimal routes and provide directional cues through haptic feedback. Machine Learning or AI-based algorithms adapt feedback based on user behavior or environmental changes. Adaptive Control algorithms dynamically adjust parameters in real-time for consistent feedback. Tactile Pattern Recognition algorithms interpret received haptic patterns for meaningful cues, and Feedback Stability algorithms maintain the reliability and comfort of the haptic experience. Each algorithm contributes to improving the system's ability to provide informative and intuitive haptic guidance during navigation.

In the context of haptic navigation or haptic systems, “rendering” refers to the creation or generation of tactile or haptic feedback. This feedback is rendered in the form of physical sensations or vibrations that users perceive through touch. In the haptic navigation system, various elements might be rendered or generated to provide tactile cues to the user. For instance, the system could render vibrations, pulses, or patterns corresponding to different navigational instructions or environmental conditions. These rendered sensations are felt by the user, providing tactile guidance or information about their surroundings, directions, obstacles, or other relevant cues to aid in navigation or interaction with the system. Rendering involves the creation or generation of specific tactile sensations or patterns that users can feel and interpret through their sense of touch as part of the haptic feedback provided by the system.

The identification of the haptic line system's direction and/or orientation involves the use of computer vision through a camera combined with sensors, to ascertain the positioning and/or directional aspect of the users. This alignment with haptic technology aims to establish control over guiding individuals or enhancing haptic encounters. Integrating computer vision,

AR, and VR settings, whether with or without geo/orientation sensors, allows for outputting sequential haptic cues. These cues serve the purpose of identifying and maintaining the user's intended path and/or offering supplementary navigational guidance.

In some aspects, the techniques described herein relate to a haptic navigation device configured to be communicatively coupled to a target, including, but not limited to including, but not limited to, an object, a user, and/or an individual. The haptic navigation device may include: one or more sensors, including at least an angular sensor, the angular sensor configured to detect angular data of an angle between an orientation of the haptic navigation device and the target; a vibration motor, the vibration motor configured to generate haptic feedback based on mapped patterns based on the orientation of the haptic navigation device relative to the target; a central processing unit (CPU) configured to: execute instructions to implement the haptic navigation device to interpret the angular data that is output from the angular sensor; translate the angular data to form a mapping of dynamic haptic patterns; and control the vibration motor of the haptic navigation device to correspond to the mapping of the dynamic haptic patterns; a memory, the memory to store the mapping of the dynamic haptic patterns; and a graphic user interface (GUI) configured to interact with the haptic feedback.

In some aspects, the techniques described herein relate to a haptic navigation device, wherein the memory is configured to store predetermined haptic parameter values.

In some aspects, the techniques described herein relate to a haptic navigation device, wherein the angular data is mapped using one or more mapping algorithms.

In some aspects, the techniques described herein relate to a haptic navigation device, wherein the haptic feedback is a vibration output.

In some aspects, the techniques described herein relate to a haptic navigation device, wherein the vibration output is a frequency change.

In some aspects, the techniques described herein relate to a haptic navigation device, wherein the vibration output is an amplitude change.

In some aspects, the techniques described herein relate to a haptic navigation device, wherein the vibration output is intermittent.

In some aspects, the techniques described herein relate to a haptic navigation device, wherein the vibration output is continuous.

In some aspects, the techniques described herein relate to a haptic navigation device, wherein the vibration output has a range of about 0 Hz to about 1000 Hz.

In some aspects, the techniques described herein relate to a haptic navigation device, wherein the vibration output has a gradient transition from a substantially low intensity to a substantially high intensity according to the orientation determined by the angular data.

In some aspects, the techniques described herein relate to a haptic navigation device, further including: an adaptive control algorithm to dynamically adjust parameters in real-time.

In some aspects, the techniques described herein relate to a haptic navigation device, wherein the one or more sensors include at least one of geolocation, a gyroscope, and an accelerometer.

In some aspects, the techniques described herein relate to a method of implementing a haptic navigation device configured to be communicatively coupled to a target, including: providing the haptic navigation device; rendering a generation of haptic feedback to provide a cue to a user; and rendering a mapping pattern, using one or more algorithms, corresponding to a haptic response with varying degrees of deviation in orientation of the haptic navigation device implementing the haptic navigation device from the target, including: measuring angle measurements of the orientation of the haptic navigation device in relation to the target, using at least one sensor of a gyroscope and an accelerometer; interpreting, using one or more algorithms, the angle measurements; and translating the angle measurements, using the one or more algorithms, into corresponding haptic feedback.

In some aspects, the techniques described herein relate to a method, wherein the haptic feedback is a vibration output.

In some aspects, the techniques described herein relate to a method, wherein the vibration output is a frequency change.

In some aspects, the techniques described herein relate to a method, wherein the vibration output is an amplitude change.

In some aspects, the techniques described herein relate to a method, wherein the vibration output is intermittent.

In some aspects, the techniques described herein relate to a method, wherein the vibration output is continuous.

In some aspects, the techniques described herein relate to a method, wherein the vibration output has a range of about 0 Hz to about 1000 Hz.

In some aspects, the techniques described herein relate to a method, further including: dynamically adjusting parameters in real-time using an adaptive control algorithm.

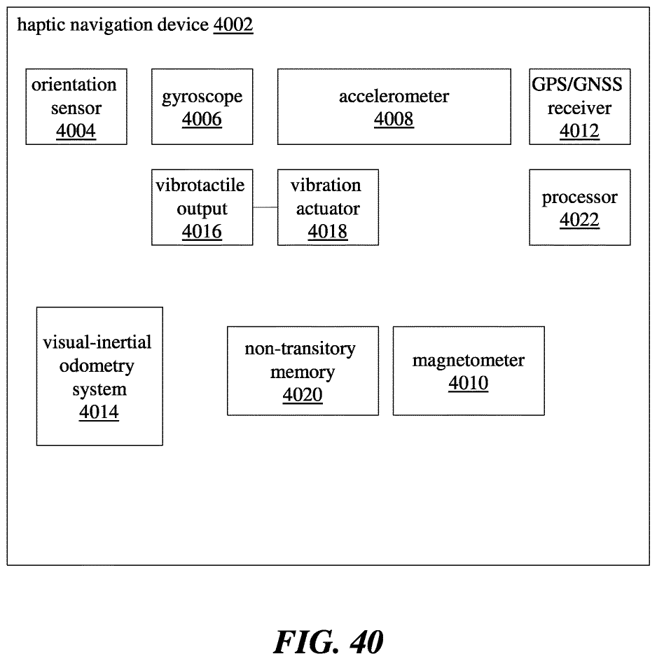

FIG. 40 illustrates a schematic block diagram of a haptic navigation device 4002 configured to generate directional guidance through vibrotactile output based on a deviation between a current device orientation and a target heading. The haptic navigation device 4002 includes one or more orientation sensors 4004, which may comprise a gyroscope 4006, an accelerometer 4008, a magnetometer 4010, a GPS/GNSS receiver 4012, and a visual-inertial odometry system 4014. These components may operate independently or in combination to provide sensor fusion data representing angular position, heading, and movement dynamics of the device relative to a reference frame. In some embodiments, the orientation sensors 4004 continuously sample environmental and motion data at a defined frequency range, such as between 10 Hz and 500 Hz, to ensure responsive and accurate heading estimation. The sensor outputs may be preprocessed to reduce noise through filtering techniques such as Kalman filtering, complementary filtering, or other sensor fusion algorithms. The resulting processed orientation data is transmitted to a processor 4022 for further computation.

The processor 4022 is configured to compute an angular deviation between a current heading of the haptic navigation device 4002 and a target heading derived from a planned navigation route stored in non-transitory memory 4020. In some embodiments, the planned navigation route may include a sequence of waypoints, vectors, or directional segments, each associated with a target heading relative to the user's current position. The processor 4022 may determine the current heading using a combination of magnetometer and gyroscope data, optionally corrected using GPS/GNSS data or visual-inertial odometry data to improve accuracy in dynamic environments. The angular deviation may be computed as an absolute angular difference between the current heading and the target heading, such as within a range of 0 degrees to 180 degrees. In some implementations, the angular deviation calculation may account for wraparound conditions at 360 degrees and may normalize values to ensure consistent mapping. The computed angular deviation is then used as an input to a vibrotactile mapping function that governs output behavior of the vibration actuator 4018.

The vibration actuator 4018 is configured to generate vibrotactile output 4016 based on control signals received from the processor 4022. In some embodiments, the vibration actuator 4018 may comprise a linear resonant actuator, an eccentric rotating mass motor, a piezoelectric actuator, or a multi-actuator array distributed across a wearable surface. The processor 4022 causes the vibration actuator 4018 to produce a null vibration state when the angular deviation is within a configurable threshold angular range of the target heading. The configurable threshold angular range may be defined within the non-transitory memory 4020 and may include values such as 0 degrees to 15 degrees, 0 degrees to 30 degrees, or other selectable ranges depending on user preference or application requirements. When the angular deviation falls within this threshold angular range, the absence of vibration provides an indication that the device is aligned with the target heading. This null-state encoding reduces cognitive load and allows the user to intuitively maintain direction without continuous stimulation.

When the angular deviation exceeds the configurable threshold angular range, the processor 4022 causes the vibration actuator 4018 to increase vibration intensity proportionally as the angular deviation increases. In some embodiments, the proportional increase may follow a linear mapping function, while in other embodiments it may follow a non-linear mapping such as exponential, logarithmic, or piecewise functions to enhance perceptual sensitivity. The vibration intensity may reach a maximum value at approximately 180 degrees of deviation from the target heading, representing a condition where the device is oriented in a substantially opposite direction from the desired path. The transition from the null vibration state to maximum intensity may be continuous, thereby creating a gradient-based tactile cue that guides the user toward the correct orientation. This gradient-based encoding allows the user to adjust direction in real time without reliance on visual or audio feedback, thereby improving usability in scenarios involving visual impairment or attention constraints.

In some embodiments, the vibrotactile output 4016 generated by the vibration actuator 4018 comprises simultaneous modulation of both vibration frequency and vibration amplitude. The processor 4022 may independently or jointly control these parameters such that both frequency and amplitude increase proportionally with angular deviation. For example, vibration amplitude may increase within a range of approximately 0.1 g to 2.0 g, while vibration frequency may increase within a range of approximately 50 Hz to 300 Hz as deviation increases. In some implementations, amplitude may encode magnitude of deviation while frequency encodes rate of correction required, thereby providing multidimensional tactile information. The simultaneous modulation of frequency and amplitude enhances perceptual resolution and allows users to distinguish fine-grained directional differences. This dual-parameter modulation may be particularly beneficial in high-noise environments or when users are engaged in other tasks.

The non-transitory memory 4020 stores the planned navigation route as well as configuration parameters used by the processor 4022 to control vibrotactile output. The stored data may include waypoint coordinates, heading vectors, threshold angular ranges, mapping functions, actuator control parameters, and user-specific calibration profiles. In some embodiments, the planned navigation route may be dynamically updated based on real-time positioning data, environmental conditions, or user inputs. The memory 4020 may also store historical navigation performance data that may be used to refine mapping functions or adjust sensitivity thresholds. The processor 4022 may access and update this stored information during operation to maintain accurate and responsive navigation behavior.

In operation, the haptic navigation device 4002 continuously receives sensor data, computes angular deviation, and updates vibrotactile output in real time. The closed-loop system enables immediate tactile feedback corresponding to changes in user orientation, thereby facilitating intuitive navigation without requiring a graphical display or audio output. The architecture shown in FIG. 40 allows for compact integration into various device form factors, including wearable devices such as wristbands, rings, belts, or head-mounted displays. The modular arrangement of components further enables scalability and customization based on application-specific requirements. This configuration provides an efficient and responsive mechanism for translating spatial orientation into tactile guidance signals, thereby improving navigation performance in a wide range of environments.

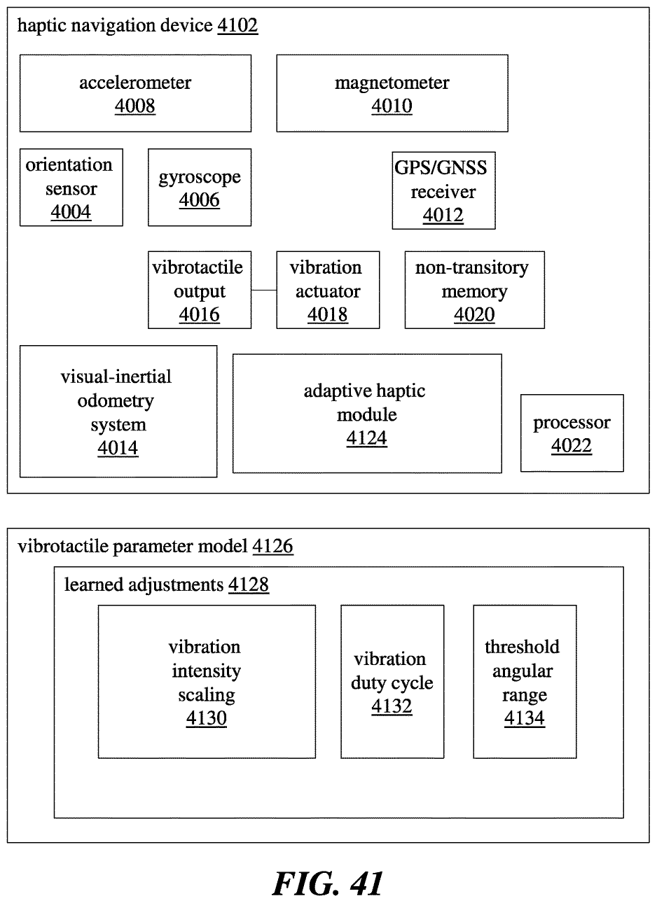

FIG. 41 illustrates a schematic block diagram of a haptic navigation device 4102 further comprising an adaptive haptic module 4124 configured to dynamically refine vibrotactile output based on navigation performance data. The haptic navigation device 4102 may include one or more orientation sensors 4004, such as a gyroscope 4006, an accelerometer 4008, a magnetometer 4010, a GPS/GNSS receiver 4012, and a visual-inertial odometry system 4014, which collectively provide orientation and positional data. The device 4102 further includes a processor 4022, a vibration actuator 4018 configured to generate vibrotactile output 4016, and a non-transitory memory 4020 storing a planned navigation route and associated parameters. In addition to these components, the adaptive haptic module 4124 is operatively coupled to the processor 4022 and is configured to enable real-time adaptation of haptic feedback characteristics based on observed navigation performance. The adaptive haptic module 4124 may be implemented as software instructions executed by the processor 4022, as a dedicated co-processor, or as a hybrid hardware-software module.

The processor 4022 is further configured to receive navigation performance data collected during operation of the haptic navigation device 4102. The navigation performance data may include time-to-destination measurements representing elapsed time required for a user to reach a target location, heading deviation event frequency indicating how often the user deviates beyond a defined angular threshold, and waypoint miss event counts representing instances in which the user fails to pass within a defined proximity of a designated waypoint. In some embodiments, additional performance metrics may include path efficiency ratios, correction latency, dwell time at incorrect headings, or user-specific behavioral patterns. The navigation performance data may be accumulated over one or more navigation sessions and stored within the non-transitory memory 4020 or a dedicated data structure accessible by the adaptive haptic module 4124. The processor 4022 may preprocess the navigation performance data to normalize values, remove outliers, and generate statistical summaries suitable for model updates.

Based on the received navigation performance data, the processor 4022 is configured to update a vibrotactile parameter model 4126. The vibrotactile parameter model 4126 may comprise learned adjustments 4128 to one or more haptic output parameters that govern operation of the vibration actuator 4018. These learned adjustments 4128 may include vibration intensity scaling 4130, threshold angular range 4134, and vibration duty cycle 4132. In some embodiments, the vibration intensity scaling 4130 may define a mapping factor that adjusts the rate at which vibration amplitude increases relative to angular deviation. The threshold angular range 4134 may define the angular window within which a null vibration state is produced, and may be dynamically widened or narrowed based on user performance. The vibration duty cycle 4132 may define the ratio of active vibration time to inactive time within a given period, thereby controlling the perceived rhythm or continuity of the haptic output. The vibrotactile parameter model 4126 may be implemented using rule-based logic, regression models, lookup tables, or machine learning models such as lightweight neural networks or decision trees optimized for embedded execution.

The processor 4022 is further configured to adjust one or more vibrotactile output parameters based on the updated vibrotactile parameter model 4126. For example, if navigation performance data indicates frequent heading deviation events, the processor 4022 may increase vibration intensity scaling 4130 or reduce the threshold angular range 4134 to provide more sensitive feedback. Conversely, if the user demonstrates stable navigation performance, the processor 4022 may decrease vibration intensity scaling or increase the threshold angular range to reduce unnecessary stimulation. Adjustments to the vibration duty cycle 4132 may be used to alter the temporal characteristics of the vibrotactile output, such as transitioning between intermittent pulses and continuous vibration patterns. These adjustments enable the haptic navigation device 4102 to personalize feedback in accordance with user behavior and environmental conditions, thereby improving navigation efficiency and user comfort.

In some embodiments, the processor 4022 executes model inference associated with the vibrotactile parameter model 4126 entirely on-device without requiring network connectivity during active navigation. This on-device execution ensures low-latency response, preserves user privacy by avoiding transmission of performance data to external servers, and enables operation in environments where network connectivity is limited or unavailable. The model inference process may include evaluating input features derived from navigation performance data, applying learned parameter adjustments, and generating updated control signals for the vibration actuator 4018. The computational workload associated with model inference may be optimized for embedded processing by using quantized models, reduced parameter sets, or hardware acceleration features available within the processor 4022.

During operation, the adaptive haptic module 4124 continuously or periodically updates the vibrotactile parameter model 4126 and applies corresponding adjustments to the vibrotactile output 4016. The feedback loop established between navigation performance data, model updates, and actuator control enables the haptic navigation device 4102 to evolve its behavior over time. This adaptive capability enhances the effectiveness of the vibrotactile guidance by aligning output characteristics with user-specific navigation patterns and contextual factors. The architecture illustrated in FIG. 41 therefore provides a self-optimizing haptic navigation system that maintains responsiveness while improving accuracy and usability through on-device learning and parameter adaptation.

In some embodiments, the vibrotactile parameter model 4126 of the adaptive haptic module 4124 is implemented as a decision tree classifier having a maximum tree depth of between 3 and 8 levels. The decision tree may occupy less than approximately 10 kilobytes (KB) of non-transitory memory 4020. The decision tree evaluates input features derived from navigation performance data and outputs one or more learned adjustments 4128 to vibrotactile output parameters. In some embodiments, the input features comprise at least: a time-to-destination metric representing a ratio of actual elapsed navigation time to an estimated minimum navigation time for a given route segment; a heading deviation frequency metric representing a count of heading deviation events exceeding a defined angular threshold per unit time; and a waypoint miss count metric representing a number of designated waypoints that the user failed to pass within a defined proximity threshold during a navigation session. Additional input features may include an average correction latency metric representing the mean time required for the user to return to within the threshold angular range after a deviation event, and a dwell time metric representing the cumulative time the user remained at an angular deviation exceeding a defined threshold.

In other embodiments, the vibrotactile parameter model 4126 is implemented as a quantized neural network having fewer than approximately 10,000 parameters. The neural network parameters may be quantized to 8-bit integers, and the total model size may occupy less than approximately 100 kilobytes (KB) of non-transitory memory 4020. The neural network may comprise an input layer receiving the navigation performance features described above, one or more hidden layers each containing between 8 and 64 neurons with a rectified linear unit (ReLU) activation function, and an output layer producing predicted values for vibration intensity scaling 4130, vibration duty cycle 4132, and threshold angular range 4134.

In some embodiments, the processor 4022 executes model inference using an embedded machine learning runtime compatible with microcontroller architectures, such as an ARM Cortex-M4 processor having approximately 256 KB of flash memory and approximately 64 KB of static random-access memory (SRAM). The inference latency for a single model prediction may be less than approximately 10 milliseconds for the decision tree implementation and less than approximately 50 milliseconds for the quantized neural network implementation. The processor 4022 may execute model inference at a rate of once per navigation session, once per route segment, or at periodic intervals during navigation, such as every 30 seconds to every 5 minutes, depending on the rate of change of navigation performance data.

In some embodiments, the vibrotactile parameter model 4126 is trained using on-device learning from navigation performance data accumulated over a minimum of approximately 5 navigation sessions. A convergence criterion for model training may be defined as a reduction of at least approximately 10 percent in the heading deviation frequency metric over a rolling window of the most recent 10 navigation sessions compared to the 10 navigation sessions preceding the most recent model update. In some embodiments, the model may be initialized with default parameter values and may progressively adapt to user-specific navigation patterns over time. The default parameter values may be stored in the non-transitory memory 4020 as a fallback configuration that is applied when insufficient navigation performance data is available for model training, such as during the first 5 navigation sessions.

In some embodiments, the adaptive haptic module 4124 applies boundary constraints to the learned adjustments 4128 to prevent the vibrotactile output parameters from exceeding operationally safe or perceptually effective ranges. The vibration intensity scaling 4130 may be constrained to a range of approximately 0.3 to approximately 3.0 relative to a baseline intensity value. The threshold angular range 4134 may be constrained to a range of approximately 5 degrees to approximately 45 degrees. The vibration duty cycle 4132 may be constrained to a range of approximately 20 percent to approximately 100 percent. These boundary constraints ensure that learned adjustments do not result in imperceptible vibrotactile output at the lower bound or uncomfortable or disorienting vibrotactile output at the upper bound.

In some embodiments, the haptic navigation device is implemented as an augmented reality glasses device or a head-mounted display comprising a frame configured to be worn by a user. The frame serves as a structural support for integrated sensing, processing, and actuation components that collectively enable haptic navigation functionality. The vibration actuator of the device may be incorporated into the frame such that vibrotactile signals are delivered directly to regions of the user's head or face that are in contact with the frame. This configuration allows the device to operate as a self-contained navigation system without reliance on external peripherals. The integration of components within the frame reduces system latency and improves responsiveness of haptic feedback. The wearable nature of the device further enables continuous navigation assistance during user movement. In some implementations, the frame may be constructed from materials selected to enhance transmission of vibrotactile signals while maintaining user comfort.

In certain embodiments, the vibration actuator comprises a bone conduction transducer mounted at a temple contact point of the frame of the AR glasses device. The bone conduction transducer is configured to transmit vibration signals through cranial bone structures, thereby stimulating the user's somatosensory system. In other embodiments, the vibration actuator comprises a linear resonant actuator embedded within the frame of the AR glasses device, wherein the actuator generates localized vibrotactile output at specific contact points along the frame. In further embodiments, the vibration actuator comprises a vibrotactile array integrated into the frame of the head-mounted display, wherein multiple actuator elements are distributed across different regions of the frame to provide spatially varied haptic signals. These actuator types may be used individually or in combination to achieve desired haptic effects. The placement and configuration of the actuators may be optimized based on ergonomic considerations and signal fidelity requirements. In some implementations, actuator control signals may be coordinated to produce composite vibration patterns corresponding to navigation cues.

In operation, the processor is configured to cause the vibration actuator to deliver a null vibration state when an angular deviation between a current heading and a target heading is within a configurable threshold angular range. When the angular deviation exceeds the configurable threshold angular range, the processor causes the vibration actuator to produce a vibrotactile gradient output in which vibration intensity increases proportionally with the angular deviation. The vibrotactile gradient output may be perceived by the user as a continuous directional cue indicating misalignment with the target heading. The null vibration state provides a clear indication that the user is aligned with the intended navigation direction. The transition from the null vibration state to increasing vibration intensity enables intuitive correction of heading without requiring visual attention. In some embodiments, the gradient output may extend to a maximum intensity corresponding to approximately 180 degrees of deviation. The vibrotactile signals are delivered directly through the frame of the AR glasses device to the wearer without requiring a separate wristband or smartphone.

In further embodiments, the system may be implemented as a haptic navigation system comprising a processor and a vibration actuator, wherein the processor is configured to compute an angular deviation between a sensed orientation and a target heading derived from a navigation route stored in memory. The processor maps the angular deviation to a vibrotactile gradient output such that vibration intensity is at a null state when the angular deviation is within a threshold of the target heading and increases continuously as the angular deviation increases. The mapping may be linear, nonlinear, or based on a predefined function stored in memory. The vibration intensity may reach a maximum value at approximately 180 degrees of angular deviation. The system operates without requiring a graphical display output, thereby enabling eyes-free navigation. In some implementations, the absence of a graphical interface reduces cognitive load and enhances usability in dynamic environments. The processor may execute these functions in real time to provide immediate feedback responsive to user movement.

In some embodiments, the target heading is derived from a target comprising a physical geographic location specified by coordinates. In other embodiments, the target may comprise a physical device broadcasting a wireless identifier, such as a Bluetooth Low Energy or Ultra-Wideband signal. In further embodiments, the target may comprise a vehicle, a person whose position is tracked by a positioning system, or a physical asset tagged with a wireless identifier. The processor may determine the target heading by computing a relative direction between the current position of the user and the target. In some implementations, the system may continuously update the target heading based on changes in user position or target movement. The flexibility in target types allows the system to be used in a variety of navigation and tracking scenarios. The use of wireless identifiers enables proximity-based navigation in environments where geographic coordinates may be unavailable or unreliable.

In additional embodiments, the processor is further configured to generate context-specific vibrotactile patterns based on proximity detection and identifier matching. For example, the processor may generate a wrong-vehicle alert pattern comprising a rapid alternating vibrotactile pattern when proximity to a vehicle is detected and a received identifier does not match a stored identifier of a target vehicle. This pattern provides a clear indication that the detected vehicle is not the intended target. Conversely, the processor may generate a vehicle-confirmed pattern comprising a distinct confirmation vibrotactile pattern when proximity to the target vehicle is confirmed by a match between the received identifier and the stored identifier. These patterns may be distinguishable in frequency, amplitude, or temporal structure to convey different meanings to the user. The use of distinct vibrotactile patterns enables communication of contextual information without reliance on visual or auditory cues. In some implementations, these patterns may be customizable based on user preferences or application requirements. The integration of identifier-based pattern generation enhances the functionality of the haptic navigation system in real-world scenarios involving dynamic targets.

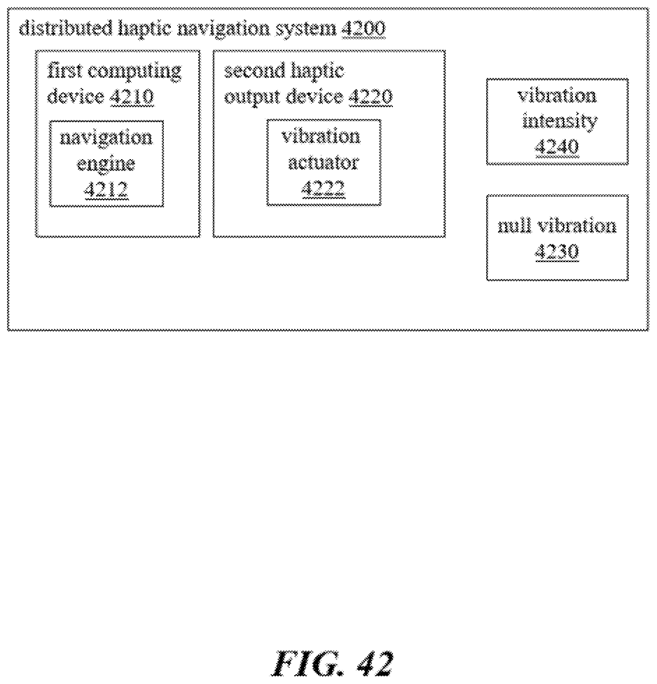

Referring to FIG. 42, a distributed haptic navigation system 4200 is illustrated, comprising a first computing device 4210 and a second haptic output device 4220 that are communicatively coupled via a short-range wireless protocol. The first computing device 4210 includes a navigation engine 4212 configured to receive route data and determine navigation-related parameters associated with a user. In some embodiments, the navigation engine 4212 processes route data obtained from a mapping service, local storage, or a remote navigation platform. The first computing device 4210 is further configured to determine a current position and a current heading of the user based on one or more sensor inputs or positioning systems. These inputs may include, for example, satellite-based positioning signals, inertial measurement data, or visual-inertial tracking data. The navigation engine 4212 computes an angular deviation between the current heading of the user and a target heading associated with the received route data. The computed angular deviation is used as a control parameter for generating haptic guidance signals.

The second haptic output device 4220 comprises a vibration actuator 4222 configured to generate vibrotactile output based on control signals received from the first computing device 4210. The second haptic output device 4220 may be implemented as a wearable device, a handheld device, or an embedded component within another user-facing system. The communication between the first computing device 4210 and the second haptic output device 4220 is achieved using a short-range wireless protocol, which may include Bluetooth, Bluetooth Low Energy, Ultra-Wideband, or other low-latency communication technologies. This communication link enables the transmission of vibrotactile output parameters from the first computing device 4210 to the second haptic output device 4220 in real time. In some embodiments, the transmitted parameters may include encoded representations of angular deviation, vibration intensity values, frequency parameters, or duty cycle characteristics. The separation of navigation computation and haptic output generation allows each device to be optimized for its respective function.

In operation, the first computing device 4210 transmits vibrotactile output parameters corresponding to the computed angular deviation to the second haptic output device 4220. The second haptic output device 4220 receives the transmitted parameters and controls the vibration actuator 4222 to generate vibrotactile output encoding the angular deviation. As illustrated in FIG. 42, the vibrotactile output includes a null vibration state 4230 when the angular deviation is within a configurable threshold. This null vibration state indicates that the user's current heading is aligned with the target heading. When the angular deviation exceeds the configurable threshold, the vibration actuator 4222 generates vibrotactile output having a vibration intensity 4240 that increases proportionally with the magnitude of the angular deviation. The proportional relationship between angular deviation and vibration intensity provides a continuous feedback mechanism that guides the user toward alignment with the target heading.

In some embodiments, the configurable threshold defines an angular range within which no vibration is produced, thereby creating a tolerance band for alignment. The proportional increase in vibration intensity beyond the threshold may be implemented using a linear scaling function, a nonlinear mapping, or a lookup table stored in memory. The vibration intensity 4240 may be further modulated in conjunction with other parameters such as frequency or duty cycle to enhance perceptual clarity. The second haptic output device 4220 may generate the vibrotactile output independently based on received parameters without requiring continuous high-bandwidth communication. This enables efficient operation and reduces power consumption in the distributed system. In some implementations, the second haptic output device 4220 may include local processing capabilities to interpret received parameters and control the vibration actuator accordingly.

In further embodiments, the distributed haptic navigation system 4200 may support continuous updates of vibrotactile output parameters as the user moves along a route. The first computing device 4210 may continuously recompute the angular deviation based on updated position and heading data and transmit updated parameters to the second haptic output device 4220. The communication protocol may be configured to ensure low latency and reliable delivery of control signals. In some embodiments, acknowledgment or synchronization mechanisms may be employed to maintain consistency between transmitted parameters and generated haptic output. The system may also support dynamic adjustment of the configurable threshold based on user preferences or environmental conditions.

In additional embodiments, the distributed architecture enables flexibility in device configurations, allowing the first computing device 4210 to be implemented as a smartphone, wearable computer, or dedicated navigation unit, while the second haptic output device 4220 may be implemented as a wristband, wearable accessory, or integrated actuator module. The separation of computation and actuation allows the system to scale across multiple devices and use cases. The vibrotactile encoding of angular deviation enables navigation guidance without reliance on visual displays or audio output, thereby supporting eyes-free and hands-free operation. The distributed haptic navigation system 4200 thus provides an efficient and intuitive mechanism for conveying directional information through tactile feedback.

### Multi-Device Distributed Architecture

In some embodiments, the haptic navigation system is implemented using a distributed architecture in which navigation computation and haptic output delivery are performed across multiple communicatively coupled devices. In a phone-plus-wearable configuration, the system comprises a first computing device and a second haptic output device that are configured to operate cooperatively to provide navigation guidance. The first computing device may comprise a smartphone executing a navigation engine configured to process route data and determine navigation parameters associated with a user. The second haptic output device may comprise a wrist-worn device, smartwatch, wristband, or other wearable device including a vibration actuator configured to deliver vibrotactile output to the user. The two devices are communicatively coupled via a short-range wireless protocol, including Bluetooth, Bluetooth

Low Energy, or Ultra-Wideband. This distributed configuration enables separation of computational tasks and haptic delivery functions while maintaining coordinated operation between devices. The architecture supports scalable deployment across a variety of consumer and enterprise hardware platforms.

In operation, the first computing device is configured to receive route data from a navigation service, determine a current position of the user using positioning systems, and determine a current heading based on sensor inputs. The first computing device computes an angular deviation between the current heading and a target heading derived from the route data. Based on the computed angular deviation, the first computing device generates vibrotactile output parameters representing a haptic encoding of the deviation. These parameters may include vibration intensity values, frequency values, duty cycle parameters, or encoded representations of the angular deviation. The first computing device transmits the vibrotactile output parameters to the second haptic output device using the short-range wireless protocol. The transmission may occur continuously or at periodic intervals to provide real-time updates as the user moves.

The second haptic output device receives the transmitted vibrotactile output parameters and generates vibrotactile output using the vibration actuator. The vibrotactile output encodes the angular deviation using a null vibration state when the angular deviation is within a configurable threshold and a gradient-intensity encoding when the angular deviation exceeds the threshold. The vibration intensity increases proportionally as the angular deviation increases, thereby providing continuous directional feedback to the user. The haptic output device may include local processing capabilities to interpret received parameters and control the vibration actuator accordingly. The separation of navigation computation and haptic actuation allows the wearable device to operate with reduced processing requirements and lower power consumption.

The user receives directional guidance directly through tactile feedback delivered at the wearable device.

In some embodiments, the distributed architecture maintains consistency of the null-state and gradient-intensity encoding across both devices. The mapping between angular deviation and vibrotactile output parameters may be defined and enforced by the first computing device to ensure uniform behavior. The second haptic output device may implement standardized control logic to reproduce the intended vibrotactile output based on received parameters. In some implementations, synchronization mechanisms may be employed to ensure timely and accurate delivery of haptic signals. The communication protocol may be optimized for low latency and reliability to support real-time navigation guidance. The distributed architecture allows the system to leverage the computational resources, network connectivity, and sensor capabilities of the first computing device while utilizing the ergonomic advantages of the wearable device for haptic delivery.

In further embodiments, the distributed architecture enables flexible system configurations in which different types of computing devices and wearable devices may be paired. The first computing device may comprise a smartphone, tablet, or other portable computing system, while the second haptic output device may comprise various wearable form factors. The architecture may support dynamic pairing and disconnection of devices during operation. In some implementations, multiple haptic output devices may be controlled by a single computing device to provide redundant or multi-location feedback. The distributed system may also support firmware updates or parameter adjustments transmitted from the first computing device to the second haptic output device. The described architecture enhances usability, scalability, and adaptability of the haptic navigation system across diverse deployment scenarios. AR/VR Wearable Haptic Delivery

In some embodiments, the haptic navigation device is implemented as an augmented reality (AR) glasses device or a head-mounted display (HMD) configured to deliver vibrotactile navigation guidance directly through a wearable frame in contact with a user. In these embodiments, the device integrates one or more vibration actuators within structural components of the frame such that vibrotactile output is transmitted directly to the user without requiring a separate handheld or body-worn device. The wearable configuration enables continuous, unobtrusive delivery of haptic guidance while maintaining a compact form factor suitable for extended use. The integration of sensing, processing, and actuation components within the AR or HMD platform allows the system to operate as a self-contained navigation device. The wearable architecture further enables alignment of haptic output with natural head movements, thereby enhancing intuitive interpretation of directional cues. This configuration supports applications in assistive navigation, augmented environments, and scenarios requiring hands-free operation. Bone Conduction and Frame-Embedded Actuator Delivery

In certain embodiments, the vibration actuator may comprise a bone conduction transducer mounted at a temple contact point of the AR glasses frame, wherein the transducer is configured to transmit vibrotactile signals through cranial bone structures to stimulate the user's somatosensory system. In other embodiments, the vibration actuator may comprise a linear resonant actuator embedded within the frame material of the AR glasses, wherein the actuator delivers localized vibrations at discrete contact regions between the frame and the user's skin. In further embodiments, the vibration actuator may comprise a vibrotactile array integrated into an inner surface of the head-mounted display frame, wherein multiple actuator elements are distributed across regions of contact with the user's face or head. These actuator configurations may operate independently or in combination to provide spatially distributed or localized haptic signals. The actuator placement within the frame may be selected to optimize signal transmission efficiency, user comfort, and perceptual clarity. In some implementations, actuator control signals are synchronized across multiple actuators to create composite vibration patterns or directional cues. The use of frame-embedded actuators enables direct coupling of vibrotactile output to the user without reliance on external devices such as wristbands or smartphones.

In these embodiments, the processor of the haptic navigation device is configured to deliver a null vibration state when an angular deviation is within a configurable threshold angular range and to deliver increasing vibration intensity as the angular deviation increases beyond the configurable threshold angular range. The vibrotactile output is transmitted directly through the AR glasses frame to the wearer, thereby providing navigation guidance without requiring visual or audio feedback. The one or more orientation sensors may include inertial measurement unit components of the AR or HMD device, such as gyroscopes and accelerometers, as well as magnetometers and camera-based visual-inertial odometry systems. These sensing components may be integrated into the wearable device and configured to provide real-time orientation and positional data. The integration of these sensors with the actuator system allows the device to generate haptic feedback that is dynamically responsive to user movement. The direct delivery of vibrotactile output through the frame enables seamless interaction between sensing and feedback subsystems.

### Head-Orientation-Based Heading Computation

In AR and HMD embodiments, the processor is further configured to compute angular deviation based on a head orientation of the user as measured by the orientation sensors of the wearable device. The head orientation may be derived from inertial measurement unit data and may be further refined using simultaneous localization and mapping (SLAM) processing performed using one or more onboard cameras. The processor determines a current heading corresponding to a forward-facing direction of the user's head and compares this current heading to a target heading derived from a planned navigation route. The angular deviation is calculated as a difference between the current heading and the target heading, and the resulting value is used to control vibrotactile output. In some embodiments, the angular deviation may be normalized within a range of 0 degrees to 180 degrees and may account for rotational wraparound conditions. The vibrotactile output is then generated such that no vibration is produced when the angular deviation is within the configurable threshold angular range, and vibration intensity increases as the angular deviation increases beyond the threshold.

This head-orientation-based computation enables navigation guidance that is directly aligned with the user's natural field of view and head movement. Because the system does not require a visual display or audio prompt to convey directional information, it allows for eyes-free and hands-free navigation. The user may adjust direction by simply rotating their head until the null vibration state is achieved, thereby indicating alignment with the target heading. In some implementations, the system may update the target heading dynamically based on waypoint progression or route recalculation. The integration of head-orientation sensing with frame-based haptic delivery provides an intuitive and low-latency navigation interface suitable for immersive and assistive applications.

### Vibrotactile Perception at Cranial Contact Points

In embodiments where the haptic navigation device is implemented as augmented reality glasses or a head-mounted display, the vibration actuator may comprise a bone conduction transducer configured to transmit vibrotactile signals through cranial bone structures. Bone conduction transducers transmit mechanical vibrations through direct contact with the skin and underlying bone, bypassing the outer and middle ear. While bone conduction is conventionally employed for audio signal transmission at frequencies above approximately 500 Hz, the present disclosure utilizes bone conduction transducers to deliver vibrotactile navigation signals at frequencies below the auditory perception threshold of bone-conducted sound.

In some embodiments, the bone conduction transducer operates within a vibrotactile frequency range of approximately 20 Hz to approximately 250 Hz. Within this frequency range, the mechanical vibrations transmitted through the cranial bone at the temple contact point are perceived primarily by cutaneous mechanoreceptors, including slow-adapting type I (SA-I), slow-adapting type II (SA-II), and fast-adapting type I (FA-I) afferents in the skin and periosteum. Research in vibrotactile sensitivity of the human head has established that tactile detection thresholds on the temporal bone region are measurable within the range of approximately 32 Hz to approximately 250 Hz, with sensitivity varying as a function of stimulus frequency and contact area. (See Morioka, M. and Griffin, M. J., “Vibrotactile thresholds on the mastoid and forehead,” Ear and Hearing, vol. 38, no. 6, pp. e359-e364, 2017.)

In some embodiments, the vibrotactile frequency range is selected to be below the auditory perception threshold of bone-conducted sound. Auditory perception through bone conduction typically begins at frequencies above approximately 500 Hz in humans with normal hearing. (See Walker, B. N. and Stanley, R. M., “Thresholds of audibility for bone-conduction headsets,” Proceedings of the International Conference on Auditory Display, 2005.) By operating the bone conduction transducer at frequencies below approximately 250 Hz, the system delivers navigation guidance as a tactile sensation perceived through the somatosensory system rather than as an audible signal perceived through the auditory system. This separation between vibrotactile and auditory perception channels enables the haptic navigation device to deliver navigation feedback without interfering with the user's ability to perceive ambient sounds, spoken communications, or auditory alerts.

In certain embodiments, the facial region in contact with the frame of the AR glasses device, including the temple, forehead, and periorbital regions, lacks Pacinian corpuscles, which are mechanoreceptors responsible for detecting high-frequency vibrations at approximately 200 Hz to approximately 300 Hz in other body regions such as the fingertips and palms. (See Barlow, S. M., “Mechanical frequency detection thresholds in the human face,” Experimental Neurology, vol. 96, no. 2, pp. 253-261, 1987.) The absence of Pacinian corpuscles in the facial region has been shown to enable perception of amplitude-modulated vibrotactile signals as pure low-frequency sensations in the range of approximately 2 Hz to approximately 16 Hz, without the high-frequency “noise” component that would be perceived by Pacinian corpuscles at other body locations. (See Akiba, Y. et al., “Presentation of Low-Frequency Vibration to the Face Using Amplitude Modulation,” arXiv: 2508.01155, 2025.) This perceptual characteristic of the facial skin enables the bone conduction transducer mounted at the temple contact point to deliver navigation guidance signals that are perceived as clean, distinct tactile patterns suitable for encoding angular deviation information.

In some embodiments, the vibration amplitude of the bone conduction transducer at the temple contact point is within a range of approximately 0.05 g to approximately 2.0 g of peak acceleration, where g is the acceleration due to gravity (approximately 9.81 m/s\hat{ }2). The lower bound of the amplitude range corresponds to a level above the vibrotactile detection threshold at the temple for frequencies within the vibrotactile frequency range. The upper bound of the amplitude range corresponds to a level below the discomfort threshold for prolonged vibrotactile stimulation at the temple. In some embodiments, the vibration amplitude is modulated proportionally to the angular deviation between the current heading and the target heading, with the amplitude at the null vibration state being approximately 0 g and the amplitude at maximum deviation (approximately 180 degrees) being within the range of approximately 0.5 g to approximately 2.0 g.

In further embodiments, the bone conduction transducer may comprise a balanced armature transducer, a piezoelectric bending element, or a linear resonant actuator mechanically coupled to a rigid contact surface of the AR glasses frame. The contact surface may be constructed from a rigid material, such as titanium, stainless steel, or a rigid polymer, to maximize transmission efficiency of vibrotactile signals from the transducer to the temple. A compliant coupling layer, such as a silicone pad or elastomeric gasket, may be interposed between the contact surface and the skin to maintain consistent contact pressure while accommodating variations in head geometry across users.

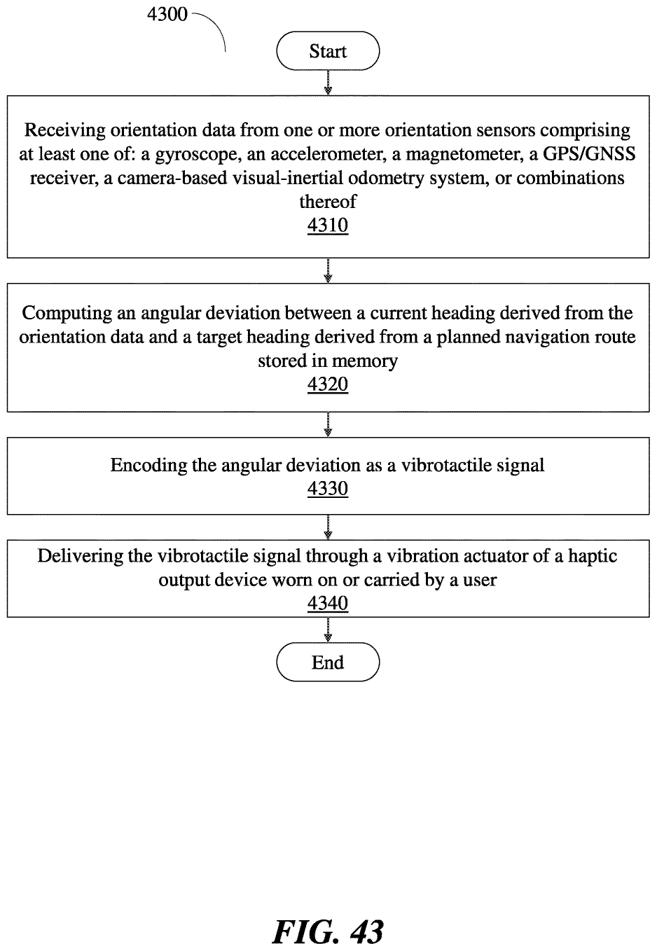

Referring to FIG. 43, a method 4300 for haptic navigation is illustrated. The method begins at block 4310 with receiving orientation data from one or more orientation sensors. The orientation sensors may include at least one of a gyroscope, an accelerometer, a magnetometer, a GPS/GNSS receiver, or a camera-based visual-inertial odometry system, or combinations thereof. In some embodiments, the orientation data comprises raw sensor measurements as well as fused sensor outputs generated by a sensor fusion algorithm. The orientation data may represent a current spatial orientation, heading, or movement of a user carrying or wearing a haptic navigation device. The receiving step may be performed continuously or at periodic intervals to enable real-time navigation guidance. In some implementations, the orientation data may be filtered or calibrated prior to further processing to reduce noise and improve accuracy. The use of multiple sensor modalities enables improved robustness in environments where individual sensors may be unreliable.

At block 4320, the method comprises computing an angular deviation between a current heading derived from the orientation data and a target heading derived from a planned navigation route stored in memory. The current heading may be determined based on a forward direction of the user as inferred from the orientation sensors. The target heading may correspond to a direction toward a waypoint or destination defined within the planned navigation route. The angular deviation may be calculated as a difference between the current heading and the target heading and may be expressed in degrees within a defined range. In some embodiments, the angular deviation may be normalized within a range of zero to one hundred eighty degrees to account for directional symmetry. The computation may be performed by a processor executing instructions stored in a non-transitory memory. The angular deviation serves as an input parameter for generating a haptic guidance signal.

At block 4330, the method comprises encoding the angular deviation as a vibrotactile signal. The encoding step maps the angular deviation to one or more parameters of a vibration signal generated by a vibration actuator. In some embodiments, the vibrotactile signal is configured such that a vibration intensity is at a null state when the angular deviation is within a configurable threshold. The configurable threshold may define an acceptable angular range within which the user is considered aligned with the target heading. When the angular deviation exceeds the configurable threshold, the vibration intensity increases proportionally as the angular deviation increases. The proportional relationship may be implemented using a linear scaling function, a nonlinear mapping function, or a lookup table stored in memory. In some implementations, the encoding may further include modulation of additional signal parameters to enhance perceptibility and information content.

In certain embodiments, encoding the angular deviation comprises simultaneously modulating both vibration frequency and vibration amplitude of the vibrotactile signal. Each of the vibration frequency and vibration amplitude may be modulated proportionally to the angular deviation such that increases in angular deviation result in corresponding increases in both frequency and amplitude. This simultaneous modulation provides a multi-dimensional haptic signal that may improve user perception and responsiveness. The modulation parameters may be dynamically adjusted based on user preferences or environmental conditions. In some implementations, the encoding may include temporal patterns or duty cycle variations in addition to frequency and amplitude modulation. The combined modulation of multiple parameters enables more expressive and informative haptic feedback.

At block 4340, the method comprises delivering the vibrotactile signal through a vibration actuator of a haptic output device worn on or carried by a user. The haptic output device may be implemented as a wearable device, a handheld device, or an integrated component of another system. The vibration actuator may include a linear resonant actuator, an eccentric rotating mass motor, a piezoelectric actuator, or other suitable vibration-generating components. The delivery of the vibrotactile signal provides real-time feedback to the user indicating alignment with or deviation from the target heading. The null vibration state indicates proper alignment, while increasing vibration intensity indicates increasing deviation. The user may adjust their heading based on the perceived vibrotactile signal without requiring visual or auditory cues. The method thus enables eyes-free and hands-free navigation guidance through tactile feedback.

In some embodiments, the method 4300 may be performed continuously as the user progresses along a navigation route. The steps of receiving orientation data, computing angular deviation, encoding the vibrotactile signal, and delivering the signal may be repeated iteratively to provide ongoing guidance. The method may further include updating the planned navigation route or recalculating the target heading in response to changes in user position or environmental conditions. In some implementations, the method may be executed entirely on a local device without requiring network connectivity, thereby improving reliability and responsiveness. The described method provides an intuitive and efficient mechanism for conveying directional information through haptic feedback.

### Proximity-Based Vehicle Identification Via BLE and UWB

In some embodiments, the haptic navigation device is further configured to provide proximity-based vehicle identification using short-range wireless communication technologies and alternative sensing modalities. The system operates by detecting proximity to a target vehicle and generating distinct vibrotactile patterns that convey identification status to a user. These embodiments extend the haptic navigation functionality beyond directional guidance to include contextual interaction with nearby physical assets. The processor of the device is configured to interpret proximity signals and identifier data in real time to determine whether a detected vehicle corresponds to a stored target vehicle. The resulting determination is communicated to the user through structured vibrotactile patterns delivered via the vibration actuator. The system may operate independently of visual or audio interfaces, thereby enabling discreet and accessible vehicle identification. These embodiments are particularly suited for rideshare, autonomous vehicle, and fleet management applications.

### Vehicle Identification Heartbeat Pattern

In certain embodiments, the processor is configured to generate a Vehicle

identification heartbeat pattern comprising a rhythmic vibrotactile pulse delivered through the vibration actuator. The Heartbeat pattern is activated when the system is engaged in identifying a target vehicle and proximity measurements fall within a configurable proximity threshold. The repetition rate and vibration intensity of the Heartbeat pattern increase as the measured proximity to the target vehicle decreases below the configurable threshold. In some embodiments, the configurable threshold may be set to approximately thirty meters in outdoor environments, although the threshold may be adjusted based on environmental conditions or application requirements. The Heartbeat pattern is distinct from the heading-deviation vibrotactile encoding used for navigation guidance and serves a separate functional purpose. The rhythmic nature of the pattern provides a continuous indication of closing distance to the target vehicle. The progressive increase in repetition rate and intensity enables the user to intuitively perceive proximity without requiring visual confirmation.

Vehicle proximity may be determined using one or more sensing modalities. In some embodiments, proximity is measured using Bluetooth Low Energy received signal strength indicator values obtained from advertisement packets broadcast by a vehicle-side device. In other embodiments, proximity is measured using Ultra-Wideband two-way ranging between the haptic navigation device and a UWB anchor associated with the vehicle. In further embodiments, proximity may be determined using Near Field Communication field detection during close-range interaction. Additional embodiments may utilize computer vision techniques to recognize a vehicle using camera input or may employ QR code scanning of a code displayed on or associated with the vehicle. These modalities may be used individually or in combination to improve reliability and accuracy of proximity detection. The processor may fuse data from multiple sources to generate a unified proximity estimate.

### Target Vehicle Identifier Matching

In some embodiments, the system utilizes a target vehicle identifier to distinguish a desired vehicle from other nearby vehicles. The target vehicle identifier may comprise a unique device identifier broadcast by a rideshare application, an autonomous vehicle platform, or a fleet management system. The identifier may be transmitted from a driver device, a vehicle-embedded computing system, or a vehicle-mounted beacon. The haptic navigation device receives the target vehicle identifier through an application programming interface associated with a navigation or rideshare application. The identifier is stored in non-transitory memory and used as a reference for comparison with received broadcast identifiers. The processor is configured to monitor incoming wireless signals and extract identifiers from detected transmissions. The comparison between stored and received identifiers is performed in real time to determine whether a detected vehicle corresponds to the target vehicle. This matching process enables precise identification of a specific vehicle in environments with multiple nearby vehicles.

### Wrong-Vehicle Alert and Vehicle-Confirmed Patterns

In certain embodiments, the processor generates distinct vibrotactile patterns to indicate identification outcomes. When proximity to a vehicle is detected and the received broadcast identifier does not match the stored target vehicle identifier, the processor generates a wrong-vehicle alert pattern. The wrong-vehicle alert pattern may comprise a rapid alternating vibrotactile sequence designed to be clearly distinguishable from other patterns used by the system. This pattern alerts the user that the detected vehicle is not the intended target. Conversely, when proximity to a vehicle is detected and the received broadcast identifier matches the stored target vehicle identifier, the processor generates a vehicle-confirmed pattern. The vehicle-confirmed pattern may comprise a distinct confirmation sequence indicating successful identification of the correct vehicle. The confirmation pattern may differ from both the Heartbeat pattern and the heading-deviation encoding in terms of temporal structure, intensity profile, or frequency characteristics. These differentiated patterns enable the user to interpret system feedback without ambiguity. In some implementations, the patterns may be configurable to accommodate user preferences or accessibility needs.

### Operation in GPS-Denied Environments

In some embodiments, the proximity-based vehicle identification system operates in environments where satellite-based positioning signals are unavailable or unreliable. Such environments may include underground parking structures, covered transportation hubs, or dense urban areas with signal obstruction. In these scenarios, the system relies on short-range communication technologies and alternative sensing modalities to determine vehicle proximity. Bluetooth Low Energy received signal strength indicator measurements, Ultra-Wideband ranging, and Near Field Communication detection may be used to estimate distance to nearby vehicles without reliance on GPS or GNSS data. The system may function using a smartphone or driver device operating as a Bluetooth beacon without requiring specialized hardware installed on the vehicle. The positioning-source-agnostic architecture enables seamless operation across a variety of environments. The ability to operate without GPS enhances reliability and expands the applicability of the system to indoor and obstructed settings.

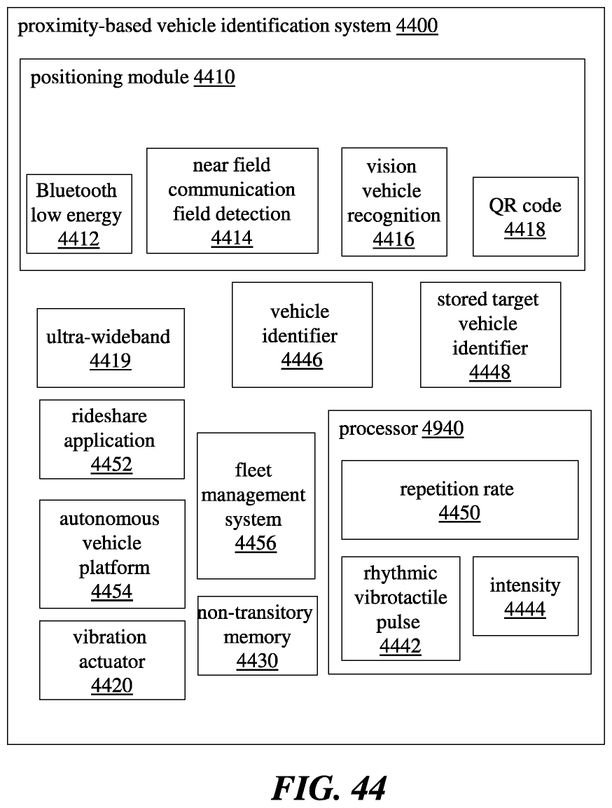

Referring to FIG. 44, a proximity-based vehicle identification system 4400 is illustrated. The system 4400 comprises a positioning module 4410 configured to receive proximity signals associated with a target vehicle using one or more sensing modalities. The positioning module 4410 may include, for example, Bluetooth Low Energy functionality 4412 configured to determine proximity based on received signal strength indicator values, Near Field Communication field detection 4414 configured to detect close-range interactions, computer vision vehicle recognition 4416 configured to identify vehicles using image data, and QR code scanning 4418 configured to decode vehicle-associated identifiers. In some embodiments, the positioning module 4410 further includes Ultra-Wideband ranging functionality 4419 configured to perform two-way ranging measurements to determine distance to the target vehicle. These sensing modalities may operate independently or in combination to generate a proximity estimate. The positioning module 4410 provides input data to a processor 4490 for further analysis and decision making.

The system 4400 further comprises a vibration actuator 4420 configured to generate vibrotactile output and a non-transitory memory 4430 storing a target vehicle identifier 4448. The target vehicle identifier 4448 may correspond to a unique identifier associated with a specific vehicle and may be provided by a rideshare application 4452, an autonomous vehicle platform 4454, or a fleet management system 4456. In some embodiments, the identifier is broadcast by a driver device, a vehicle-embedded computing system, or a vehicle-mounted beacon. The identifier may be received by the positioning module 4410 through wireless communication or other detection mechanisms and stored in memory 4430 for comparison. The system may continuously monitor incoming signals to detect identifiers associated with nearby vehicles.

The processor 4490 is configured to compare a received vehicle identifier 4446 against the stored target vehicle identifier 4448. The comparison may be performed in real time as proximity signals are received and processed. When the received vehicle identifier 4446 matches the stored target vehicle identifier 4448, the processor 4490 determines that the detected vehicle corresponds to the target vehicle. When no match is detected, the processor may continue scanning for additional identifiers or update proximity estimates. The comparison process enables selective identification of a desired vehicle in environments where multiple vehicles may be present. The processor 4490 may execute instructions stored in the non-transitory memory 4430 to perform these operations.

Upon determining proximity to the target vehicle, the processor 4490 is further configured to generate a Vehicle identification heartbeat pattern comprising a rhythmic vibrotactile pulse delivered through the vibration actuator 4420. As illustrated in FIG. 44, the rhythmic vibrotactile pulse 4442 is characterized by a repetition rate 4450 and an intensity 4444 that are each modulated based on measured proximity to the target vehicle. In particular, the repetition rate 4450 and the intensity 4444 increase as the measured proximity decreases below a configurable proximity threshold. The configurable proximity threshold may be defined based on application requirements and may correspond to a distance at which haptic feedback becomes meaningful to the user. The progressive increase in repetition rate and intensity provides an intuitive indication that the user is approaching the target vehicle. The rhythmic nature of the Heartbeat pattern allows the user to perceive changes in proximity without requiring visual confirmation.

In some embodiments, the processor 4490 may continuously update the vibrotactile output as new proximity measurements are obtained. The mapping between proximity and vibrotactile parameters may be implemented using linear scaling, nonlinear functions, or lookup tables stored in memory. The system may further adjust the proximity threshold or modulation parameters based on environmental conditions or user preferences. The vibration actuator 4420 may comprise a linear resonant actuator, an eccentric rotating mass motor, or other suitable vibration-generating component capable of producing the required rhythmic output. The vibrotactile output is delivered to a user through a wearable or handheld device, enabling hands-free and eyes-free interaction.

In further embodiments, the system 4400 operates across multiple platforms and environments, including rideshare applications, autonomous vehicle systems, and fleet management infrastructures. The use of multiple sensing modalities enables operation in both outdoor and indoor environments, including GPS-denied locations. The reliance on broadcast identifiers allows the system to function without requiring direct line-of-sight or manual input from the user. The integration of proximity sensing, identifier matching, and vibrotactile feedback provides a cohesive mechanism for vehicle identification. The system enhances user experience by reducing ambiguity in locating a target vehicle and by providing clear, real-time feedback through haptic signals.

### Robotic Platform Haptic Guidance

In some embodiments, the haptic navigation system is configured to support human-robot interaction by enabling a human operator to receive directional guidance toward one or more robotic platforms using vibrotactile feedback. These embodiments facilitate coordination between humans and robotic systems in environments where visual or audio communication may be limited, obstructed, or undesirable. The system leverages wireless communication between robotic platforms and a human-worn haptic output device to determine relative positioning and provide intuitive directional cues. The haptic guidance mechanism encodes directional information as vibrotactile signals that can be perceived without requiring the user to divert visual attention. This configuration is particularly beneficial in dynamic or hazardous environments such as warehouses, construction sites, or search-and-rescue operations. The system may operate in real time to continuously update guidance signals as the relative positions of the human operator and robotic platforms change. The integration of proximity sensing and orientation detection enables accurate and responsive navigation assistance.

### Robot-to-Human Haptic Direction Encoding

In certain embodiments, a robotic platform is equipped with a proximity radio module configured to broadcast a unique robot identifier using at least one wireless communication protocol. The robotic platform may comprise an autonomous mobile robot, a delivery robot, an unmanned ground vehicle, a warehouse robot, a search-and-rescue robot, or a construction inspection robot. The proximity radio module may transmit signals using Bluetooth Low Energy, Ultra-Wideband, Wi-Fi, or other suitable wireless technologies. A human-worn haptic output device comprising a vibration actuator and one or more orientation sensors is configured to receive the broadcast identifier. The orientation sensors may include inertial measurement components that determine a current heading of the user. The processor of the human-worn device processes the received signal and sensor data to determine a heading toward the robotic platform.

The processor computes an angular deviation between the user's current heading and the heading toward the robotic platform. This angular deviation is encoded using a null vibration state when the deviation is within a configurable threshold and a gradient-intensity vibrotactile output when the deviation exceeds the threshold. The vibration intensity increases proportionally as the angular deviation increases, thereby guiding the user toward alignment with the robotic platform. The vibrotactile output is delivered through the vibration actuator of the human-worn device, enabling the user to adjust direction based on tactile feedback. This encoding allows the user to locate and approach the robotic platform without requiring visual display or audio output. The system may continuously update the angular deviation and corresponding vibrotactile signal as the user or robotic platform moves. The resulting interaction provides an intuitive and low-latency mechanism for robot-to-human guidance.

### Multi-Robot and Human-Robot Teaming

In further embodiments, the system supports interaction with multiple robotic platforms simultaneously. Each robotic platform broadcasts a distinct identifier, allowing the human-worn device to differentiate between multiple robots within range. The processor of the human-worn device is configured to receive multiple identifiers and determine relative headings and distances to each corresponding robotic platform. The processor may establish a priority ordering of guidance signals based on proximity, mission objectives, or user-defined parameters. For example, a robotic platform that is closest to the user or designated as a primary target may be assigned higher priority. The system may generate sequential or simultaneous vibrotactile signals corresponding to different robotic platforms.

In some implementations, distinct vibrotactile patterns or modulation schemes may be assigned to different robotic platforms to enable differentiation by the user. The processor may alternate between guidance signals for multiple robots or combine signals using multiplexing techniques. The prioritization logic may dynamically adjust based on changes in proximity or task requirements. The system may also allow the user to select or switch between target robotic platforms through input controls or predefined rules. This multi-robot capability enables coordinated human-robot teaming in complex environments. The use of vibrotactile guidance allows the human operator to maintain situational awareness while receiving directional cues from multiple robotic systems.

In some embodiments, the proximity-based vehicle identification system 4400 implements a multi-phase proximity model in which the Vehicle identification heartbeat pattern transitions through distinct operational phases as the measured proximity to the target vehicle changes. The multi-phase proximity model may comprise at least three phases: a detection phase, a guidance phase, and an arrival phase. In the detection phase, the positioning module 4410 detects the target vehicle at a first proximity range using Bluetooth Low Energy (BLE) received signal strength indicator (RSSI) at a range of approximately 50 meters to approximately 100 meters with an accuracy of approximately 1 meter to approximately 3 meters. Upon detection, the processor 4940 initiates the Vehicle identification heartbeat pattern at a baseline repetition rate. In the guidance phase, the measured proximity to the target vehicle decreases below a first configurable proximity threshold, such as approximately 50 meters, and the positioning module 4410 may transition to Ultra-Wideband (UWB) two-way ranging, which provides distance measurements with an accuracy of approximately 10 centimeters to approximately 30 centimeters at ranges up to approximately 50 meters in line-of-sight conditions. In the arrival phase, the measured proximity decreases below a second configurable proximity threshold, such as approximately 3 meters, and the positioning module 4410 may further incorporate Near Field Communication (NFC) field detection at an effective range of less than approximately 10 centimeters, or Bluetooth 6.0 Channel Sounding at an accuracy of approximately 10 centimeters to approximately 50 centimeters, to confirm final approach to the target vehicle.

In some embodiments, the rhythmic vibrotactile pulse of the Vehicle identification heartbeat pattern has a repetition rate that increases from approximately 0.5 Hz at a measured proximity of approximately 100 meters to approximately 1.0 Hz at approximately 50 meters, approximately 2.0 Hz at approximately 10 meters, and approximately 5.0 Hz at approximately 1 meter. The vibration intensity of each pulse may increase from approximately 10 percent of maximum actuator output at approximately 100 meters to approximately 50 percent at approximately 10 meters and approximately 100 percent at approximately 1 meter. In some embodiments, the relationship between proximity and repetition rate may follow a logarithmic mapping function such that the perceived rate of change is approximately uniform across the proximity range. In other embodiments, the relationship may follow a piecewise linear function with breakpoints at the configurable proximity thresholds corresponding to the detection, guidance, and arrival phases.

In some embodiments, the processor 4940 is further configured to generate a wrong-vehicle alert pattern when the positioning module 4410 detects proximity to a vehicle and the received vehicle identifier does not match the stored target vehicle identifier 4448. The wrong-vehicle alert pattern may comprise a rapid alternating vibrotactile pattern at a frequency of approximately 8 Hz to approximately 15 Hz with a duty cycle of approximately 50 percent, producing a perceptually distinct “buzzing” sensation that is distinguishable from the rhythmic heartbeat pattern of the Vehicle identification heartbeat. The wrong-vehicle alert pattern may be generated for a duration of approximately 2 seconds to approximately 5 seconds and may repeat at intervals of approximately 10 seconds while the non-matching vehicle remains within the detection range.

In some embodiments, the processor 4940 is further configured to generate a vehicle-confirmed pattern when the received vehicle identifier matches the stored target vehicle identifier 4448 and the measured proximity is below a confirmation threshold, such as approximately 3 meters. The vehicle-confirmed pattern may comprise a sustained vibrotactile pulse at approximately 70 percent to approximately 100 percent of maximum actuator output for a duration of approximately 500 milliseconds to approximately 1500 milliseconds, followed by a gradual intensity decay over approximately 500 milliseconds. The vehicle-confirmed pattern is perceptually distinguishable from both the Vehicle identification heartbeat pattern and the wrong-vehicle alert pattern by its sustained duration and absence of rhythmic repetition. In some implementations, the vehicle-confirmed pattern may be preceded by a confirmation handshake in which the positioning module 4410 transmits an acknowledgment signal to the target vehicle via the same short-range wireless protocol used for identifier detection.

In some embodiments, the target vehicle identifier is received from a rideshare application executing on a driver device, the rideshare application transmitting the identifier via a BLE advertising packet, a UWB ranging initiation frame, or an NFC Data Exchange Format (NDEF) record. In other embodiments, the target vehicle identifier is broadcast by a vehicle-mounted beacon affixed to or integrated within the target vehicle, the beacon broadcasting a unique identifier at a configurable transmission power level and advertising interval. In further embodiments, the target vehicle identifier is transmitted by a vehicle-embedded computer of an autonomous vehicle platform, the vehicle-embedded computer broadcasting the identifier as part of a standardized vehicle-to-everything (V2X) communication protocol or a proprietary fleet management identifier scheme.

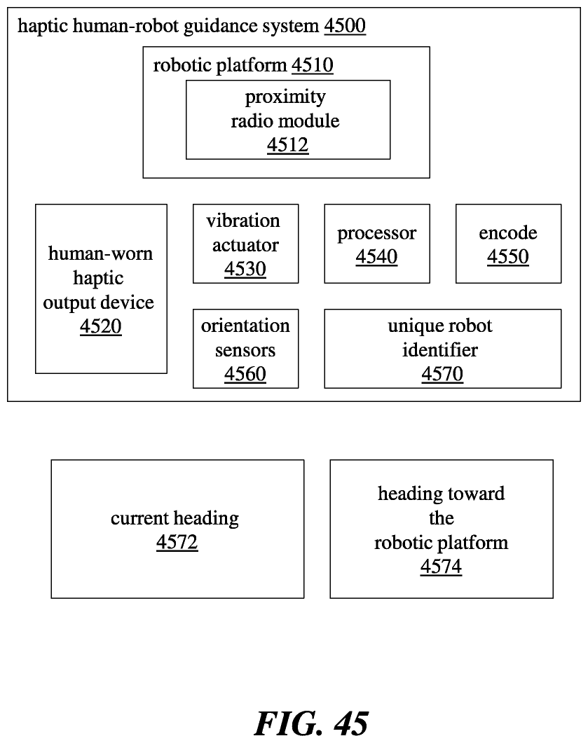

Referring to FIG. 45, a haptic human-robot guidance system 4500 is illustrated. The system 4500 comprises a robotic platform 4510 and a human-worn haptic output device 4520 configured to cooperatively provide directional guidance to a user. The robotic platform 4510 includes a proximity radio module 4512 configured to broadcast a unique robot identifier 4570 using at least one wireless communication protocol. The wireless communication protocol may include Bluetooth Low Energy, Ultra-Wideband, Wi-Fi, or other suitable short-range or medium-range communication technologies. The robotic platform 4510 may comprise an autonomous mobile robot, a delivery robot, an unmanned ground vehicle, a warehouse robot, or other robotic system configured to operate within an environment. The proximity radio module 4512 continuously or periodically transmits the unique robot identifier 4570 to enable detection by nearby devices. The broadcast identifier allows the robotic platform 4510 to be uniquely distinguished from other robotic platforms or wireless devices operating in the same environment.

The human-worn haptic output device 4520 comprises a vibration actuator 4530, one or more orientation sensors 4560, and a processor 4540. The vibration actuator 4530 is configured to generate vibrotactile output perceivable by a user wearing or carrying the device. The orientation sensors 4560 may include one or more of a gyroscope, an accelerometer, a magnetometer, or other inertial measurement components configured to determine a current heading 4572 of the user. The processor 4540 is communicatively coupled to the vibration actuator 4530 and the orientation sensors 4560 and is configured to execute instructions for determining directional guidance. The human-worn haptic output device 4520 may be implemented as a wearable device such as a wristband, smartwatch, belt-mounted device, or other body-worn form factor. The device may operate independently or in conjunction with additional computing systems.

In operation, the processor 4540 of the human-worn haptic output device 4520 is configured to receive the unique robot identifier 4570 broadcast by the robotic platform 4510. Based on the received signal, the processor 4540 determines a heading toward the robotic platform 4574. The determination of the heading toward the robotic platform may be based on signal strength measurements, time-of-flight measurements, directional antenna information, or other proximity-based localization techniques. The processor 4540 further determines the current heading 4572 of the user using data from the orientation sensors 4560. The processor 4540 computes an angular deviation between the current heading 4572 and the heading toward the robotic platform 4574. The angular deviation represents the difference between the direction the user is currently facing and the direction toward the robotic platform.

The processor 4540 encodes the computed angular deviation using a vibrotactile output scheme. Specifically, the processor 4540 causes the vibration actuator 4530 to produce a null vibration state when the angular deviation is within a configurable threshold. The configurable threshold defines an angular range within which the user is considered aligned with the robotic platform. When the angular deviation exceeds the configurable threshold, the processor 4540 causes the vibration actuator 4530 to generate vibrotactile output having an intensity that increases proportionally with the magnitude of the angular deviation. This increasing vibration intensity provides a continuous and intuitive indication of misalignment, guiding the user to adjust orientation until the null vibration state is achieved. The encoding of angular deviation may be implemented using linear scaling, nonlinear mapping, or other functions stored in memory.

In some embodiments, the processor 4540 may include an encoding module 4550 configured to map angular deviation values to vibrotactile output parameters. The encoding module 4550 may generate control signals that specify vibration intensity, frequency, or duty cycle characteristics. The vibration actuator 4530 then produces vibrotactile output corresponding to the control signals. The system may continuously update the vibrotactile output as the user or robotic platform moves, thereby providing real-time guidance. The use of vibrotactile encoding enables the user to locate and approach the robotic platform without reliance on visual displays or audio cues. This facilitates operation in environments where visual attention must be maintained on other tasks or where audio communication is impractical.

In further embodiments, the system 4500 operates without requiring any graphical display output or audio output from either the robotic platform 4510 or the human-worn haptic output device 4520. The exclusive use of haptic feedback provides a discreet and low-cognitive-load mechanism for conveying directional information. The system may be used in industrial, commercial, or emergency response environments where efficient human-robot coordination is required. The integration of proximity-based identifier detection, orientation sensing, and vibrotactile feedback enables accurate and responsive guidance. The system may also support multiple robotic platforms, each broadcasting a unique identifier, with the processor 4540 configured to select or prioritize a target robotic platform based on proximity or predefined criteria. The described haptic human-robot guidance system 4500 thus provides an effective interface for intuitive and non-visual interaction between humans and robotic systems.

In some embodiments, the haptic human-robot guidance system 4500 is configured to provide real-time vibrotactile guidance toward a robotic platform 4510 that may be stationary or mobile. When the robotic platform 4510 is mobile, the heading toward the robotic platform from the perspective of the human-worn haptic output device 4520 changes as a function of the relative positions and velocities of both the user and the robotic platform. The processor 4540 of the human-worn haptic output device 4520 is configured to update the computed heading toward the robotic platform 4510 at an update rate of at least 10 Hz and up to approximately 50 Hz, thereby enabling responsive tracking of a mobile target.

In some embodiments, the processor 4540 determines the heading toward the robotic platform 4510 by computing a direction vector from the current position of the user to the estimated current position of the robotic platform 4510. The current position of the user may be determined using one or more orientation sensors 4560 of the human-worn haptic output device 4520, including inertial measurement unit (IMU) data, GPS/GNSS signals, or visual-inertial odometry. The estimated current position of the robotic platform 4510 may be determined using at least one of: angle-of-arrival (AoA) estimation from BLE or UWB radio signals received from the proximity radio module 4512; time-difference-of-arrival (TDoA) from UWB signals received at multiple antenna elements of the human-worn haptic output device 4520; or range-and-bearing estimation from UWB two-way ranging combined with IMU-derived heading data. In some embodiments, the processor 4540 applies a Kalman filter or an extended Kalman filter to fuse range measurements, angle-of-arrival estimates, and IMU data to produce a smoothed estimate of the heading toward the robotic platform 4510. The Kalman filter state vector may include at least the estimated relative position, relative velocity, and heading of the robotic platform 4510 with respect to the user.

In some embodiments, the end-to-end latency from detection of a change in heading toward the robotic platform 4510 to generation of updated vibrotactile output by the vibration actuator 4530 is less than approximately 100 milliseconds. This latency budget may be allocated as follows: approximately 10 milliseconds to approximately 30 milliseconds for radio signal reception and processing; approximately 5 milliseconds to approximately 20 milliseconds for heading computation and Kalman filter update; and approximately 5 milliseconds to approximately 20 milliseconds for vibration actuator command generation and mechanical response. The total latency of less than approximately 100 milliseconds enables the user to perceive the vibrotactile guidance as temporally coincident with changes in the spatial relationship between the user and the robotic platform 4510, thereby supporting intuitive navigation toward a moving target.

In some embodiments, the haptic human-robot guidance system 4500 operates in environments where GPS/GNSS signals are unavailable or unreliable, including indoor environments, subterranean environments, and urban environments with significant multipath interference. In such environments, the processor 4540 may rely exclusively on proximity radio signals from the proximity radio module 4512 of the robotic platform 4510, combined with IMU-derived dead reckoning, to determine the heading toward the robotic platform. The proximity radio module 4512 may broadcast the unique robot identifier 4570 via BLE advertising packets at a configurable advertising interval of approximately 20 milliseconds to approximately 100 milliseconds, or via UWB ranging initiation frames at a configurable ranging interval of approximately 10 milliseconds to approximately 50 milliseconds. The advertising or ranging interval may be dynamically adjusted based on the measured proximity between the user and the robotic platform 4510, with shorter intervals at closer proximity to improve tracking accuracy during final approach.

In some embodiments, the robotic platform 4510 may comprise an autonomous mobile robot, an unmanned ground vehicle, an unmanned aerial vehicle, a warehouse logistics robot, a surgical assist robot, or a service robot operating in a shared human-robot workspace. The haptic human-robot guidance system 4500 enables non-visual, non-auditory guidance of a human operator toward the robotic platform without requiring the operator to visually locate the robot or to receive auditory instructions, thereby supporting operation in low-visibility conditions, high-noise environments, or scenarios in which the operator's visual and auditory attention is directed toward other tasks.

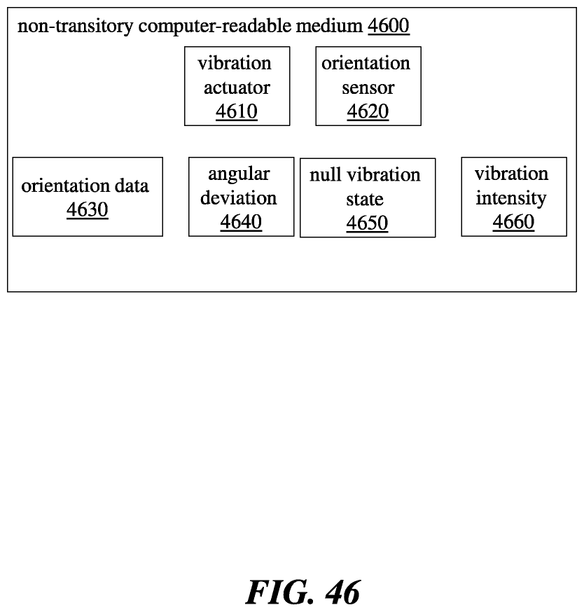

Referring to FIG. 46, a non-transitory computer-readable medium 4600 is illustrated, the medium storing instructions that, when executed by a processor of a haptic output device, cause the processor to perform operations for providing haptic navigation guidance. The haptic output device may comprise a vibration actuator 4610 and one or more orientation sensors 4620 configured to generate orientation data 4630 representative of a spatial orientation of the device. The non-transitory computer-readable medium 4600 may comprise any suitable storage medium, including flash memory, embedded multi-media card storage, solid-state drives, read-only memory, or other persistent storage capable of retaining executable instructions. In some embodiments, the haptic output device may be implemented as a wristband, smartwatch, augmented reality glasses device, belt-mounted module, or handheld navigation unit. The instructions stored on the medium are configured to be executed locally by the processor without requiring continuous network connectivity, thereby enabling operation in remote or connectivity-limited environments. In some implementations, the medium may also store configuration parameters, calibration data, and user preference profiles. The integration of storage, sensing, and actuation components enables a compact and self-contained navigation system.

In operation, the processor is configured to receive orientation data 4630 from the one or more orientation sensors 4620. The orientation sensors may include a gyroscope configured to detect rotational motion, an accelerometer configured to detect linear acceleration and tilt, and a magnetometer configured to determine heading relative to a magnetic reference. In further embodiments, the orientation sensors may include a GPS or GNSS receiver configured to provide course-over-ground information, or a camera-based orientation system camera-based orientation system configured to track movement relative to environmental features. The received orientation data may be processed using sensor fusion algorithms to produce a stable and accurate estimate of the current heading of the device. For example, gyroscope drift may be corrected using magnetometer data, while accelerometer data may be used to stabilize orientation estimates during motion. The processor may also apply filtering techniques such as Kalman filtering or complementary filtering to improve signal quality. The orientation data may be updated at a rate ranging from approximately ten updates per second to several hundred updates per second depending on hardware capabilities. This continuous acquisition enables real-time responsiveness to user movement.

### Camera-Based Orientation System

In some embodiments, the haptic navigation device includes a camera-based orientation sensing system configured to determine a current heading and spatial orientation of the device using image data captured by one or more cameras. The camera-based system may operate alone or together with one or more inertial sensors, such as a gyroscope and an accelerometer, to estimate motion and orientation. In certain implementations, the processor processes image frames captured by the camera and extracts visual features from the surrounding environment. These features may include edges, corners, textures, or other identifiable landmarks that can be tracked across multiple frames. By analyzing movement of these features between frames, the processor estimates motion of the device relative to the environment. The estimated motion is then used to determine orientation and heading for use in the haptic navigation system.

In some embodiments, the camera-based orientation sensing system may be implemented as a visual-inertial odometry system in which camera data is combined with inertial sensor data. The processor may perform sensor fusion by combining image-based motion estimation with inertial measurements to produce a more accurate and stable estimate of orientation. For example, gyroscope data may provide short-term rotational motion, while camera-based tracking may correct drift over time. This combination improves performance in conditions where one sensing method alone is insufficient. The fusion process may be performed using filtering techniques such as Kalman filtering or similar estimation methods.

In certain embodiments, the camera-based system is useful in environments where GPS or GNSS signals are weak or unavailable, such as indoor spaces, underground locations, or dense urban areas. In these situations, the processor may rely on camera data and inertial sensor data to determine orientation and heading. The system may continuously update orientation based on incoming sensor data, allowing the navigation system to remain functional without satellite signals. The processor may also switch between sensing modes depending on signal availability and environmental conditions.

In some embodiments, the camera-based system may include additional components such as depth sensors, stereo cameras, or simultaneous localization and mapping systems. These components may improve accuracy by building a map of the surrounding environment and tracking movement within that environment. In wearable implementations, such as augmented reality glasses or head-mounted displays, the camera may be aligned with the user's field of view, allowing the system to track head orientation directly. The heading of the device may therefore correspond to the direction the user is facing.

In some embodiments, even if the term visual-inertial odometry is not explicitly used, the system may still be described as performing the same function by combining camera data with inertial sensor data to determine orientation. In other implementations, the system may be described more generally as a camera-based orientation system. The processor may select or combine different sensing methods depending on accuracy, availability, or power requirements. In operation, the processor receives image data from the camera and motion data from the inertial sensors, processes the data to determine orientation, and uses the resulting heading to compute angular deviation relative to a target heading. This angular deviation is then used to generate vibrotactile output for navigation. The use of both camera and inertial data provides a flexible and reliable way to determine orientation across different environments.

The processor is further configured to compute an angular deviation 4640 between the current heading derived from the orientation data and a target heading derived from a planned navigation route stored in memory. The planned navigation route may comprise a sequence of waypoints, turn-by-turn directions, or a vector path generated by a mapping application. In some embodiments, the target heading may correspond to a direction toward a next waypoint located within a distance range such as approximately one meter to several hundred meters from the user. The angular deviation 4640 may be calculated using vector subtraction or trigonometric functions and may be normalized within a range of zero degrees to one hundred eighty degrees. In some implementations, wraparound conditions may be handled such that the shortest angular path to the target heading is always selected. For example, a deviation of negative one hundred seventy degrees may be treated as a positive ten-degree deviation in the opposite direction. The computation may be updated continuously as the user moves or as the navigation route is recalculated. The angular deviation serves as a control input for generating vibrotactile feedback.

Based on the computed angular deviation 4640, the processor is configured to control the vibration actuator 4610 to produce a null vibration state 4650 when the angular deviation is within a configurable threshold angular range of the target heading. The configurable threshold angular range may be defined within a range such as approximately two degrees to approximately fifteen degrees, depending on the desired sensitivity. For example, a pedestrian navigation application may use a threshold of approximately five degrees to allow slight natural head or body movement without triggering feedback, while a precision industrial application may use a narrower threshold of approximately two degrees. When the angular deviation falls within this threshold, the absence of vibration provides a clear indication that the user is properly aligned with the intended direction. This null-state feedback reduces unnecessary stimulation and allows the user to conserve attention for other tasks. The threshold may be dynamically adjusted based on user behavior, environmental conditions, or application context.

### Null Vibration State

In some embodiments, the haptic navigation device is configured to provide a null vibration state corresponding to a condition in which no vibrotactile output is generated by the vibration actuator. The null vibration state occurs when the device is aligned with a target heading such that an angular deviation between a current heading and the target heading is within a defined angular range. In this condition, the processor causes the vibration actuator to remain inactive, thereby producing no perceptible vibration. The absence of vibration serves as an intentional and meaningful output signal indicating correct alignment. This approach allows the user to interpret alignment without requiring continuous stimulation or additional sensory input. The null vibration state reduces cognitive load by providing a clear binary indication of proper orientation. The system thereby communicates alignment through the absence of a signal rather than the presence of one.

In certain embodiments, the processor determines the null vibration state by comparing the computed angular deviation to a threshold angular range stored in memory. When the angular deviation is less than or equal to the threshold angular range, the processor maintains the vibration actuator in an inactive state. For example, when the user is facing the correct direction toward a destination, no vibration is generated. When the angular deviation exceeds the threshold angular range, the processor transitions from the null vibration state to an active vibration state in which vibrotactile output is generated. The transition between the null vibration state and the active vibration state may occur immediately or may be smoothed using transition logic to avoid abrupt changes. The null vibration state thus functions as a baseline reference condition within the haptic encoding scheme.

In some embodiments, the null vibration state may be implemented across different actuator types, including vibration motors, linear resonant actuators, or other vibration actuators. Regardless of the specific actuator type, the null vibration state corresponds to a condition in which no actuation signal is applied, or the applied signal is below a perceptibility threshold for the user. In certain implementations, the system may maintain a minimal idle signal to preserve actuator readiness while remaining imperceptible to the user. The processor may also ensure that the transition into the null vibration state occurs in a manner that avoids residual vibration or unintended tactile artifacts. The null vibration state may be maintained continuously as long as the alignment condition is satisfied.

In certain embodiments, the null vibration state is part of a broader haptic encoding scheme in which angular deviation is mapped to vibrotactile output. The null vibration state corresponds to a zero-output condition at or near zero angular deviation. As the angular deviation increases beyond the threshold angular range, the system generates increasing levels of vibrotactile output. The null vibration state therefore represents one endpoint of a gradient-based mapping function. In some implementations, the mapping function may be continuous, while in others it may include discrete transitions between states. The null vibration state provides a stable reference point that enhances the interpretability of the haptic feedback.

In some embodiments, the use of a null vibration state aligns with descriptions in the parent specification indicating that no vibration occurs when the device is facing the correct direction. The described embodiments extend this concept by formalizing the condition as a defined state within the system operation. The null vibration state may be explicitly implemented in software instructions executed by the processor. These instructions may include logic for detecting alignment, suppressing actuator output, and transitioning to active vibration states when misalignment is detected. The explicit definition of the null vibration state ensures consistent behavior across different implementations and hardware configurations.

In operation, the processor continuously evaluates the current heading relative to the target heading and determines whether the conditions for the null vibration state are satisfied. When satisfied, the processor maintains the vibration actuator in a non-operational state. When the conditions are no longer satisfied, the processor activates the vibration actuator to provide directional feedback. This mechanism allows the user to navigate by minimizing vibration rather than responding to constant stimuli. The null vibration state thus serves as a key element of the haptic navigation system, enabling intuitive and efficient user interaction through the sense of touch.

When the angular deviation exceeds the configurable threshold angular range, the processor causes the vibration actuator 4610 to generate vibrotactile output having a vibration intensity 4660 that increases proportionally with the magnitude of the angular deviation. The proportional relationship may be implemented using a linear scaling function in which intensity increases steadily from a minimum value at the threshold to a maximum value at approximately one hundred eighty degrees of deviation. In other embodiments, a nonlinear mapping function may be used, such as an exponential or logarithmic curve, to provide greater sensitivity at smaller deviations and stronger feedback at larger deviations. For example, vibration intensity may increase slowly for deviations between approximately five degrees and thirty degrees, and more rapidly for deviations exceeding thirty degrees. In some implementations, the vibration intensity 4660 may range from approximately ten percent to one hundred percent of the actuator's maximum output capability. The processor may update the intensity in real time as the user adjusts direction.

In further embodiments, additional vibrotactile parameters may be modulated to enhance the richness of the feedback signal. For example, vibration frequency may be increased from approximately one hundred hertz to approximately two hundred fifty hertz as angular deviation increases, while duty cycle may be adjusted to create pulsed or continuous vibration patterns. In some implementations, different vibration profiles may be used for different navigation modes, such as walking, cycling, or driving. For instance, a walking mode may use lower intensity and smoother gradients, while a cycling mode may use stronger and more rapid feedback to account for higher speeds. The processor may select or adjust these parameters based on contextual data or user preferences stored in memory.

### Vibration Actuator and Vibration Motor Terminology

In some embodiments, the haptic navigation device includes a component configured to generate vibrotactile output, referred to herein as a vibration actuator. The vibration actuator is configured to produce mechanical vibrations that are perceivable by a user as tactile feedback. In certain implementations, the vibration actuator may be embodied as a vibration motor, such as those described in the parent specification. For example, the parent disclosure references vibrating motors configured to generate haptic feedback, which are a specific type of vibration actuator. Accordingly, a vibration motor may be considered a species within the broader class of vibration actuators.

As used herein, the term vibration actuator is intended to encompass any device or component capable of generating controlled mechanical vibrations for delivery to a user. In addition to vibration motors, suitable vibration actuators may include linear resonant actuators, eccentric rotating mass motors, piezoelectric actuators, electroactive polymer actuators, or other devices configured to generate vibrotactile output. These various actuator types may differ in operating principles, frequency response, power consumption, and form factor, but all are capable of producing vibrations perceivable by the human somatosensory system. The use of the broader term vibration actuator allows the haptic navigation system to be implemented using a wide range of hardware technologies without limitation to a specific actuator type.

In some embodiments, a linear resonant actuator may be used to provide precise and efficient vibration output within a defined frequency range, such as approximately 100 Hz to approximately 250 Hz. In other embodiments, an eccentric rotating mass motor may be used to generate vibration through rotational imbalance, typically operating within a lower frequency range, such as approximately 50 Hz to approximately 150 Hz. In further embodiments, piezoelectric actuators may be employed to produce high-frequency or localized vibrations with rapid response characteristics. The selection of actuator type may depend on the intended application, device form factor, and desired haptic performance characteristics.

In certain embodiments, the processor of the haptic navigation device is configured to control the vibration actuator by generating control signals that define parameters such as vibration intensity, frequency, duty cycle, and duration. The vibration actuator responds to these control signals by producing vibrotactile output corresponding to the encoded navigation information. For example, the processor may increase vibration intensity as angular deviation from a target heading increases, or may generate distinct vibration patterns to convey different navigation cues. The vibration actuator may be integrated into a wearable device, a handheld device, or an embedded system, and may be positioned to maximize tactile perception by the user.

In some embodiments, where the parent specification explicitly describes a vibration motor, the vibration actuator described herein may be understood to include such vibration motors as an implementation example. The use of the broader term vibration actuator does not introduce new functionality but rather generalizes the disclosed component to include equivalent structures known in the art. This terminology allows for flexibility in implementation while maintaining consistency with the underlying haptic feedback principles described in the parent specification.

In operation, the vibration actuator receives control signals from the processor and generates vibrotactile output that is delivered to the user. The vibrotactile output may be continuous or intermittent and may vary in intensity or frequency based on navigation conditions. The use of a vibration actuator enables the haptic navigation system to provide intuitive, non-visual guidance through tactile sensations. The described embodiments support a wide range of actuator technologies while preserving compatibility with the vibration motor implementations disclosed in the parent application.

The instructions stored on the non-transitory computer-readable medium 4600 may further enable continuous execution of the navigation method during movement. The processor may repeatedly perform the steps of receiving orientation data, computing angular deviation, and updating vibrotactile output at a refresh rate sufficient to provide seamless guidance. In some embodiments, the system may operate entirely offline using locally stored route data, making it suitable for use in remote areas such as hiking trails, warehouses, or underground facilities. In other embodiments, the system may receive periodic route updates from an external device while maintaining local control of haptic feedback. The haptic output device may be worn on or carried by the user, enabling hands-free and eyes-free navigation across a wide range of use cases. The described non-transitory computer-readable medium 4600 thus supports a flexible and highly responsive implementation of haptic navigation with configurable performance characteristics.

In some embodiments, the non-transitory computer-readable medium described in claim 14 further stores instructions that, when executed by the processor, cause simultaneous modulation of multiple vibrotactile signal parameters to encode angular deviation with increased perceptual resolution. In particular, the processor may simultaneously modulate both vibration frequency and vibration amplitude of the vibration actuator proportionally to the angular deviation. For example, vibration amplitude may be scaled within a range of approximately ten percent to one hundred percent of a maximum actuator output, while vibration frequency may be varied within a range of approximately eighty hertz to approximately three hundred hertz, depending on actuator capabilities and perceptual characteristics. In some implementations, both parameters increase monotonically as angular deviation increases from the configurable threshold to approximately one hundred eighty degrees. In other implementations, amplitude may follow a linear scaling while frequency follows a nonlinear scaling to enhance sensitivity at lower deviations. This simultaneous modulation provides a multi-dimensional haptic signal that improves user perception of directional error. The coordinated control of amplitude and frequency enables more intuitive and distinguishable feedback compared to single-parameter modulation.

In further embodiments, the instructions cause the processor to dynamically adjust one or more vibrotactile parameters in real time based on changes in angular deviation. The parameters may include vibration intensity, vibration frequency, and vibration duty cycle, each of which may be updated at a refresh rate ranging from approximately ten updates per second to approximately two hundred updates per second. For example, duty cycle may be adjusted within a range of approximately ten percent to ninety percent to create pulsed or continuous vibration patterns corresponding to different levels of deviation. As the angular deviation changes due to user movement, the processor continuously recalculates control signals and updates the vibration actuator accordingly. This real-time adjustment enables smooth and continuous feedback without abrupt transitions. In some implementations, the rate-of-change of angular deviation may also be considered to adjust responsiveness or damping of the output signal. The dynamic adaptation ensures that the haptic feedback remains synchronized with user motion.

In certain embodiments, the instructions cause the processor to apply a configurable threshold angular range stored in memory to define the null vibration state. The threshold angular range may be selected within a range of approximately two degrees to approximately twenty degrees, depending on application requirements. For example, a threshold of approximately three to five degrees may be used for precision navigation tasks, while a threshold of approximately ten to fifteen degrees may be used for casual pedestrian navigation. When the angular deviation falls within this threshold range, the processor causes the vibration actuator to produce no vibration, thereby establishing a null vibration state. The threshold value may be user-configurable or dynamically adjusted based on environmental conditions such as movement speed or sensor noise. In some embodiments, multiple threshold profiles may be stored in memory and selected based on operational mode. The use of a configurable threshold reduces unnecessary feedback and improves usability.

In additional embodiments, the instructions cause the processor to generate a gradient transition of vibration intensity from the null vibration state to a maximum intensity using a continuous mapping function of the angular deviation. The mapping function may be linear, piecewise linear, exponential, logarithmic, or polynomial, depending on desired responsiveness characteristics. For example, a linear mapping may increase intensity proportionally from zero at the threshold to one hundred percent at approximately one hundred eighty degrees, while an exponential mapping may provide finer resolution at lower deviations and stronger feedback at higher deviations. In some implementations, the gradient transition may be defined using a lookup table stored in memory with discrete intensity values corresponding to angular deviation intervals of approximately one degree to ten degrees. The continuous nature of the mapping function ensures smooth transitions in vibration output as the user adjusts heading. The gradient transition enhances the user's ability to interpret directional cues accurately. The processor may update the mapping function parameters dynamically based on user preferences or contextual factors.

In some embodiments, the instructions cause the processor to output the vibration intensity through one or more types of vibration actuators. The actuator may comprise a linear resonant actuator configured to operate within a frequency range of approximately one hundred hertz to approximately two hundred fifty hertz, providing efficient and precise vibration output. In other embodiments, the actuator may comprise an eccentric rotating mass motor configured to generate vibration through rotational imbalance, typically operating within a frequency range of approximately fifty hertz to approximately one hundred fifty hertz. In further embodiments, the actuator may comprise a vibrotactile array including multiple actuator elements distributed across a wearable device to provide spatially distributed feedback. The processor may control individual actuators within the array to generate composite vibration patterns. The selection of actuator type may depend on device form factor, power constraints, and desired haptic characteristics. The instructions may include actuator-specific control parameters to optimize performance.

In further embodiments, the instructions cause the processor to perform the computation of angular deviation and control of the vibration actuator without requiring a graphical display or audio output. The system is configured to operate as a purely haptic interface, enabling eyes-free and hands-free navigation. This mode of operation reduces cognitive load and allows the user to maintain visual attention on the surrounding environment. The processor may execute all computations locally on the haptic output device or in conjunction with a paired computing device while maintaining haptic-only output. In some implementations, the absence of visual or audio output may be particularly advantageous in environments with high noise levels or limited visibility. The reliance on vibrotactile feedback alone ensures accessibility for users with visual or auditory impairments. The described embodiments thus provide a self-contained and adaptable haptic navigation system with configurable performance characteristics and enhanced perceptual encoding.

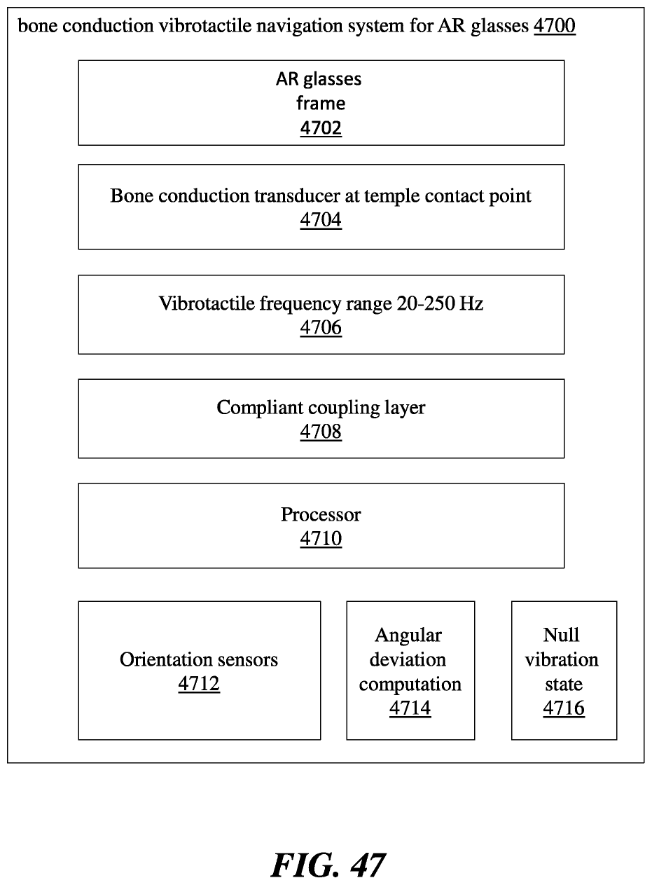

FIG. 47 illustrates a bone conduction vibrotactile navigation system 4700 implemented within an augmented reality glasses device, according to some embodiments. The system 4700 is integrated into an AR glasses frame 4702 that is configured to be worn by a user such that portions of the frame contact the user's head, including temple regions. The AR glasses frame 4702 houses structural, electronic, and sensing components required to perform haptic navigation without reliance on external devices. The frame may be constructed from rigid or semi-flexible materials capable of supporting embedded electronic components while maintaining user comfort during extended wear. In some embodiments, the AR glasses frame 4702 includes internal routing channels for electrical connections between system components.

The system 4700 includes a bone conduction transducer 4704 positioned at a temple contact point of the AR glasses frame 4702. The bone conduction transducer 4704 is configured to generate vibrotactile signals that are transmitted through the user's cranial structure to the somatosensory system. Unlike conventional audio transducers, the bone conduction transducer 4704 operates in a vibrotactile mode in which vibrations are perceived as tactile sensations rather than audible sound. In some embodiments, the bone conduction transducer 4704 operates within a vibrotactile frequency range 4706 of approximately 20 Hz to approximately 250 Hz. This frequency range is selected to fall below typical auditory perception thresholds for bone-conducted sound, thereby allowing the output to be interpreted as touch rather than hearing. The transducer may be driven by control signals generated by a processor and may produce variable intensity and frequency outputs based on navigation conditions.

In certain embodiments, a compliant coupling layer 4708 is positioned between the bone conduction transducer 4704 and the user's skin. The compliant coupling layer 4708 may be formed from elastomeric materials, gels, foams, or other deformable materials configured to improve mechanical coupling between the transducer and the user. The compliant coupling layer 4708 enhances transmission of vibrotactile energy while improving comfort and reducing localized pressure. The material properties of the compliant coupling layer 4708 may be selected to optimize vibration transfer across a range of frequencies while minimizing energy loss. In some implementations, the coupling layer may also dampen unwanted high-frequency components or reduce mechanical noise.

The system 4700 further includes a processor 4710 configured to control operation of the navigation system. The processor 4710 is communicatively coupled to one or more orientation sensors 4712, which may include a gyroscope, an accelerometer, a magnetometer, or combinations thereof. The orientation sensors 4712 are configured to detect motion and orientation of the AR glasses device and generate sensor data representing a current heading of the user. The processor 4710 processes the sensor data to compute an angular deviation 4714 between the current heading and a target heading associated with a navigation route. The computation of angular deviation may be performed continuously and updated in real time as the user moves.

Based on the computed angular deviation 4714, the processor 4710 controls the bone conduction transducer 4704 to generate vibrotactile output. When the angular deviation is within a threshold angular range, the processor 4710 maintains a null vibration state 4716 in which no vibrotactile output is generated. This null vibration state indicates that the user is aligned with the target heading. When the angular deviation exceeds the threshold angular range, the processor 4710 causes the bone conduction transducer 4704 to generate vibrations having an intensity that increases proportionally with the angular deviation. The intensity may be scaled from a minimal perceptible level to a maximum output level corresponding to approximately 180 degrees of deviation. In some embodiments, vibration frequency may also be modulated in conjunction with intensity to provide enhanced perceptual cues.

In operation, the system 4700 enables hands-free and eyes-free navigation by delivering directional information through bone-conducted vibrotactile signals. The integration of the bone conduction transducer 4704 within the AR glasses frame 4702 allows direct transmission of haptic feedback without requiring external wearable devices such as wristbands or handheld units. The use of orientation sensors 4712 and real-time processing by the processor 4710 provides accurate and responsive navigation guidance. The system 4700 may be used in a variety of environments, including indoor and outdoor settings, and is particularly advantageous in scenarios where visual or audio feedback is undesirable or impractical. The described configuration provides a compact and efficient architecture for delivering haptic navigation cues directly through an AR glasses platform.

### Computer System

In some embodiments, the present invention may be a computer system, a method, and/or the computing device 116 (of FIG. 1) or the computing device 222 (of FIG. 35). For example, the computer system and/or the computing device 222 may be utilized to implement one or more methods described herein. A basic configuration 232 of a computing device 222 is illustrated in FIG. 35 by those components within the inner dashed line.

In the basic configuration 232 of the computing device 222 of FIG. 35, the computing device 222 includes a processor 234 and a system memory 224. In some examples, the computing device 222 may include one or more processors and the system memory 224. A memory bus 244 is used for communicating between the one or more processors 234 and the system memory 224.

Depending on the desired configuration, the processor 234 may be of any type, including, but not limited to, a microprocessor (uP), a microcontroller (uC), and a digital signal processor (DSP), or any combination thereof. Further, the processor 234 may include one or more levels of caching, such as a level cache memory 236, a processor core 238, and registers 240, among other examples. The processor core 238 may include an arithmetic logic unit (ALU), a floating point unit (FPU), and/or a digital signal processing core (DSP Core), or any combination thereof. A memory controller 242 may be used with the processor 234, or, in some implementations, the memory controller 242 may be an internal part of the memory controller 242.

Depending on the desired configuration, the system memory 224 may be of any type, including, but not limited to, volatile memory (such as RAM), and/or non-volatile memory (such as ROM, flash memory, etc.), or any combination thereof. The system memory 224 includes an operating system 226, one or more engines, such as the Haptic Line™ engine 108, and program data 230. The system memory 224 may also include a storage engine 228 that may store any information disclosed herein.

Moreover, the computing device 222 may have additional features or functionality, and additional interfaces to facilitate communications between the basic configuration 232 and any desired devices and interfaces. For example, a bus/interface controller 248 is used to facilitate communications between the basic configuration 232 and data storage devices 246 via a storage interface bus 250. The data storage devices 246 may be one or more removable storage devices 252, one or more non-removable storage devices 254, or a combination thereof. Examples of the one or more removable storage devices 252 and the one or more non-removable storage devices 254 include magnetic disk devices (such as flexible disk drives and hard-disk drives (HDD)), optical disk drives (such as compact disk (CD) drives or digital versatile disk (DVD) drives), solid state drives (SSD), and tape drives, among others.

In some embodiments, an interface bus 256 facilitates communication from various interface devices (e.g., one or more output devices 280, one or more peripheral interfaces 272, and one or more communication devices 264) to the basic configuration 232 via the bus/interface controller 256. Some of the one or more output devices 280 include a graphics processing unit 278 and an audio processing unit 276, which are configured to communicate to various external devices, such as a display or speakers, via one or more A/V ports 274.

The one or more peripheral interfaces 272 may include a serial interface controller 270 or a parallel interface controller 266, which are configured to communicate with external devices, such as input devices (e.g., a keyboard, a mouse, a pen, a voice input device, or a touch input device, etc.) or other peripheral devices (e.g., a printer or a scanner, etc.) via one or more I/O ports 268.

Further, the one or more communication devices 264 may include a network controller 258, which is arranged to facilitate communication with one or more other computing devices 262 over a network communication link via one or more communication ports 260. The one or more other computing devices 262 include servers, the database, mobile devices, and comparable devices.

The network communication link is an example of a communication media. The communication media are typically embodied by the computer-readable instructions, data structures, program modules, or other data in a modulated data signal, such as a carrier wave or other transport mechanism, and include any information delivery media. A “modulated data signal” is a signal that has one or more of its characteristics set or changed in such a manner as to encode information in the signal. By way of example, and not limitation, the communication media may include wired media (such as a wired network or direct-wired connection) and wireless media (such as acoustic, radio frequency (RF), microwave, infrared (IR), and other wireless media). The term “computer-readable media,” as used herein, includes both storage media and communication media.

It should be appreciated that the system memory 224, the one or more removable storage devices 252, and the one or more non-removable storage devices 254 are examples of the computer-readable storage media. The computer-readable storage media is a tangible device that can retain and store instructions (e.g., program code) for use by an instruction execution device (e.g., the computing device 222). Any such, computer storage media is part of the computing device 222.

The computer readable storage media/medium can be a tangible device that can retain and store instructions for use by an instruction execution device. The computer readable storage media/medium may be, for example, but is not limited to, an electronic storage device, a magnetic storage device, an optical storage device, an electromagnetic storage device, and/or a semiconductor storage device, or any suitable combination of the foregoing. A non-exhaustive list of more specific examples of the computer readable storage media/medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and/or a mechanically encoded device (such as punch-cards or raised structures in a groove having instructions recorded thereon), and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Aspects of the present invention are described herein regarding illustrations and/or block diagrams of methods, computer systems, and computing devices according to embodiments of the invention. It will be understood that each block in the block diagrams, and combinations of the blocks, can be implemented by the computer-readable instructions (e.g., the program code).

The computer-readable instructions are provided to the processor 234 of a general purpose computer, special purpose computer, or other programmable data processing apparatus (e.g., the computing device 222) to produce a machine, such that the instructions, which execute via the processor 234 of the computer or other programmable data processing apparatus, create means for implementing the functions/acts specified in the block diagram blocks. These computer-readable instructions are also stored in a computer-readable storage medium that can direct a computer, a programmable data processing apparatus, and/or other devices to function in a particular manner, such that the computer-readable storage medium having instructions stored therein comprises an article of manufacture including instructions, which implement aspects of the functions/acts specified in the block diagram blocks.

The computer-readable instructions (e.g., the program code) are also loaded onto a computer (e.g., the computing device 222), another programmable data processing apparatus, or another device to cause a series of operational steps to be performed on the computer, the other programmable apparatus, or the other device to produce a computer implemented process, such that the instructions, which execute on the computer, the other programmable apparatus, or the other device, implement the functions/acts specified in the block diagram blocks.

### EXAMPLES

Embodiment 1. A haptic navigation device comprising: one or more orientation sensors configured to detect angular data representing an angular relationship between a current orientation of the haptic navigation device and a target heading, the one or more orientation sensors comprising at least one of: a gyroscope, an accelerometer, a magnetometer, a GPS/GNSS receiver, a camera-based orientation system, or combinations thereof, a vibration actuator configured to generate vibrotactile output; a non-transitory memory storing a planned navigation route; and a processor configured to: compute an angular deviation between a current heading of the haptic navigation device and the target heading derived from the planned navigation route; cause the vibration actuator to produce a null vibration state when the angular deviation is within a configurable threshold angular range of the target heading; and cause the vibration actuator to increase vibration intensity proportionally as the angular deviation increases beyond the configurable threshold angular range, reaching maximum intensity at a maximum angular deviation from the target heading.

Embodiment 2. The haptic navigation device of embodiment 1, wherein the vibrotactile output generated by the vibration actuator comprises simultaneous modulation of both vibration frequency and vibration amplitude, each modulated proportionally to the angular deviation from the target heading.

Embodiment 3. The haptic navigation device of embodiment 1, further comprising an adaptive haptic module, wherein the processor is further configured to: receive navigation performance data comprising at least one of: time-to-destination measurements, heading deviation event frequency, and waypoint miss event counts; update a vibrotactile parameter model based on the navigation performance data, the vibrotactile parameter model comprising learned adjustments to at least one of: vibration intensity scaling, threshold angular range, and vibration duty cycle; and adjust a vibrotactile output parameter based on the updated vibrotactile parameter model; executing a model inference by a processor on-device without network connectivity during active navigation.

Embodiment 4. The haptic navigation device of claim 3, wherein the adaptive haptic module executes on a microcontroller having less than approximately 256 kilobytes of flash memory and less than approximately 64 kilobytes of static random-access memory, and wherein the vibrotactile parameter model occupies less than approximately 100 kilobytes of the non-transitory memory.

Embodiment 5. The haptic navigation device of embodiment 1, wherein: the haptic navigation device is an augmented reality (AR) glasses device or head-mounted display comprising a frame; the vibration actuator comprises at least one of: a bone conduction transducer mounted at a temple contact point of the frame of the AR glasses device; a linear resonant actuator (LRA) embedded within the frame of the AR glasses device; or a vibrotactile array integrated into the frame of the head-mounted display; and wherein the null vibration state and a vibrotactile gradient output are delivered directly through the frame of the AR glasses device to a wearer without requiring a separate wristband or smartphone.

Embodiment 6. The haptic navigation device of embodiment 1, wherein: the haptic navigation device is an augmented reality (AR) glasses device or head-mounted display comprising a frame; the vibration actuator comprises at least one of: a bone conduction transducer mounted at a temple contact point of the frame of the AR glasses device, a linear resonant actuator (LRA) embedded within the frame of the AR glasses device, or a vibrotactile array integrated into the frame of the head-mounted display; and wherein the null vibration state and the vibration intensity that increases proportionally with the angular deviation are delivered directly through the frame of the AR glasses device to a wearer without requiring a separate wristband or smartphone.

Embodiment 7. The haptic navigation device of embodiment 1, wherein the processor is further configured to detect availability of GPS/GNSS signals from the GPS/GNSS receiver.

Embodiment 8. The haptic navigation device of embodiment 7, wherein the processor is further configured to compare the GPS/GNSS signal availability to a configurable signal quality threshold stored in the non-transitory memory.

Embodiment 9. The haptic navigation device of embodiment 8, wherein, when the GPS/GNSS signal availability is above the configurable signal quality threshold, the processor operates in an outdoor navigation mode in which the current heading is derived at least in part from GPS/GNSS-based heading estimation.

Embodiment 10. The haptic navigation device of embodiment 9, wherein, when the GPS/GNSS signal availability is below the configurable signal quality threshold, the processor operates in an indoor navigation mode in which the current heading is derived at least in part from at least one of: Bluetooth Low Energy beacon triangulation, Ultra-Wideband ranging, magnetometer-based heading estimation, camera-based visual-inertial odometry, or combinations thereof.

Embodiment 11. The haptic navigation device of embodiment 10, wherein the processor is further configured to automatically transition from the outdoor navigation mode to the indoor navigation mode when the GPS/GNSS signal availability falls below the configurable signal quality threshold.

Embodiment 12. The haptic navigation device of embodiment 10, wherein the processor is further configured to automatically transition from the indoor navigation mode to the outdoor navigation mode when the GPS/GNSS signal availability rises above the configurable signal quality threshold without requiring user input.

Embodiment 13. The haptic navigation device of embodiment 1, wherein the processor is further configured to measure ambient vibration levels using the accelerometer of the one or more orientation sensors.

Embodiment 14. The haptic navigation device of embodiment 13, wherein the processor is further configured to compare the measured ambient vibration levels to a configurable ambient vibration threshold stored in the non-transitory memory.

Embodiment 15. The haptic navigation device of claim 1, wherein the processor is further configured to: detect availability of GPS/GNSS signals from the GPS/GNSS receiver; when GPS/GNSS signal availability is above a configurable signal quality threshold, operate in an outdoor navigation mode in which the current heading is derived at least in part from GPS/GNSS-based heading estimation; when GPS/GNSS signal availability is below the configurable signal quality threshold, operate in an indoor navigation mode in which the current heading is derived at least in part from at least one of: BLE beacon triangulation, UWB ranging, magnetometer-based heading estimation, the camera-based orientation system, or combinations thereof, and automatically transition between the outdoor navigation mode and the indoor navigation mode based on changes in GPS/GNSS signal availability without requiring user input.

Embodiment 16. The haptic navigation device of embodiment 1, wherein the processor is further configured to: measure ambient vibration levels using the accelerometer of the one or more orientation sensors; compare the measured ambient vibration levels to a configurable ambient vibration threshold; and when the measured ambient vibration levels exceed the configurable ambient vibration threshold, increase at least one of the vibration intensity and a vibration frequency of the vibrotactile output by a compensation factor proportional to the measured ambient vibration levels, thereby maintaining perceptibility of the vibrotactile output during locomotion, vehicular travel, or operation of vibrating equipment. The haptic navigation device of claim 13, wherein, when the measured ambient vibration levels exceed the configurable ambient vibration threshold, the processor is further configured to increase at least one of the vibration intensity or the vibration frequency of the vibrotactile output.

Embodiment 17. The haptic navigation device of embodiment 14, wherein the processor is further configured to increase the at least one of the vibration intensity or vibration frequency by a compensation factor proportional to the measured ambient vibration levels.

Embodiment 18. The haptic navigation device of embodiment 15, wherein the processor is further configured to maintain perceptibility of the vibrotactile output during at least one of locomotion, vehicular travel, or operation of vibrating equipment.

Embodiment 19. The haptic navigation device of embodiment 1, wherein the vibration actuator comprises a bone conduction transducer.

Embodiment 20. The haptic navigation device of embodiment 19, wherein the bone conduction transducer is configured to operate within a vibrotactile frequency range of approximately 20 Hz to approximately 250 Hz.

Embodiment 21. The haptic navigation device of embodiment 20, wherein the vibrotactile frequency range is below an auditory perception threshold for bone-conducted sound of approximately 500 Hz.

Embodiment 22. The haptic navigation device of embodiment 19, wherein the bone conduction transducer is configured such that the vibrotactile output is perceived by a user through a somatosensory system as a tactile sensation rather than through an auditory system as an audible signal.

Embodiment 23. The haptic navigation device of claim 1, wherein the processor is further configured to generate a confirmation pulse when the angular deviation is within the configurable threshold angular range, the confirmation pulse comprising a periodic vibrotactile pattern at a frequency of approximately 0.2 Hz to approximately 1 Hz distinguishable from the null vibration state, indicating alignment with the target heading.

Embodiment 24. A system for haptic navigation comprising: a processor configured to compute an angular deviation between a sensed orientation and a target heading derived from a navigation route stored in memory; a vibration actuator coupled to the processor; and wherein the processor maps the angular deviation to a vibrotactile gradient output in which: a vibration intensity is at a null state when the angular deviation is within a threshold of the target heading; the vibration intensity increases continuously from the null state as the angular deviation increases; and the vibration intensity reaches a maximum value at 180 degrees of the angular deviation from the target heading; wherein the null state and the vibrotactile gradient output are implemented without a graphical display output.

Embodiment 25. The system for haptic navigation of embodiment 24, wherein the target heading is derived from a target comprising at least one of: a physical geographic location specified by coordinates; a physical device broadcasting a wireless identifier; a vehicle; a person whose position is tracked by a positioning system; or a physical asset tagged with a GPS, Bluetooth Low Energy (BLE), or Ultra-Wideband (UWB) identifier.

Embodiment 26. The system for haptic navigation of embodiment 24, wherein the processor is further configured to: generate a wrong-vehicle alert pattern comprising a rapid alternating vibrotactile pattern when proximity to a vehicle is detected whose received identifier does not match a stored identifier of a target vehicle; and generate a vehicle-confirmed pattern comprising a distinct confirmation vibrotactile pattern when proximity to the target vehicle is confirmed by a match between a received identifier and the stored identifier of the target vehicle.

Embodiment 27. A distributed haptic navigation system comprising: a first computing device comprising a navigation engine configured to: receive route data; determine a current position and a current heading of a user; and compute an angular deviation between the current heading and a target heading; a second haptic output device communicatively coupled to the first computing device via a short-range wireless protocol comprising at least one of Bluetooth, Bluetooth Low Energy, or Ultra-Wideband; the second haptic output device comprising a vibration actuator; and wherein the first computing device transmits vibrotactile output parameters to the second haptic output device, and the second haptic output device generates vibrotactile output encoding the angular deviation as: a null vibration state when the angular deviation is within a configurable threshold; and vibration intensity increases proportional to the angular deviation as the angular deviation increases beyond the configurable threshold.

Embodiment 28. A method for haptic navigation comprising: receiving orientation data from one or more orientation sensors comprising at least one of: a gyroscope, an accelerometer, a magnetometer, a GPS/GNSS receiver, a camera-based orientation system, or combinations thereof; computing an angular deviation between a current heading derived from the orientation data and a target heading derived from a planned navigation route stored in memory; encoding the angular deviation as a vibrotactile signal in which: a vibration intensity is at a null state when the angular deviation is within a configurable threshold; and the vibration intensity increases proportionally as the angular deviation increases beyond the configurable threshold; and delivering the vibrotactile signal through a vibration actuator of a haptic output device worn on or carried by a user.

Embodiment 29. The method of embodiment 28, wherein encoding the angular deviation comprises simultaneously modulating both vibration frequency and vibration amplitude of the vibrotactile signal, each modulated proportionally to the angular deviation.

Embodiment 30. A proximity-based vehicle identification system comprising: a positioning module configured to receive proximity signals from a target vehicle via at least one of: Bluetooth Low Energy (BLE) received signal strength indicator (RSSI), Ultra-Wideband (UWB) two-way ranging, Near Field Communication (NFC) field detection, computer vision vehicle recognition, or QR code scanning; a vibration actuator; a non-transitory memory storing a target vehicle identifier; and a processor configured to: compare a received vehicle identifier against a stored target vehicle identifier; and generate a vehicle identification heartbeat pattern comprising a rhythmic vibrotactile pulse whose repetition rate and intensity each increase as measured proximity to the target vehicle decreases below a configurable proximity threshold; wherein the target vehicle identifier is broadcast by a rideshare application, autonomous vehicle platform, or fleet management system operating on a driver device, vehicle-embedded computer, or vehicle-mounted beacon.

Embodiment 31. The proximity-based vehicle identification system of embodiment 30, wherein the processor is further configured to determine a measured proximity to the target vehicle based on the proximity signals received by the positioning module.

Embodiment 32. The proximity-based vehicle identification system of embodiment 31, wherein the processor is further configured to classify the measured proximity into a plurality of proximity zones comprising: a detection zone corresponding to a range of approximately 30 meters to approximately 100 meters; a guidance zone corresponding to a range of approximately 3 meters to approximately 30 meters; and an arrival zone corresponding to a range of less than approximately 3 meters.

Embodiment 33. The proximity-based vehicle identification system of embodiment 32, wherein the processor is further configured to generate the vehicle identification heartbeat pattern at a first repetition rate when the measured proximity is within the detection zone.

Embodiment 34. The proximity-based vehicle identification system of embodiment 33, wherein the processor is further configured to generate the vehicle identification heartbeat pattern at a second repetition rate greater than the first repetition rate when the measured proximity is within the guidance zone.

Embodiment 35. The proximity-based vehicle identification system of embodiment 34, wherein the processor is further configured to generate the vehicle identification heartbeat pattern at a third repetition rate greater than the second repetition rate when the measured proximity is within the arrival zone.

Embodiment 36. The proximity-based vehicle identification system of embodiment 32, wherein the processor is further configured to, upon determining that the measured proximity is within the arrival zone, generate a vehicle-confirmed vibrotactile pattern comprising a sustained vibrotactile pulse distinguishable from the rhythmic vibrotactile pulse of the vehicle identification heartbeat pattern.

Embodiment 37. The proximity-based vehicle identification system of claim 30, wherein the processor is further configured to: classify the measured proximity to the target vehicle into at least three proximity zones comprising a detection zone at a range of approximately 30 meters to approximately 100 meters, a guidance zone at a range of approximately 3 meters to approximately 30 meters, and an arrival zone at a range of less than approximately 3 meters; generate the vehicle identification heartbeat pattern at a first repetition rate in the detection zone, a second repetition rate greater than the first repetition rate in the guidance zone, and a third repetition rate greater than the second repetition rate in the arrival zone; and upon entry into the arrival zone, generate a vehicle-confirmed vibrotactile pattern comprising a sustained vibrotactile pulse distinguishable from the rhythmic vibrotactile pulse of the vehicle identification heartbeat pattern.

Embodiment 38. A haptic human-robot guidance system comprising: a robotic platform comprising a proximity radio module configured to broadcast a unique robot identifier via at least one of Bluetooth Low Energy (BLE), Ultra-Wideband (UWB), or Wi-Fi; a human-worn haptic output device comprising: a vibration actuator; one or more orientation sensors; and a processor; and wherein the processor of the human-worn haptic output device is configured to: receive the unique robot identifier broadcast and determine a heading toward the robotic platform; compute angular deviation between a current heading of a user and the heading toward the robotic platform; and encode the angular deviation as a null vibration state when the angular deviation is within a threshold and as increasing vibration intensity as the angular deviation increases beyond the threshold; wherein guidance is delivered without requiring visual display or audio output from either the robotic platform or the human-worn haptic output device.

Embodiment 39. A non-transitory computer-readable medium storing instructions that, when executed by a processor of a haptic output device comprising a vibration actuator and one or more orientation sensors, cause the processor to: receive orientation data from the one or more orientation sensors; compute an angular deviation between a current heading derived from the orientation data and a target heading derived from a planned navigation route stored in memory of the haptic output device; cause the vibration actuator to produce a null vibration state when the angular deviation is within a configurable threshold angular range of the target heading; and cause the vibration actuator to increase vibration intensity proportionally as the angular deviation increases beyond the configurable threshold angular range, reaching maximum intensity at a maximum angular deviation from the target heading.

Embodiment 40. The non-transitory computer-readable medium of embodiment 39, wherein the instructions further cause the processor to simultaneously modulate both vibration frequency and vibration amplitude of the vibration actuator proportionally to the angular deviation.

Embodiment 41. The non-transitory computer-readable medium of embodiment 39, wherein the instructions further cause the processor to dynamically adjust at least one of: vibration intensity, vibration frequency, or vibration duty cycle based on changes in the angular deviation in real time.

Embodiment 42. The non-transitory computer-readable medium of embodiment 39, wherein the instructions further cause the processor to apply a configurable threshold angular range stored in memory to define the null vibration state.

Embodiment 43. The non-transitory computer-readable medium of embodiment 39, wherein the instructions further cause the processor to generate a gradient transition of vibration intensity from the null vibration state to the maximum intensity based on a continuous mapping function of the angular deviation.

Embodiment 44. The non-transitory computer-readable medium of embodiment 39, wherein the instructions further cause the processor to output the vibration intensity through at least one of: a linear resonant actuator, an eccentric rotating mass motor, or a vibrotactile array.

Embodiment 45. The non-transitory computer-readable medium of embodiment 39, wherein the instructions further cause the processor to perform the computing of the angular deviation and control of the vibration actuator without requiring a graphical display or audio output.

Embodiment 1. A haptic navigation device comprising: one or more orientation sensors configured to detect angular data representing an angular relationship between a current orientation of the haptic navigation device and a target heading, the one or more orientation sensors comprising at least one of: a gyroscope, an accelerometer, a magnetometer, a GPS/GNSS receiver, a camera-based orientation system, or combinations thereof; a vibration actuator configured to generate vibrotactile output; a non-transitory memory storing a planned navigation route; and a processor configured to: compute an angular deviation between a current heading of the haptic navigation device and the target heading derived from the planned navigation route; cause the vibration actuator to produce a null vibration state when the angular deviation is within a configurable threshold angular range of the target heading; and cause the vibration actuator to increase vibration intensity proportionally as the angular deviation increases beyond the configurable threshold angular range, reaching maximum intensity at a maximum angular deviation from the target heading.

Embodiment 2. The haptic navigation device of embodiment 1, wherein the vibrotactile output generated by the vibration actuator comprises simultaneous modulation of both vibration frequency and vibration amplitude, each modulated proportionally to the angular deviation from the target heading.

Embodiment 3. The haptic navigation device of embodiment 1, further comprising an adaptive haptic module, wherein the processor is further configured to: receive navigation performance data comprising at least one of: time-to-destination measurements, heading deviation event frequency, and waypoint miss event counts; update a vibrotactile parameter model based on the navigation performance data, the vibrotactile parameter model comprising learned adjustments to at least one of: vibration intensity scaling, threshold angular range, and vibration duty cycle; and adjust a vibrotactile output parameter based on the updated vibrotactile parameter model; executing a model inference by a processor on-device without network connectivity during active navigation.

Embodiment 4. The haptic navigation device of claim 3, wherein the adaptive haptic module executes on a microcontroller having less than approximately 256 kilobytes of flash memory and less than approximately 64 kilobytes of static random-access memory, and wherein the vibrotactile parameter model occupies less than approximately 100 kilobytes of the non-transitory memory.

Embodiment 5. The haptic navigation device of embodiment 1, wherein: the haptic navigation device is an augmented reality (AR) glasses device or head-mounted display comprising a frame; the vibration actuator comprises at least one of: a bone conduction transducer mounted at a temple contact point of the frame of the AR glasses device; a linear resonant actuator (LRA) embedded within the frame of the AR glasses device; or a vibrotactile array integrated into the frame of the head-mounted display; and wherein the null vibration state and a vibrotactile gradient output are delivered directly through the frame of the AR glasses device to a wearer without requiring a separate wristband or smartphone.

Embodiment 6. The haptic navigation device of embodiment 1, wherein: the haptic navigation device is an augmented reality (AR) glasses device or head-mounted display comprising a frame; the vibration actuator comprises at least one of: a bone conduction transducer mounted at a temple contact point of the frame of the AR glasses device, a linear resonant actuator (LRA) embedded within the frame of the AR glasses device, or a vibrotactile array integrated into the frame of the head-mounted display; and wherein the null vibration state and the vibration intensity that increases proportionally with the angular deviation are delivered directly through the frame of the AR glasses device to a wearer without requiring a separate wristband or smartphone.

Embodiment 7. The haptic navigation device of embodiment 1, wherein the processor is further configured to detect availability of GPS/GNSS signals from the GPS/GNSS receiver.

Embodiment 8. The haptic navigation device of embodiment 7, wherein the processor is further configured to compare the GPS/GNSS signal availability to a configurable signal quality threshold stored in the non-transitory memory.

Embodiment 9. The haptic navigation device of embodiment 8, wherein, when the GPS/GNSS signal availability is above the configurable signal quality threshold, the processor operates in an outdoor navigation mode in which the current heading is derived at least in part from GPS/GNSS-based heading estimation.

Embodiment 10. The haptic navigation device of embodiment 9, wherein, when the GPS/GNSS signal availability is below the configurable signal quality threshold, the processor operates in an indoor navigation mode in which the current heading is derived at least in part from at least one of: Bluetooth Low Energy beacon triangulation, Ultra-Wideband ranging, magnetometer-based heading estimation, camera-based visual-inertial odometry, or combinations thereof.

Embodiment 11. The haptic navigation device of embodiment 10, wherein the processor is further configured to automatically transition from the outdoor navigation mode to the indoor navigation mode when the GPS/GNSS signal availability falls below the configurable signal quality threshold.

Embodiment 12. The haptic navigation device of embodiment 10, wherein the processor is further configured to automatically transition from the indoor navigation mode to the outdoor navigation mode when the GPS/GNSS signal availability rises above the configurable signal quality threshold without requiring user input.

Embodiment 13. The haptic navigation device of embodiment 1, wherein the processor is further configured to measure ambient vibration levels using the accelerometer of the one or more orientation sensors.

Embodiment 14. The haptic navigation device of embodiment 13, wherein the processor is further configured to compare the measured ambient vibration levels to a configurable ambient vibration threshold stored in the non-transitory memory.

Embodiment 15. The haptic navigation device of claim 1, wherein the processor is further configured to: detect availability of GPS/GNSS signals from the GPS/GNSS receiver; when GPS/GNSS signal availability is above a configurable signal quality threshold, operate in an outdoor navigation mode in which the current heading is derived at least in part from GPS/GNSS-based heading estimation; when GPS/GNSS signal availability is below the configurable signal quality threshold, operate in an indoor navigation mode in which the current heading is derived at least in part from at least one of: BLE beacon triangulation, UWB ranging, magnetometer-based heading estimation, the camera-based orientation system, or combinations thereof; and automatically transition between the outdoor navigation mode and the indoor navigation mode based on changes in GPS/GNSS signal availability without requiring user input.

Embodiment 16. The haptic navigation device of embodiment 1, wherein the processor is further configured to: measure ambient vibration levels using the accelerometer of the one or more orientation sensors; compare the measured ambient vibration levels to a configurable ambient vibration threshold; and when the measured ambient vibration levels exceed the configurable ambient vibration threshold, increase at least one of the vibration intensity and a vibration frequency of the vibrotactile output by a compensation factor proportional to the measured ambient vibration levels, thereby maintaining perceptibility of the vibrotactile output during locomotion, vehicular travel, or operation of vibrating equipment.

Embodiment 17. The haptic navigation device of embodiment 16, wherein, when the measured ambient vibration levels exceed the configurable ambient vibration threshold, the processor is further configured to increase at least one of the vibration intensity or the vibration frequency of the vibrotactile output.

Embodiment 18. The haptic navigation device of embodiment 17, wherein the processor is further configured to increase the at least one of the vibration intensity or vibration frequency by a compensation factor proportional to the measured ambient vibration levels.

Embodiment 19. The haptic navigation device of embodiment 18, wherein the processor is further configured to maintain perceptibility of the vibrotactile output during at least one of locomotion, vehicular travel, or operation of vibrating equipment.

Embodiment 20. The haptic navigation device of embodiment 1, wherein the vibration actuator comprises a bone conduction transducer.

Embodiment 21. The haptic navigation device of embodiment 20, wherein the bone conduction transducer is configured to operate within a vibrotactile frequency range of approximately 20 Hz to approximately 250 Hz.

Embodiment 22. The haptic navigation device of embodiment 21, wherein the vibrotactile frequency range is below an auditory perception threshold for bone-conducted sound of approximately 500 Hz.

Embodiment 23. The haptic navigation device of embodiment 20, wherein the bone conduction transducer is configured such that the vibrotactile output is perceived by a user through a somatosensory system as a tactile sensation rather than through an auditory system as an audible signal.

Embodiment 24. The haptic navigation device of embodiment 1, wherein the processor is further configured to generate a confirmation pulse when the angular deviation is within the configurable threshold angular range, the confirmation pulse comprising a periodic vibrotactile pattern at a frequency of approximately 0.2 Hz to approximately 1 Hz distinguishable from the null vibration state, indicating alignment with the target heading.

Embodiment 25. A system for haptic navigation comprising: a processor configured to compute an angular deviation between a sensed orientation and a target heading derived from a navigation route stored in memory; a vibration actuator coupled to the processor; and wherein the processor maps the angular deviation to a vibrotactile gradient output in which: a vibration intensity is at a null state when the angular deviation is within a threshold of the target heading; the vibration intensity increases continuously from the null state as the angular deviation increases; and the vibration intensity reaches a maximum value at 180 degrees of the angular deviation from the target heading; wherein the null state and the vibrotactile gradient output are implemented without a graphical display output.

Embodiment 26. The system for haptic navigation of embodiment 25, wherein the target heading is derived from a target comprising at least one of: a physical geographic location specified by coordinates; a physical device broadcasting a wireless identifier; a vehicle; a person whose position is tracked by a positioning system; or a physical asset tagged with a GPS, Bluetooth Low Energy (BLE), or Ultra-Wideband (UWB) identifier.

Embodiment 27. The system for haptic navigation of embodiment 25, wherein the processor is further configured to: generate a wrong-vehicle alert pattern comprising a rapid alternating vibrotactile pattern when proximity to a vehicle is detected whose received identifier does not match a stored identifier of a target vehicle; and generate a vehicle-confirmed pattern comprising a distinct confirmation vibrotactile pattern when proximity to the target vehicle is confirmed by a match between a received identifier and the stored identifier of the target vehicle.

Embodiment 28. A distributed haptic navigation system comprising: a first computing device comprising a navigation engine configured to: receive route data; determine a current position and a current heading of a user; and compute an angular deviation between the current heading and a target heading; a second haptic output device communicatively coupled to the first computing device via a short-range wireless protocol comprising at least one of Bluetooth, Bluetooth Low Energy, or Ultra-Wideband; the second haptic output device comprising a vibration actuator; and wherein the first computing device transmits vibrotactile output parameters to the second haptic output device, and the second haptic output device generates vibrotactile output encoding the angular deviation as: a null vibration state when the angular deviation is within a configurable threshold; and vibration intensity increases proportional to the angular deviation as the angular deviation increases beyond the configurable threshold.

Embodiment 29. A method for haptic navigation comprising: receiving orientation data from one or more orientation sensors comprising at least one of: a gyroscope, an accelerometer, a magnetometer, a GPS/GNSS receiver, a camera-based orientation system, or combinations thereof; computing an angular deviation between a current heading derived from the orientation data and a target heading derived from a planned navigation route stored in memory; encoding the angular deviation as a vibrotactile signal in which: a vibration intensity is at a null state when the angular deviation is within a configurable threshold; and the vibration intensity increases proportionally as the angular deviation increases beyond the configurable threshold; and delivering the vibrotactile signal through a vibration actuator of a haptic output device worn on or carried by a user.

Embodiment 30. The method of embodiment 29, wherein encoding the angular deviation comprises simultaneously modulating both vibration frequency and vibration amplitude of the vibrotactile signal, each modulated proportionally to the angular deviation.

Embodiment 31. A proximity-based vehicle identification system comprising: a positioning module configured to receive proximity signals from a target vehicle via at least one of: Bluetooth Low Energy (BLE) received signal strength indicator (RSSI), Ultra-Wideband (UWB) two-way ranging, Near Field Communication (NFC) field detection, computer vision vehicle recognition, or QR code scanning; a vibration actuator; a non-transitory memory storing a target vehicle identifier; and a processor configured to: compare a received vehicle identifier against a stored target vehicle identifier; and generate a vehicle identification heartbeat pattern comprising a rhythmic vibrotactile pulse whose repetition rate and intensity each increase as measured proximity to the target vehicle decreases below a configurable proximity threshold; wherein the target vehicle identifier is broadcast by a rideshare application, autonomous vehicle platform, or fleet management system operating on a driver device, vehicle-embedded computer, or vehicle-mounted beacon.

Embodiment 32. The proximity-based vehicle identification system of embodiment 31, wherein the processor is further configured to determine a measured proximity to the target vehicle based on the proximity signals received by the positioning module.

Embodiment 33. The proximity-based vehicle identification system of embodiment 32, wherein the processor is further configured to classify the measured proximity into a plurality of proximity zones comprising: a detection zone corresponding to a range of approximately 30 meters to approximately 100 meters; a guidance zone corresponding to a range of approximately 3 meters to approximately 30 meters; and an arrival zone corresponding to a range of less than approximately 3 meters.

Embodiment 34. The proximity-based vehicle identification system of embodiment 33, wherein the processor is further configured to generate the vehicle identification heartbeat pattern at a first repetition rate when the measured proximity is within the detection zone.

Embodiment 35. The proximity-based vehicle identification system of embodiment 34, wherein the processor is further configured to generate the vehicle identification heartbeat pattern at a second repetition rate greater than the first repetition rate when the measured proximity is within the guidance zone.

Embodiment 36. The proximity-based vehicle identification system of embodiment 35, wherein the processor is further configured to generate the vehicle identification heartbeat pattern at a third repetition rate greater than the second repetition rate when the measured proximity is within the arrival zone.

Embodiment 37. The proximity-based vehicle identification system of embodiment 33, wherein the processor is further configured to, upon determining that the measured proximity is within the arrival zone, generate a vehicle-confirmed vibrotactile pattern comprising a sustained vibrotactile pulse distinguishable from the rhythmic vibrotactile pulse of the vehicle identification heartbeat pattern.

Embodiment 38. The proximity-based vehicle identification system of claim 31, wherein the processor is further configured to: classify the measured proximity to the target vehicle into at least three proximity zones comprising a detection zone at a range of approximately 30 meters to approximately 100 meters, a guidance zone at a range of approximately 3 meters to approximately 30 meters, and an arrival zone at a range of less than approximately 3 meters; generate the vehicle identification heartbeat pattern at a first repetition rate in the detection zone, a second repetition rate greater than the first repetition rate in the guidance zone, and a third repetition rate greater than the second repetition rate in the arrival zone; and upon entry into the arrival zone, generate a vehicle-confirmed vibrotactile pattern comprising a sustained vibrotactile pulse distinguishable from the rhythmic vibrotactile pulse of the vehicle identification heartbeat pattern.

Embodiment 39. A haptic human-robot guidance system comprising: a robotic platform comprising a proximity radio module configured to broadcast a unique robot identifier via at least one of Bluetooth Low Energy (BLE), Ultra-Wideband (UWB), or Wi-Fi; a human-worn haptic output device comprising: a vibration actuator; one or more orientation sensors; and a processor; and wherein the processor of the human-worn haptic output device is configured to: receive the unique robot identifier broadcast and determine a heading toward the robotic platform; compute angular deviation between a current heading of a user and the heading toward the robotic platform; and encode the angular deviation as a null vibration state when the angular deviation is within a threshold and as increasing vibration intensity as the angular deviation increases beyond the threshold; wherein guidance is delivered without requiring visual display or audio output from either the robotic platform or the human-worn haptic output device.

Embodiment 40. A non-transitory computer-readable medium storing instructions that, when executed by a processor of a haptic output device comprising a vibration actuator and one or more orientation sensors, cause the processor to: receive orientation data from the one or more orientation sensors; compute an angular deviation between a current heading derived from the orientation data and a target heading derived from a planned navigation route stored in memory of the haptic output device; cause the vibration actuator to produce a null vibration state when the angular deviation is within a configurable threshold angular range of the target heading; and cause the vibration actuator to increase vibration intensity proportionally as the angular deviation increases beyond the configurable threshold angular range, reaching maximum intensity at a maximum angular deviation from the target heading.

Embodiment 41. The non-transitory computer-readable medium of embodiment 40, wherein the instructions further cause the processor to simultaneously modulate both vibration frequency and vibration amplitude of the vibration actuator proportionally to the angular deviation.

Embodiment 42. The non-transitory computer-readable medium of embodiment 40, wherein the instructions further cause the processor to dynamically adjust at least one of: vibration intensity, vibration frequency, or vibration duty cycle based on changes in the angular deviation in real time.

Embodiment 43. The non-transitory computer-readable medium of embodiment 40, wherein the instructions further cause the processor to apply a configurable threshold angular range stored in memory to define the null vibration state.

Embodiment 44. The non-transitory computer-readable medium of embodiment 40, wherein the instructions further cause the processor to generate a gradient transition of vibration intensity from the null vibration state to the maximum intensity based on a continuous mapping function of the angular deviation.

Embodiment 45. The non-transitory computer-readable medium of embodiment 40, wherein the instructions further cause the processor to output the vibration intensity through at least one of: a linear resonant actuator, an eccentric rotating mass motor, or a vibrotactile array.

Embodiment 46. The non-transitory computer-readable medium of embodiment 40, wherein the instructions further cause the processor to perform the computing of the angular deviation and control of the vibration actuator without requiring a graphical display or audio output.

Computer readable program instructions described herein can also be downloaded to respective computing/processing devices from a computer readable storage medium or to an external computer or external storage device via a network (e.g., the Internet, a local area network, a wide area network, and/or a wireless network). The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer/computing device, partly on the user's computer/computing device, as a stand-alone software package, partly on the user's computer/computing device and partly on a remote computer/computing device or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to block diagrams of methods, computer systems, and computing devices according to embodiments of the invention. It will be understood that each block and combinations of blocks in the diagrams, can be implemented by the computer readable program instructions.

The block diagrams in the Figures illustrate the architecture, functionality, and operation of possible implementations of computer systems, methods, and computing devices according to various embodiments of the present invention. In this regard, each block in the block diagrams may represent a module, a segment, or a portion of executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block and combinations of blocks can be implemented by special purpose hardware-based systems that perform the specified functions or acts or carry out combinations of special purpose hardware and computer instructions.

Another embodiment of the invention provides a method that performs the process steps on a subscription, advertising, and/or fee basis. That is, a service provider can offer to assist in the method steps described herein. In this case, the service provider can create, maintain, and/or support, etc., a computer infrastructure that performs the process steps for one or more customers. In return, the service provider can receive payment from the customer(s) under a subscription and/or fee agreement, and/or the service provider can receive payment from the sale of advertising content to one or more third parties.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

When introducing elements of the present disclosure or the embodiments thereof, the articles “a,” “an,” and “the” are intended to mean that there are one or more of the elements.

Similarly, the adjective “another,” when used to introduce an element, is intended to mean one or more elements. The terms “including” and “having” are intended to be inclusive, such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A haptic navigation device comprising:
one or more orientation sensors configured to detect angular data representing an angular relationship between a current orientation of the haptic navigation device and a target heading, the one or more orientation sensors comprising at least one of: a gyroscope, an accelerometer, a magnetometer, a GPS/GNSS receiver, a camera-based orientation system, or combinations thereof;
a vibration actuator configured to generate vibrotactile output;
a non-transitory memory storing a planned navigation route; and
a processor configured to:
compute an angular deviation between a current heading of the haptic navigation device and the target heading derived from the planned navigation route;
cause the vibration actuator to produce a null vibration state when the angular deviation is within a configurable threshold angular range of the target heading; and
cause the vibration actuator to increase vibration intensity proportionally as the angular deviation increases beyond the configurable threshold angular range, reaching maximum intensity at a maximum angular deviation from the target heading.

2. The haptic navigation device of claim 1, wherein the vibrotactile output generated by the vibration actuator comprises simultaneous modulation of both vibration frequency and vibration amplitude, each modulated proportionally to the angular deviation from the target heading.

3. The haptic navigation device of claim 1, further comprising an adaptive haptic module, wherein the processor is further configured to:
receive navigation performance data comprising at least one of: time-to-destination measurements, heading deviation event frequency, and waypoint miss event counts;
update a vibrotactile parameter model based on the navigation performance data, the vibrotactile parameter model comprising learned adjustments to at least one of: vibration intensity scaling, threshold angular range, and vibration duty cycle; and
adjust a vibrotactile output parameter based on the updated vibrotactile parameter model;
executing a model inference by a processor on-device without network connectivity during active navigation.

4. The haptic navigation device of claim 3, wherein the adaptive haptic module executes on a microcontroller having less than approximately 256 kilobytes of flash memory and less than approximately 64 kilobytes of static random-access memory, and wherein the vibrotactile parameter model occupies less than approximately 100 kilobytes of the non-transitory memory.

5. The haptic navigation device of claim 1, wherein:
the haptic navigation device is an augmented reality (AR) glasses device or head-mounted display comprising a frame;
the vibration actuator comprises at least one of:
a bone conduction transducer mounted at a temple contact point of the frame of the AR glasses device;
a linear resonant actuator (LRA) embedded within the frame of the AR glasses device; or
a vibrotactile array integrated into the frame of the head-mounted display; and
wherein the null vibration state and a vibrotactile gradient output are delivered directly through the frame of the AR glasses device to a wearer without requiring a separate wristband or smartphone.

6. The haptic navigation device of claim 1, wherein:
the haptic navigation device is an augmented reality (AR) glasses device or head-mounted display comprising a frame;
the vibration actuator comprises at least one of: a bone conduction transducer mounted at a temple contact point of the frame of the AR glasses device, a linear resonant actuator (LRA) embedded within the frame of the AR glasses device, or a vibrotactile array integrated into the frame of the head-mounted display; and
wherein the null vibration state and the vibration intensity that increases proportionally with the angular deviation are delivered directly through the frame of the AR glasses device to a wearer without requiring a separate wristband or smartphone.

7. The haptic navigation device of claim 1, wherein the processor is further configured to detect availability of GPS/GNSS signals from the GPS/GNSS receiver.

8. The haptic navigation device of claim 7, wherein the processor is further configured to compare the GPS/GNSS signal availability to a configurable signal quality threshold stored in the non-transitory memory.

9. The haptic navigation device of claim 8, wherein, when the GPS/GNSS signal availability is above the configurable signal quality threshold, the processor operates in an outdoor navigation mode in which the current heading is derived at least in part from GPS/GNSS-based heading estimation.

10. The haptic navigation device of claim 9, wherein, when the GPS/GNSS signal availability is below the configurable signal quality threshold, the processor operates in an indoor navigation mode in which the current heading is derived at least in part from at least one of: Bluetooth Low Energy beacon triangulation, Ultra-Wideband ranging, magnetometer-based heading estimation, camera-based visual-inertial odometry, or combinations thereof.

11. The haptic navigation device of claim 10, wherein the processor is further configured to automatically transition from the outdoor navigation mode to the indoor navigation mode when the GPS/GNSS signal availability falls below the configurable signal quality threshold.

12. The haptic navigation device of claim 10, wherein the processor is further configured to automatically transition from the indoor navigation mode to the outdoor navigation mode when the GPS/GNSS signal availability rises above the configurable signal quality threshold without requiring user input.

13. The haptic navigation device of claim 1, wherein the processor is further configured to measure ambient vibration levels using the accelerometer of the one or more orientation sensors.

14. The haptic navigation device of claim 13, wherein the processor is further configured to compare the measured ambient vibration levels to a configurable ambient vibration threshold stored in the non-transitory memory.

15. The haptic navigation device of claim 1, wherein the processor is further configured to:
detect availability of GPS/GNSS signals from the GPS/GNSS receiver; when GPS/GNSS signal availability is above a configurable signal quality threshold, operate in an outdoor navigation mode in which the current heading is derived at least in part from GPS/GNSS-based heading estimation; when GPS/GNSS signal availability is below the configurable signal quality threshold, operate in an indoor navigation mode in which the current heading is derived at least in part from at least one of: BLE beacon triangulation, UWB ranging, magnetometer-based heading estimation, the camera-based orientation system, or combinations thereof; and automatically transition between the outdoor navigation mode and the indoor navigation mode based on changes in GPS/GNSS signal availability without requiring user input.

16. The haptic navigation device of claim 1, wherein the processor is further configured to:
measure ambient vibration levels using the accelerometer of the one or more orientation sensors;
compare the measured ambient vibration levels to a configurable ambient vibration threshold; and
when the measured ambient vibration levels exceed the configurable ambient vibration threshold, increase at least one of the vibration intensity and a vibration frequency of the vibrotactile output by a compensation factor proportional to the measured ambient vibration levels, thereby maintaining perceptibility of the vibrotactile output during locomotion, vehicular travel, or operation of vibrating equipment.

17. The haptic navigation device of claim 16, wherein, when the measured ambient vibration levels exceed the configurable ambient vibration threshold, the processor is further configured to increase at least one of the vibration intensity or the vibration frequency of the vibrotactile output.

18. The haptic navigation device of claim 17, wherein the processor is further configured to increase the at least one of the vibration intensity or vibration frequency by a compensation factor proportional to the measured ambient vibration levels.

19. The haptic navigation device of claim 18, wherein the processor is further configured to maintain perceptibility of the vibrotactile output during at least one of locomotion, vehicular travel, or operation of vibrating equipment.

20. The haptic navigation device of claim 1, wherein the vibration actuator comprises a bone conduction transducer.

21. The haptic navigation device of claim 20, wherein the bone conduction transducer is configured to operate within a vibrotactile frequency range of approximately 20 Hz to approximately 250 Hz.

22. The haptic navigation device of claim 21, wherein the vibrotactile frequency range is below an auditory perception threshold for bone-conducted sound of approximately 500 Hz.

23. The haptic navigation device of claim 20, wherein the bone conduction transducer is configured such that the vibrotactile output is perceived by a user through a somatosensory system as a tactile sensation rather than through an auditory system as an audible signal.

24. The haptic navigation device of claim 1, wherein the processor is further configured to generate a confirmation pulse when the angular deviation is within the configurable threshold angular range, the confirmation pulse comprising a periodic vibrotactile pattern at a frequency of approximately 0.2 Hz to approximately 1 Hz distinguishable from the null vibration state, indicating alignment with the target heading.

25. A system for haptic navigation comprising:
a processor configured to compute an angular deviation between a sensed orientation and a target heading derived from a navigation route stored in memory;
a vibration actuator coupled to the processor; and
wherein the processor maps the angular deviation to a vibrotactile gradient output in which:
a vibration intensity is at a null state when the angular deviation is within a threshold of the target heading;
the vibration intensity increases continuously from the null state as the angular deviation increases; and
the vibration intensity reaches a maximum value at 180 degrees of the angular deviation from the target heading;
wherein the null state and the vibrotactile gradient output are implemented without a graphical display output.

26. The system for haptic navigation of claim 25, wherein the target heading is derived from a target comprising at least one of: a physical geographic location specified by coordinates; a physical device broadcasting a wireless identifier; a vehicle; a person whose position is tracked by a positioning system; or a physical asset tagged with a GPS, Bluetooth Low Energy (BLE), or Ultra-Wideband (UWB) identifier.

27. The system for haptic navigation of claim 25, wherein the processor is further configured to:
generate a wrong-vehicle alert pattern comprising a rapid alternating vibrotactile pattern when proximity to a vehicle is detected whose received identifier does not match a stored identifier of a target vehicle; and
generate a vehicle-confirmed pattern comprising a distinct confirmation vibrotactile pattern when proximity to the target vehicle is confirmed by a match between a received identifier and the stored identifier of the target vehicle.

28. A distributed haptic navigation system comprising:
a first computing device comprising a navigation engine configured to:
receive route data; determine a current position and a current heading of a user; and
compute an angular deviation between the current heading and a target heading;
a second haptic output device communicatively coupled to the first computing device via a short-range wireless protocol comprising at least one of Bluetooth, Bluetooth Low Energy, or Ultra-Wideband;
the second haptic output device comprising a vibration actuator; and
wherein the first computing device transmits vibrotactile output parameters to the second haptic output device, and the second haptic output device generates vibrotactile output encoding the angular deviation as:
a null vibration state when the angular deviation is within a configurable threshold; and
vibration intensity increases proportional to the angular deviation as the angular deviation increases beyond the configurable threshold.

29. A method for haptic navigation comprising:
receiving orientation data from one or more orientation sensors comprising at least one of: a gyroscope, an accelerometer, a magnetometer, a GPS/GNSS receiver, a camera-based orientation system, or combinations thereof;
computing an angular deviation between a current heading derived from the orientation data and a target heading derived from a planned navigation route stored in memory;
encoding the angular deviation as a vibrotactile signal in which:
a vibration intensity is at a null state when the angular deviation is within a configurable threshold; and
the vibration intensity increases proportionally as the angular deviation increases beyond the configurable threshold; and
delivering the vibrotactile signal through a vibration actuator of a haptic output device worn on or carried by a user.

30. The method of claim 29, wherein encoding the angular deviation comprises simultaneously modulating both vibration frequency and vibration amplitude of the vibrotactile signal, each modulated proportionally to the angular deviation.

31. A proximity-based vehicle identification system comprising:
a positioning module configured to receive proximity signals from a target vehicle via at least one of: Bluetooth Low Energy (BLE) received signal strength indicator (RSSI), Ultra-Wideband (UWB) two-way ranging, Near Field Communication (NFC) field detection, computer vision vehicle recognition, or QR code scanning;
a vibration actuator;
a non-transitory memory storing a target vehicle identifier; and
a processor configured to:
compare a received vehicle identifier against a stored target vehicle identifier; and
generate a vehicle identification heartbeat pattern comprising a rhythmic vibrotactile pulse whose repetition rate and intensity each increase as measured proximity to the target vehicle decreases below a configurable proximity threshold;
wherein the target vehicle identifier is broadcast by a rideshare application, autonomous vehicle platform, or fleet management system operating on a driver device, vehicle-embedded computer, or vehicle-mounted beacon.

32. The proximity-based vehicle identification system of claim 31, wherein the processor is further configured to determine a measured proximity to the target vehicle based on the proximity signals received by the positioning module.

33. The proximity-based vehicle identification system of claim 32, wherein the processor is further configured to classify the measured proximity into a plurality of proximity zones comprising:
a detection zone corresponding to a range of approximately 30 meters to approximately 100 meters;
a guidance zone corresponding to a range of approximately 3 meters to approximately 30 meters; and
an arrival zone corresponding to a range of less than approximately 3 meters.

34. The proximity-based vehicle identification system of claim 33, wherein the processor is further configured to generate the vehicle identification heartbeat pattern at a first repetition rate when the measured proximity is within the detection zone.

35. The proximity-based vehicle identification system of claim 34, wherein the processor is further configured to generate the vehicle identification heartbeat pattern at a second repetition rate greater than the first repetition rate when the measured proximity is within the guidance zone.

36. The proximity-based vehicle identification system of claim 35, wherein the processor is further configured to generate the vehicle identification heartbeat pattern at a third repetition rate greater than the second repetition rate when the measured proximity is within the arrival zone.

37. The proximity-based vehicle identification system of claim 33, wherein the processor is further configured to, upon determining that the measured proximity is within the arrival zone, generate a vehicle-confirmed vibrotactile pattern comprising a sustained vibrotactile pulse distinguishable from the rhythmic vibrotactile pulse of the vehicle identification heartbeat pattern.

38. The proximity-based vehicle identification system of claim 31, wherein the processor is further configured to: classify the measured proximity to the target vehicle into at least three proximity zones comprising a detection zone at a range of approximately 30 meters to approximately 100 meters, a guidance zone at a range of approximately 3 meters to approximately 30 meters, and an arrival zone at a range of less than approximately 3 meters; generate the vehicle identification heartbeat pattern at a first repetition rate in the detection zone, a second repetition rate greater than the first repetition rate in the guidance zone, and a third repetition rate greater than the second repetition rate in the arrival zone; and upon entry into the arrival zone, generate a vehicle-confirmed vibrotactile pattern comprising a sustained vibrotactile pulse distinguishable from the rhythmic vibrotactile pulse of the vehicle identification heartbeat pattern.

39. A haptic human-robot guidance system comprising:
a robotic platform comprising a proximity radio module configured to broadcast a unique robot identifier via at least one of Bluetooth Low Energy (BLE), Ultra-Wideband (UWB), or Wi-Fi;
a human-worn haptic output device comprising:
a vibration actuator;
one or more orientation sensors; and
a processor; and
wherein the processor of the human-worn haptic output device is configured to:
receive the unique robot identifier broadcast and determine a heading toward the robotic platform;
compute angular deviation between a current heading of a user and the heading toward the robotic platform; and
encode the angular deviation as a null vibration state when the angular deviation is within a threshold and as increasing vibration intensity as the angular deviation increases beyond the threshold;
wherein guidance is delivered without requiring visual display or audio output from either the robotic platform or the human-worn haptic output device.

40. A non-transitory computer-readable medium storing instructions that, when executed by
a processor of a haptic output device comprising a vibration actuator and one or more orientation sensors, cause the processor to:
receive orientation data from the one or more orientation sensors;
compute an angular deviation between a current heading derived from the orientation data and a target heading derived from a planned navigation route stored in memory of the haptic output device;
cause the vibration actuator to produce a null vibration state when the angular deviation is within a configurable threshold angular range of the target heading; and
cause the vibration actuator to increase vibration intensity proportionally as the angular deviation increases beyond the configurable threshold angular range, reaching maximum intensity at a maximum angular deviation from the target heading.

41. The non-transitory computer-readable medium of claim 40, wherein the instructions further cause the processor to simultaneously modulate both vibration frequency and vibration amplitude of the vibration actuator proportionally to the angular deviation.

42. The non-transitory computer-readable medium of claim 40, wherein the instructions further cause the processor to dynamically adjust at least one of: vibration intensity, vibration frequency, or vibration duty cycle based on changes in the angular deviation in real time.

43. The non-transitory computer-readable medium of claim 40, wherein the instructions further cause the processor to apply a configurable threshold angular range stored in memory to define the null vibration state.

44. The non-transitory computer-readable medium of claim 40, wherein the instructions further cause the processor to generate a gradient transition of vibration intensity from the null vibration state to the maximum intensity based on a continuous mapping function of the angular deviation.

45. The non-transitory computer-readable medium of claim 40, wherein the instructions further cause the processor to output the vibration intensity through at least one of: a linear resonant actuator, an eccentric rotating mass motor, or a vibrotactile array.

46. The non-transitory computer-readable medium of claim 40, wherein the instructions further cause the processor to perform the computing of the angular deviation and control of the vibration actuator without requiring a graphical display or audio output.
